(19) United States
(12) Patent Application Publication
(10) Pub. No.: US 2007/0172797 A1
(43) Pub. Date: Jul. 26, 2007

(54) METHOD OF CONSTRUCTING COMPUTER-BASED MUSCULOSKELETAL MODEL BY REDEFINING DIRECTIONS OF PIVOT AXES OF JOINTS IN THE SAME MODEL

(75) Inventors: Masatoshi HADA, Nisshin-shi (JP); Daisuke Yamada, Kuwana-gun (JP); Hiroki Miura, Ichinoseki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOYOTA CHUO KENKYUSHO, Aichi-gun (JP)

(21) Appl. No.: 11/622,257

(22) Filed: Jan. 11, 2007

(30) Foreign Application Priority Data
Jan. 12, 2006 (JP) 2006-004376
Dec. 13, 2006 (JP) 2006-336311

(51) Int. Cl. G09B 9/00

(52) U.S. Cl. 434/1

(57) ABSTRACT

Techniques are disclosed of constructing a computer-based musculoskeletal model physically representing bones and muscles of a human body. These techniques include: defining as a first pivot-axis-direction for a selected joint, a direction of an axis about which selected bone models are pivoted relative to each other in response to expansion/contraction of a selected muscle model; defining as a second pivot-axis-direction, a direction of an axis about which the selected bone models are pivoted relative to each other in response to a specified motion imparted to the human body; and redefining the first pivot-axis-direction, as a function of a relative angle of the first pivot-axis-direction to the second pivot-axis-direction.

### CROSS-REFERENCE TO RELATED APPLICATIONS

This application is based on Japanese Patent Applications No. 2006-004376 filed Jan. 12, 2006, and No. 2006-336311 filed Dec. 13, 2006, the contents of which are incorporated hereinto by reference.

### BACKGROUND OF THE INVENTION

1. Field of the Invention

The invention relates to techniques of constructing a computer-based musculoskeletal model which physically represents or simulates on a computer a plurality of bones and a plurality of muscles together making up a human body, and more particularly to techniques of making it easier to enhance the accuracy of analysis results provided by the constructed musculoskeletal model.

2. Description of the Related Art

For effecting a simulation analysis of a human body motion by a computer, there are known techniques of using a physically-based human body model physically representing or simulating a human body on a computer, such as disclosed in, for example, Japanese Patent Application Publications No. HEI 11-85209 and No. 2003-339673.

In this regard, the “physically-based human body model physically representing or simulating a human body” is a model constructed, for example, so as to represent or simulate on a computer the real physical properties of a human body with maximum fidelity.

The former Publication No. HEI 11-85209 discloses a technique of estimating a human body motion by simulation on the basis of dynamics, according to optimal control theory deploying an objective function in the form of a minimum muscle action function, in order that the human body motion may be represented with higher realism in a labor-saving manner, in an attempt to animate the human body motion by simulation.

The latter Publication No. 2003-339673 discloses a technique of fast performing forward or direct dynamics calculation (i.e., process to calculate a motion from given muscle-forces) and inverse dynamics calculation (i.e., process to calculate muscle forces and ligament forces required for causing a human body to perform a given motion), both for a human body model, in order to construct the human body model in the form of a human-body detailed model bearing geometrical data indicative of bones, and data indicative of muscles, tendons and ligaments, using a commercialized modeling software product.

In this technique, dynamics calculation is performed using a human body model so as to reach force equilibrium between a joint torque and a muscle force,

### BRIEF SUMMARY OF THE INVENTION

The above-mentioned musculoskeletal model for computational or analytical purposes is roughly classified into a skeleton model defining articular movement or kinematical motion of a human body, and a muscle model defining muscular movement or dynamical motion of the human body.

For this reason, for a musculoskeletal model to be constructed so as to represent the real physical properties of a human body on a computer with maximum fidelity, it is of importance for an analyzer or researcher to verify those skeleton and muscle models individually and totally, in terms of validity.

It is therefore desirable to an analyzer to provide techniques of verifying those skeleton and muscle models with greater ease and enhanced accuracy.

Additionally, for the efficiency of corrective work on a musculoskeletal model to be improved, there are also of importance techniques of assisting an analyzer in correcting skeleton and muscle models with greater ease and enhanced accuracy, when these skeleton and muscle models lack validity.

However, conventional techniques of constructing a musculoskeletal model involve a comparatively high degree of difficulty in verifying the validity of a muscle model, for example, resulting in a comparatively high degree of difficulty with which an analyzer corrects the muscle model.

Described more specifically, the present inventors, as a result of their study, have found that, from the perspective of verifying the validity of a muscle model representing a muscle with enhanced accuracy, and of improving the validity of the muscle model with enhanced accuracy, it is of importance to focus much attention on a direction (hereinafter, referred to as “first pivot-axis-direction”) of a pivot axis about which aligned bones are pivoted relative to each other about an associated joint in response to a force acting onto those bones from the muscle during its contraction.

Additionally, the present inventors have also found that it is also of importance to evaluate the first pivot-axis-direction relatively with respect to a direction (hereinafter, referred to as “second pivot-axis-direction”) of a pivot axis about which aligned bones are pivoted relative to each other about an associated joint in response to a specified motion imparted to a human body.

However, conventional techniques of constructing the musculoskeletal model would not visualize the first and second pivot-axis-directions for presentation to an analyzer during construction of a musculoskeletal model, nor automatically correct a musculoskeletal model by a computer so that the first pivot-axis-direction may be moved close to the second pivot-axis-direction.

In light of the circumstances described above, it is an object of the present invention to provide techniques of constructing by a computer a musculoskeletal model which physically represents on the computer a plurality of bones and a plurality of muscles together making up a human body, which techniques are for making it easier to enhance with greater ease the accuracy of analysis results provided by the constructed musculoskeletal model.

General Overview of the Invention

According to a first aspect of the invention, there is provided a method of constructing a computer-based musculoskeletal model which physically represents on a computer a plurality of bones and a plurality of muscles together making up a human body.

In this regard, the musculoskeletal model is, for example, a model approximately representing the plurality of bones in the form of a plurality of bone models each of which is defined as a rigid-body segment and which are pivotable relative to one another about pivot axes of a plurality of joints, and approximately representing the plurality of muscles in the form of a plurality of muscle models.

This method is constructed to include, for example, a first defining step, a second defining step, and a redefining step.

The first defining step is, for example, a step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint.

The second defining step is, for example, a step of defining as a second pivot-axis-direction, a direction of an axis about which selected ones of the plurality of bones represented by the selected bone models are pivoted relative to each other in response to a specified motion imparted to the human body.

The redefining step is, for example of a step of redefining by the computer the defined first pivot-axis-direction of the selected joint, as a function of a relative angle of the defined first pivot-axis-direction to the defined second pivot-axis-direction, both of the selected joint.

According to a second aspect of the invention, there is provided a process of estimating by a computer a stress and/or a strain occurring at each segment of a human body, from a given motion imparted to the human body, using a computer-based musculoskeletal model and a finite element model.

In this regard, the musculoskeletal model is, for example, a model of physically representing on a computer a plurality of bones and a plurality of muscles together making up the human body, using a plurality of rigid-body segments for representation of the plurality of bones, and using a plurality of finite elements for representation of the plurality of muscles.

Described more specifically, the musculoskeletal model is, for example, a model approximately representing the plurality of bones in the form of a plurality of bone models each of which is defined as a rigid-body segment and which are pivotable relative to one another about pivot axes of a plurality of joints, and approximately representing the plurality of muscles in the form of a plurality of muscle models each of which is defined using at least one finite element.

On the other hand, the finite element model is, for example, a model physically representing on the computer the same human body using a plurality of finite elements, irrespective of whether each segment of the human body is a bone or a muscle.

This process is constructed to include, for example, (i) a musculoskeletal model construction step of constructing the musculoskeletal model; (ii) a load estimation step of estimating a plurality of loads different in kind acting with respect to each segment of the human body, based on the motion imparted to the human body, using the constructed musculoskeletal model; and (iii) a stress/strain estimation step of estimating a stress and/or a strain occurring at each segment of the human body, based on the estimated plurality of loads, using the finite element model.

The musculoskeletal model construction step is, for example, a step comprising: (a) a provisional construction step of provisionally constructing the musculoskeletal model based on provided musculoskeletal model information; (b) a first calculation step; (c) a second calculation step; and (d) a musculoskeletal model correction step.

The first calculation step is, for example, a step of calculating as a first pivot-axis-direction for selected ones of the plurality of bone models of the provisionally-constructed musculoskeletal model, which ones are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint.

The second calculation step is, for example, a step of calculating as a second pivot-axis-direction, a direction of an axis about which selected ones of the plurality of bones represented by the selected bone models are pivoted relative to each other in response to a specified motion imparted to the human body.

The musculoskeletal model correction step is, for example, a step of correcting the calculated first pivot-axis-direction of the selected joint, as a function of a relative angle of the calculated first pivot-axis-direction to the calculated second pivot-axis-direction, both of the selected joint, to thereby correct the provisionally-constructed musculoskeletal model.

The plurality of different loads include, for example, at least one of a muscle-related load, an external force acting on each segment of the human body, a velocity and an acceleration occurring at each segment of the human body, and a plurality of physical quantities interchangeable with the foregoing physical quantities. The muscle-related load includes, for example, at least one of a muscle activation level and a muscle force.

According to a third aspect of the invention, there is provided a method of constructing a computer-based musculoskeletal model which physically represents on a computer a plurality of bones and a plurality of muscles together making up a human body.

In this regard, the musculoskeletal model is, for example, a model approximately representing the plurality of bones in the form of a plurality of bone models each of which is defined as a rigid-body segment and which are pivotable relative to one another about pivot axes of a plurality of joints, and approximately representing the plurality of muscles in the form of a plurality of muscle models each of which is defined using at least one finite element.

This method is constructed to include, for example, the aforementioned first and second defining steps, first and second presentation steps, and a redefining step.

The first presentation step is, for example, a step of visually presenting on a screen of a display device, at least one of a plurality of first pictorial-shapes representative of a plurality of the first pivot-axis-directions defined for the selected muscle models, respectively, in positional association with the selected joint.

The second presentation step is, for example, a step of visually presenting on the screen, a second pictorial-shape representative of the defined second pivot-axis-direction, in positional association with the selected joint.

The redefining step is, for example, a step of redefining at least one of the defined plurality of first pivot-axis-directions of the selected joint, as a function of a relative angle of the at least one first pivot-axis-direction to the defined second pivot-axis-direction, both of the selected joint.

### ILLUSTRATIVE EMBODIMENTS OF THE INVENTION

According to the invention, the following modes are provided as illustrative embodiments of the invention.

It is noted that these modes will be stated below so as to be sectioned and numbered, and so as to depend upon the other mode or modes, where appropriate. This is for a better understanding of some of a plurality of technical features and a plurality of combinations thereof disclosed in this description, and does not mean that the scope of these features and combinations is interpreted to be limited to the scope of the following modes of this invention.

That is to say, it should be interpreted that it is allowable to select the technical features which are stated in this description but which are not stated in the following modes, as the technical features of this invention.

It is further noted that, stating each one of the modes of the invention in such a dependent form as to depend from the other mode or modes does not exclude the possibility that the technical features set forth in a dependent-form mode become independent of those set forth in the corresponding depended mode or modes and to be removed therefrom. It should be interpreted that the technical features set forth in a dependent-form mode are allowed to become independent, where appropriate.

(1) A method of constructing a computer-based musculoskeletal model which physically represents on a computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the method comprising:

a first defining step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint;

a second defining step of defining as a second pivot-axis-direction, a direction of an axis about which selected ones of the plurality of bones represented by the selected bone models are pivoted relative to each other in response to a specified motion imparted to the human body; and

a redefining step of redefining by the computer the defined first pivot-axis-direction of the selected joint, as a function of a relative angle of the defined first pivot-axis-direction to the defined second pivot-axis-direction, both of the selected joint.

Once this method has been practiced, a musculoskeletal model is constructed or created such that a plurality of bones are represented as a plurality of bone models each of which is in the form of a rigid-body segment, with the bone models being pivotable relative to one another about an associated joint, and such that a plurality of muscles are represented as a plurality of muscle models each of which is defined using at least one finite element.

Additionally, once this method has been practiced, there is defined, for construction or creation of a musculoskeletal model, as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint. The first pivot-axis-direction is defined on a per-selected-muscle-model basis.

The first pivot-axis-direction is a muscle-based pivot-axis-direction determined by identifying a direction of a pivot axis about which aligned bones are pivoted relative to each other about a common joint in response to contraction of a certain muscle, with respect to the attributes of the muscle (e.g., a muscle force, the geometry of the muscle relative to the joint, etc.), on a per-muscle basis.

The first pivot-axis-direction may be directly defined by user entry, or may be defined through computer calculation based on user-entered data, for example.

Still additionally, once this method has been practiced, there is also defined, for construction or creation of a musculoskeletal model, as a second pivot-axis-direction, a direction of an axis about which selected ones of the plurality of bones represented by the selected bone models are pivoted relative to each other in response to a specified motion imparted to the human body.

The second pivot-axis-direction is a motion-based pivot-axis-direction determined by identifying a direction of a pivot axis about which aligned bones are pivoted relative to each other about a common joint in response to a specified motion imparted to a human body, with respect to the specified motion imparted to the human body, with the motion-based pivot-axis-direction being in common to all muscles exerting their actions on the common joint.

Similarly with the first pivot-axis-direction, the second pivot-axis-direction may be directly defined by user entry, or may be defined through computer calculation based on user-entered data for example.

Still yet additionally, once this method has been practiced, a previously-defined first pivot-axis-direction of an arbitrary selected joint is redefined or corrected by a computer as a function of a relative angle of the first pivot-axis-direction to a previously-defined second pivot-axis-direction, to thereby automatically correct a previously-created musculoskeletal model.

This method, therefore, would improve the efficiency of corrective work on a musculoskeletal model. Further, this method would make it easier to enhance the accuracy of analysis results provided by the musculoskeletal model.

Throughout the description, the term “finite element” is used to mean, for example, a wire or bar element (i.e., element deformable only in one direction), a solid element (i.e., element deformable in different directions), etc.

Further, the “musculoskeletal model” may be employed as a physically-based human body model intended for the analytical, computational, and computer simulation purposes.

(2) The method according to mode (1), wherein the redefining step includes an alteration step of altering the first pivot-axis-direction such that the relative angle becomes smaller, to thereby redefine the first pivot-axis-direction.

Observation of the actions of real muscles has revealed that each real muscle deforms in a fashion dependent upon specific modes of articular movement in a human body, resulting in changes in rectilinear direction in which a muscle force acts, and dependent changes in the first pivot-axis-direction (i.e., the aforementioned muscle-based pivot-axis-direction).

More specifically, each real muscle deforms such that its first pivot-axis-direction moves close to the second pivot-axis-direction (i.e., the aforementioned motion-based pivot-axis-direction), that is to say such that the relative angle of the first pivot-axis-direction to the second pivot-axis-direction reduces.

Based on the above findings, the method according to the present mode, upon practiced, alter the first pivot-axis-direction such that its relative angle to the second pivot-axis-direction reduces, in an automated manner through a computer, to thereby automatically correct a previously-defined musculoskeletal model.

This method, therefore, would improve the efficiency of corrective work on a musculoskeletal model. Further, this method would make it easier to enhance the accuracy of analysis results provided by the musculoskeletal model.

(3) The method according to mode (2), wherein the alteration step is implemented not to alter the first pivot-axis-direction when the relative angle exceeds an allowable limit, and to alter the first pivot-axis-direction is altered when the relative angle does not exceed the allowable limit, such that the relative angle becomes smaller.

Observation of the actions of real muscles has revealed that, upon a particular movement imparted to a human body around a certain joint thereof, not all the real muscles that exert their actions on the certain joint deform in a fashion that their first pivot-axis-directions (i.e., the muscle-based pivot-axis-directions) move close to the second pivot-axis-direction (i.e., the motion-based pivot-axis-direction).

More specifically, each one of real muscles exerting their actions on a common joint, when a relative angle of the original (pre-altered) first pivot-axis-direction to the second pivot-axis-direction is relatively small, deforms such that the original first pivot-axis-direction moves close to the second pivot-axis-direction, but does not deform when the relative angle is relatively large.

Based on the above findings, the method according to the present mode, upon practiced, does not alter the first pivot-axis-direction when its relative angle to the second pivot-axis-direction exceeds an allowable limit, and alters the first pivot-axis-direction when the relative angle does not exceed the allowable limit, such that the relative angle becomes smaller.

This method, therefore, would make it easier to create a muscle model, which is part of a musculoskeletal model, so as to reflect behaviors of a real muscle with an enhanced degree of fidelity.

(4) The method according to mode (3), wherein the alteration step is implemented to alter the first pivot-axis-direction such that the relative angle is moved closer to zero when the relative angle does not exceed a reference value not exceeding the allowable limit than when the relative value exceeds the reference value.

Observation of the actions of real muscles has revealed that, upon a particular movement imparted to a human body around a certain joint thereof, each real muscle, when a relative angle of the original first pivot-axis-direction to the second pivot-axis-direction is relatively small, deforms such that the relative angle becomes smaller. The reduction in the relative angle varies depending on the magnitude of the original relative angle.

More specifically, the relative angle becomes closer to zero when the original relative angle is relatively small, than the opposite situation.

Based on the above findings, the method according to the present mode, upon practiced, alters the first pivot-axis-direction such that the relative angle is moved closer to zero when the relative angle does not exceed a reference value not exceeding the allowable limit than when the relative value exceeds the reference value.

(5) The method according to any one of modes (1)-(4), wherein the redefining step includes a first direction calculation step of calculating the first pivot-axis-direction of the selected muscle model, based on position coordinate information indicative of a position of a joint-pivot-center of the selected joint, and position coordinate information indicative of positions of two via-points via which the selected muscle model passes when traveling between two attachment points at which the selected muscle model is attached to the selected bone models.

(6) The method according to any one of modes (1)-(5), wherein

each of the muscles is in the form of a bundle of a plurality of muscle fibers,

the plurality of muscle models include at least one detailed muscle model representing a bundle of a plurality of muscle fibers making up a corresponding one of the plurality of muscles, in the form of a bundle of a plurality of muscle-fiber models, and

the redefining step includes a second direction calculation step of calculating the first pivot-axis-direction on a per-muscle-fiber-model basis.

A real muscle is organized in the form of a bundle of a plurality of muscle fibers, each of which contacts due to activity of human motor nerves, resulting in an occurrence of a muscle force, with each muscle fiber deforming flexibly in action. Each human motor nerve forms a single motor unit controlling a plurality of muscle fibers which are distributed among different muscles, with a varying number of muscle fibers controlled by each human motor nerve in a range from tens to hundreds.

For these reasons, a muscle force can act on a muscle also in a direction deviated from the geometrical center line of the muscle. On the other hand, (a) defining of a muscle force direction on a per-muscle-fiber basis; (b) defining of the aforementioned first pivot-axis-direction (i.e., the direction of a muscle moment arm vector as described below) on a per-muscle-fiber basis; and (c) redefining of the first pivot-axis-direction on a per-muscle-fiber basis, once accepted in combination, would make it easier to improve the accuracy of a muscle model representing a real muscle.

Based on the above findings, in the method according to the present mode, a plurality of muscle models include at least one detailed muscle model representing a bundle of a plurality of muscle fibers making up a corresponding one of the plurality of muscles, in the form of a bundle of a plurality of muscle-fiber models.

Further, in this method, the first pivot-axis-direction is calculated on a per-muscle-fiber-model basis. In other words, for example, the direction of the muscle moment arm vector is calculated on a per-muscle-fiber-model basis.

(7) The method according to mode (6), wherein the redefining step includes:

a vector calculation step of calculating, on a per-muscle-fiber-model basis, a moment arm vector representative of a moment arm with which a corresponding one of the muscle fibers to each muscle-fiber model exerts its action on the selected joint;

a relative-angle calculation step of calculating the relative angle, based on the calculated moment arm vector and the defined second pivot-axis-direction; and

a vector correction step of correcting the calculated moment arm vector, based on the calculated relative angle, on a per-muscle-fiber-model basis.

(8) The method according to mode (7), wherein the vector calculation step includes a step of calculating the moment arm vector, on a per-muscle-fiber-model basis, based on position coordinate information indicative of a position of a joint-pivot-center of the selected joint, and position coordinate information indicative of positions of two via-points via which each muscle-fiber model passes when traveling between two attachment points at which each muscle-fiber model is attached to the selected bone models.

(9) A process of estimating by a computer a stress and/or a strain occurring at each segment of a human body, from a given motion imparted to the human body, using a computer-based musculoskeletal model and a finite element model, wherein

the musculoskeletal model physically represents on a computer a plurality of bones and a plurality of muscles together making up the human body, using a plurality of rigid-body segments for representation of the plurality of bones, and using a plurality of finite elements for representation of the plurality of muscles, and

the finite element model physically represents on the computer the same human body using a plurality of finite elements, irrespective of whether each segment of the human body is a bone or a muscle,

the process comprising:

a musculoskeletal model construction step of constructing the musculoskeletal model;

a load estimation step of estimating a plurality of loads different in kind acting with respect to each segment of the human body, based on the motion imparted to the human body, using the constructed musculoskeletal model; and

a stress/strain estimation step of estimating a stress and/or a strain occurring at each segment of the human body, based on the estimated plurality of loads, using the finite element model, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the musculoskeletal model construction step comprising:

(a) a provisional construction step of provisionally constructing the musculoskeletal model based on provided musculoskeletal model information;

(b) a first calculation step of calculating as a first pivot-axis-direction for selected ones of the plurality of bone models of the provisionally-constructed musculoskeletal model, which ones are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint;

(c) a second calculation step of calculating as a second pivot-axis-direction, a direction of an axis about which selected ones of the plurality of bones represented by the selected bone models are pivoted relative to each other in response to a specified motion imparted to the human body; and

(d) a musculoskeletal model correction step of correcting the calculated first pivot-axis-direction of the selected joint, as a function of a relative angle of the calculated first pivot-axis-direction to the calculated second pivot-axis-direction, both of the selected joint, to thereby correct the provisionally-constructed musculoskeletal model, wherein

the plurality of different loads include at least one of a muscle-related load, an external force acting on each segment of the human body, and a velocity and an acceleration occurring at each segment of the human body, and

the muscle-related load includes at least one of a muscle activation level and a muscle force.

This process would estimate a plurality of different loads acting on each segment of a human body, based on a motion imparted to the human body, using a musculoskeletal model having its first pivot-axis-direction which has been corrected to represent a real musculoskeleton with an enhanced accuracy.

Further, this process would also estimate at least one of a stress and a strain occurring at each segment of a human body, based on the estimated plurality of different loads, using a separate model, namely, a finite-element human-body model.

This process, therefore, would make it easier to accurately estimate at least one of a stress and a strain occurring at a human body in response to a given motion of the human body.

(10) A method of constructing a computer-based musculoskeletal model which physically represents on a computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the method comprising:

a first defining step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the first pivot-axis-direction defined on a per-selected-muscle-model basis;

a second defining step of defining as a second pivot-axis-direction, a direction of an axis about which selected ones of the plurality of bones represented by the selected bone models are pivoted relative to each other in response to a specified motion imparted to the human body;

a first presentation step of visually presenting on a screen of a display device, at least one of a plurality of first pictorial-shapes representative of a plurality of the first pivot-axis-directions defined for the selected muscle models, respectively, in positional association with the selected joint;

a second presentation step of visually presenting on the screen, a second pictorial-shape representative of the defined second pivot-axis-direction, in positional association with the selected joint; and

a redefining step of redefining at least one of the defined plurality of first pivot-axis-directions of the selected joint, as a function of a relative angle of the at least one first pivot-axis-direction to the defined second pivot-axis-direction, both of the selected joint.

Upon practice of this method, a musculoskeletal model is constructed or created, the first pivot-axis-direction is defined on a per selected-muscle-model basis, and the second pivot-axis-direction is defined for an arbitrary selected joint, each in a manner similar with the method according to the above mode (1).

Additionally, upon practice of this method, at least one of a plurality of first pictorial-shapes representative of a plurality of first pivot-axis-directions defined for a plurality of selected muscle models, respectively, is visually presented on a screen of a display device, in positional association with an arbitrary selected joint. That is to say, the at least one first pivot-axis-direction is visualized and presented to a user.

Still additionally, upon practice of this method, a second pictorial-shape representative of the defined second pivot-axis-direction is visually presenting on the screen, in positional association with the selected joint. That is to say, the second pivot-axis-direction is visualized and presented to the user.

This method, owing to the visualization and presentation of the at least one first pivot-axis-direction and the second pivot-axis-direction, would assist the user in verifying the validity of a constructed musculoskeletal model (especially, the validity of its muscle model included in the musculoskeletal model) with respect to articular movement of a human body occurring depending upon its physique (including the joint structure).

This method, therefore, would improve the efficiency of corrective work on a musculoskeletal model, resulting from the assist of verifying the validity of the configuration of a constructed musculoskeletal model. Further, this method would make it easier to enhance the accuracy of analysis results provided by the musculoskeletal model.

This method, therefore, would make it easier to create a muscle model, which is part of a musculoskeletal model, so as to reflect behaviors of a real muscle with an enhanced degree of fidelity.

Additionally, this method would enable the user to correct the constructed musculoskeletal model such that at least one of a plurality of previously-defined first pivot-axis-directions is redefined based on a previously-defined second pivot-axis-direction, in light of the verification result of the validity of the constructed musculoskeletal model

This method, therefore, would also make it easier for the user to correct a constructed musculoskeletal model, to thereby improve the efficiency of corrective work on the musculoskeletal model. Further, this method would make it easier to enhance the accuracy of analysis results provided by the musculoskeletal model.

This method may be practiced in an arrangement in which, once the first pivot-axis-direction has been redefined, the first pictorial shape indicative of the redefined first pivot-axis-direction is displayed on a visual screen.

This arrangement, because of its capability of visualizing a newest version of the first pivot-axis-direction each time the first pivot-axis-direction is redefined or updated, would improve the efficiency of redefining work on the first pivot-axis-direction in need of repetitive redefining work.

The method according to the present mode may be practiced such that the first presentation step allows the plurality of first pivot-axis-directions to be displayed together at a time, or allows a user-selected one (ones) of the plurality of the first pivot-axis-directions to be displayed alone.

It is added that, throughout the description, the terms “define” and “redefine” may be interpreted to mean, for example, an event that a particular physical quantity is specified according to user-entered information, or an event that a particular physical quantity is specified according to a calculation result by a computer.

(11) The method according to mode (10), wherein the first presentation step is implemented to perform visual presentation of the at least one first pictorial-shape in parallel to visual presentation of the second pictorial-shape by implementation of the second presentation step.

This method, because of its capability of visualizing for presentation to a user a combination of at least one first pivot-axis-direction (i.e., the aforementioned muscle-based pivot-axis-direction) and a second pivot-axis-direction (i e., the aforementioned motion-based pivot-axis-direction), would allow the user to view two kinds of pivot-axis-directions in direct comparison with one another.

This method, therefore, would allow the user to verify the validity of the first pivot-axis-direction with greater ease than when two kinds of pivot-axis-directions are displayed separately.

(12) The method according to mode (10) or (11), wherein the plurality of first pictorial-shapes are defined in a three-dimensional space in the form of a plurality of first straight-lines which extend away from one joint-pivot-center of the selected joint, in the plurality of first pivot-axis-directions, up to equidistant positions, respectively, or in the form of a plurality of figures extending along the plurality of first straight-lines, respectively,

the second pictorial-shape is defined in the three-dimensional space in the form of one second straight-line which extends away from the one joint-pivot-center, in the second pivot-axis-direction, or in the form of one figure extending along the second straight-line,

the first presentation step is implemented to display the at least one first pictorial-shape two-dimensionally on the screen, in the form of at least one first projected-image obtained by projecting the at least one first pictorial-shape onto the screen in a given direction, respectively, and

the second presentation step is implemented to display the second pictorial-shape two-dimensionally on the screen, in the form of a second projected-image obtained by projecting the second pictorial-shape onto the screen in the given direction.

Upon practice of this method, at least one first pivot-axis-direction (i.e., the aforementioned muscle-based pivot-axis-direction) is displayed as at least one first pictorial-shape which is defined in a three-dimensional space in the form of a first straight-line which extends away from one joint-pivot-center of an arbitrary selected joint, or in the form of a figure extending along the first straight-line.

The at least one first pictorial-shape is displayed two-dimensionally on a screen, in the form of a first projected-image obtained by projecting the at least one first pictorial-shape onto the screen in a given direction.

Additionally, upon practice of this method, a second pivot-axis-direction (i.e., the aforementioned motion-based pivot-axis-direction) is displayed as a second pictorial-shape which is defined in the three-dimensional space in the form of one second straight-line which extends away from the one joint-pivot-center, or in the form of one figure extending along the second straight-line.

The second pictorial-shape is displayed two-dimensionally on the screen, in the form of a second projected-image obtained by projecting the second pictorial-shape onto the screen in the given direction.

This method, therefore, would allow the user to stereoscopically perceive the first and second pivot-axis-directions through their two-dimensional representations on the screen, to thereby allow the user to accurately realize these pivot-axis-directions in a three-dimensional space.

(13) The method according to mode (12), further comprising a third presentation step of visually presenting two-dimensionally on the screen, one spherical surface shape defined in the three-dimensional space with its center located coincident with the joint-pivot-center, and with its radius equal in length to the plurality of first straight-lines, in superposition with the first projected-image, the one spherical surface shape being displayed in the form of a projected image obtained by projecting the spherical surface shape onto the screen in the given direction.

Upon practice of this method, one spherical surface shape with its center located coincident with a joint-pivot-center and with its radius equal in length to the first pictorial-shape is displayed two-dimensionally on the screen, in the form of a projected image of the spherical surface shape, in superposition with the first projected-image of the first pictorial-shape.

The projected image acts, on the screen, as a so-called depth cue which promotes the user to perceive the depth of the first projected-image of the first pictorial-shape.

This method, therefore, would allow the user to realize accurately and stereoscopically the first projected-image, that is to say the first pivot-axis-direction, with greater ease than if the projected image of the spherical surface shape is not displayed together on the screen.

(14) The method according to mode (13), wherein the spherical surface shape is defined in the three-dimensional space in the form of a three-dimensional mesh, and

the third presentation step includes a step of displaying the three-dimensional mesh two-dimensionally on the screen, in the form of a projected image of the three-dimensional mesh obtained by projecting the three-dimensional mesh onto the screen in the given direction.

This method would allow the spherical surface shape displayed in superposition with the first projected-image, to be defined as a mesh. The defined mesh is displayed two-dimensionally on the screen in the form of a projected image of the mesh.

This method, therefore, would allow the projected image of the mesh to be displayed on the screen in the form of the aforementioned depth cue to enhance the effect of the display, resulting in far greater ease with which the user perceives the first pivot-axis-direction (i.e., the aforementioned muscle-based pivot-axis-direction) accurately and stereoscopically.

(15) The method according to anyone of modes (10)-(14), further comprising

a third defining step of determining, on a per-selected-muscle-model basis, the same direction as the defined first pivot-axis-direction as a reference pivot-axis-direction, and defining, on a per-selected-muscle-model basis, an allowable angular range over which the first pivot-axis-direction is allowed to be deviated from the reference pivot-axis-direction, wherein

each one of the first pictorial-shapes is defined in the three-dimensional space in the form of a conical surface shape geometrically specified by a centerline extending in the reference pivot-axis-direction, and a base varying in size with the defined allowable-angular-range, and

the first presentation step includes a conical-surface-shape presentation step of displaying the defined conical-surface-shape two-dimensionally on the screen, on a per-selected-muscle-model basis, in the form of a projected image of the conical surface shape obtained by projecting the conical surface shape onto the screen in a given direction.

Observation of the structure of a real human body has revealed that a real muscle extends along a straight line, but has a thickness and is attached to a real bone at its local region having an area. Additionally, the real muscle is not rigid but deformable.

Because of the above structure, once a muscle force occurs in a muscle in response to muscle contraction, a rectilinear direction (hereinafter, referred to as “muscle force direction”) in which the muscle force acts is caused to change so as to conform with the direction in which associated bones move, resulting in effective transfer of the muscle force to the bones.

On the other hand, in the case of a real muscle, there is a limitation on a change in muscle force direction, leading to the presence of a limitation on a change in the first pivot-axis-direction.

For the above reasons, for a musculoskeletal model to represent a real human body with maximum fidelity, it is desirable to define the first pivot-axis-direction together while defining its allowable angular range.

In addition, for the efficiency of creating work on a musculoskeletal model to be enhanced, it is desirable to display the allowable angular range on the screen together with the first pivot-axis-direction.

Based on the above findings, upon practice of the method according to the present mode, the same direction as the first pivot-axis-direction is defined as a reference pivot-axis-direction, on a per-muscle basis, and an allowable angular range over which the first pivot-axis-direction is allowed to be deviated from the reference pivot-axis-direction, on a per-muscle basis. The allowable angular range is, typically, defined directly user-entered data.

Further, upon practice of this method, the aforementioned first pictorial-shape is defined in a three-dimensional space in the form of a conical surface shape geometrically specified by a centerline extending in the reference pivot-axis-direction, and a base varying in size with the defined allowable-angular-range.

The defined conical-surface-shape is displayed two-dimensionally on a screen, in the form of a projected image of the conical surface shape obtained by projecting the conical surface shape onto the screen in a given direction.

(16) The method according to any one of modes (10)-(15), wherein the first presentation step includes a step of displaying, on a per-selected-muscle-model basis, each one of the first pictorial-shapes in a manner that a visual property of each first pictorial-shape is varied depending on a magnitude of a moment arm with which a corresponding one of the muscles to each selected muscle model exerts its action on the selected joint.

In general, a real muscle, upon contraction, exerts a muscle moment on a real joint. The muscle moment is expressed as the product of a muscle moment arm and a muscle force. The muscle moment arm is, geometrically, a physical quantity meaning a distance between the pivot axis for the first pivot-axis-direction, and a muscle path (i.e., a muscle travel).

In this regard, the pivot axis for the first pivot-axis-direction means an axis about which the selected bone models are pivoted relative to each other in response to expansion/contraction of the selected muscle model, which exerts its action on the selected joint.

On the other hand, from the perspective of constructing a musculoskeletal model, in particular, a muscle model accurately, both the direction and the magnitude of a muscle moment arm are essential physical quantities to be referenced by a user.

In addition, upon practice of the method according to the present mode, the first pivot-axis-direction, that is to say the direction of muscle moment arm is visualized graphically, and the magnitude of the same muscle moment arm is also visualized graphically.

This method, as a result, would allow the user to construct a musculoskeletal model efficiently, while realizing visually not only the direction of a muscle moment arm but also its magnitude.

The “visual property” set forth in the present mode may be, for example, the length, the brightness or the color each attributed to a straight line forming each one of the first pictorial-shapes, or the height, the brightness or the color each attributed to a conical surface shape forming each first pictorial shape.

(17) The method according to any one of modes (10)-(16), wherein the redefining step includes an alteration step of altering at least one of the plurality of first pivot-axis-directions such that the relative angle becomes smaller, to thereby redefine the at least one first pivot-axis-direction.

This method would provide basically the same functions and effects according to the basically the same principle, as the method according to the above mode (2).

(18) The method according to mode (17), wherein the alteration step is implemented not to alter each one of the first pivot-axis-directions when the relative angle exceeds an allowable limit, and to alter each first pivot-axis-direction when the relative angle does not exceed the allowable limit, such that each first pivot-axis-direction becomes smaller.

This method would provide basically the same functions and effects according to the basically the same principle, as the method according to the above mode (3).

(19) The method according to mode (18), wherein the alteration step is implemented to alter each one of ones of the first pivot-axis-directions the relative angles of which do not exceed the allowable limit, such that the relative angle is moved closer to zero when the relative angle does not exceed a reference value not exceeding the allowable limit than when the relative value exceeds the reference value.

This method would provide basically the same functions and effects according to the basically the same principle, as the method according to the above mode (4).

(20) A computer-executable program which, when executed by a computer, effects the method according to any one of modes (1)-(19).

This program, upon executed by a computer, would provide basically the same functions and effects according to the basically the same principle, as the method according to any one of the above modes (1)-(19).

The “program” set forth in the present mode may be interpreted to incorporate not only a set of instructions implemented by a computer to perform the functions of the program, but also files, data, etc., processed according to the instructions.

In addition, this program may be interpreted as one achieving the intended purpose by being solely executed by a computer, or one achieving the intended purpose by being executed by a computer together with another program. In the latter case, this program may be constructed mainly with data.

(21) A computer-readable medium having stored therein a program which, when executed by a computer, effects the method according to any one of modes (1)-(19).

The program which has been stored in this medium, upon executed by a computer, provides the same functions and effects as the method according to any one of the above modes (1)-(19).

This medium may be realized in different types, including a magnetic recording medium, such as a flexible-disc, an optical recording medium such as a CD and a CD-ROM, an optical-magnetic recording medium such as an MO, an un-removable storage such as a ROM, for example.

(22) An apparatus of constructing a computer-based musculoskeletal model which physically represents on a computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the apparatus comprising:

first defining circuitry configured to define as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the first pivot-axis-direction defined on a per-selected-muscle-model basis;

second defining circuitry configured to define as a second pivot-axis-direction, a direction of an axis about which selected ones of the plurality of bones represented by the selected bone models are pivoted relative to each other in response to a specified motion imparted to the human body;

first presentation circuitry configured to visually present on a screen of a display device, at least one of a plurality of first pictorial-shapes representative of a plurality of the first pivot-axis-directions defined for the selected muscle models, respectively, in positional association with the selected joint;

second presentation circuitry configured to visually present on the screen, a second pictorial-shape representative of the defined second pivot-axis-direction, in positional association with the selected joint; and

redefining circuitry configured to redefine at least one of the defined plurality of first pivot-axis-directions of the selected joint, as a function of a relative angle of the at least one first pivot-axis-direction to the defined second pivot-axis-direction, both of the selected joint.

This apparatus would provide basically the same functions and effects according to the basically the same principle, as the method according to the above mode (10).

(23) An apparatus of constructing a computer-based musculoskeletal model which physically represents on a computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the apparatus comprising:

first defining circuitry configured to define as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the first pivot-axis-direction defined on a per-selected-muscle-model basis;

second defining circuitry configured to define as a second pivot-axis-direction, a direction of an axis about which selected ones of the plurality of bones represented by the selected bone models are pivoted relative to each other in response to a specified motion imparted to the human body; and

redefining circuitry configured to redefine at least one of the defined plurality of first pivot-axis-directions of the selected joint, as a function of a relative angle of the at least one first pivot-axis-direction to the defined second pivot-axis-direction, both of the selected joint.

This apparatus would provide basically the same functions and effects according to the basically the same principle, as the method according to the above mode (1).

(24) A method of displaying on a screen of a display device at least a skeletal model of a computer-based musculoskeletal model which physically represents on a computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the method comprising:

a first defining step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the first pivot-axis-direction defined on a per-selected-muscle-model basis; and

a first presentation step of visually presenting on the screen, at least one of a plurality of first pictorial-shapes representative of a plurality of the first pivot-axis-directions defined for the selected muscle models, respectively, in positional association with the selected joint.

Upon practice of this method, at least one of a plurality of first pictorial-shapes representative of a plurality of first pivot-axis-directions (i.e., the aforementioned muscle-based pivot-axis-directions) defined for a plurality of muscles contributing to a common joint, respectively, is visualized for presentation to a user, according to basically the same principle as the method according to the above mode (10).

This method, therefore, would assist a user in visually verifying the validity of a designated musculoskeletal model (especially, the validity of its muscle model included in the musculoskeletal model), and in visually evaluating the motion range of each segment of a certain human, which range, for example, varies depending on whether or not the human is an ordinary human.

The evaluation results of the motion range of each segment of a certain human may be for use in assessing the maneuverability with which the human manipulates a manually-operated device, and may for use in designing the manually-operated device in view of the assessment results of the maneuverability.

(25) The method according to mode (24), further comprising:

a second defining step of defining as a second pivot-axis-direction, a direction of an axis about which selected ones of the plurality of bones represented by the selected bone models are pivoted relative to each other in response to a specified motion imparted to the human body; and

a second presentation step of visually presenting on the screen, a second pictorial-shape representative of the defined second pivot-axis-direction, in positional association with the selected joint.

Upon practice of this method, there are visualized for presentation to a user, according to basically the same principle as the method according to the above mode (10), not only at least one of a plurality of first pictorial-shapes representative of a plurality of first pivot-axis-directions (i.e., the aforementioned muscle-based pivot-axis-directions) defined for a plurality of muscles contributing to a common joint, respectively, but also the second pivot-axis-direction (i.e., the aforementioned motion-based pivot-axis-direction) for the same joint.

This method would assist the user in, for example, visually verifying the validity of a designated musculoskeletal model (especially, the validity of its muscle model included in the musculoskeletal model) with respect to articular movement of a human body occurring depending upon its physique (including the joint structure), according to basically the same principle as the method according to the above mode (10).

(26) The method according to mode (25), wherein the first presentation step is implemented to perform visual presentation of the at least one first pictorial-shape in parallel to visual presentation of the second pictorial-shape by implementation of the second presentation step.

This apparatus would provide basically the same functions and effects according to the basically the same principle, as the method according to the above mode (11).

(27) The method according to mode (25) or (26), wherein the plurality of first pictorial-shapes are defined in a three-dimensional space in the form of a plurality of first straight-lines which extend away from one joint-pivot-center of the selected joint, in the plurality of first pivot-axis-directions, up to equidistant positions, respectively, or in the form of a plurality of figures extending along the plurality of first straight-lines, respectively,

the second pictorial-shape is defined in the three-dimensional space in the form of one second straight-line which extends away from the one joint-pivot-center, in the second pivot-axis-direction, or in the form of one figure extending along the second straight-line,

the first presentation step is implemented to display the at least one first pictorial-shape two-dimensionally on the screen, in the form of at least one first projected-image obtained by projecting the at least one first pictorial-shape onto the screen in a given direction, respectively, and

the second presentation step is implemented to display the second pictorial-shape two-dimensionally on the screen, in the form of a second projected-image obtained by projecting the second pictorial-shape onto the screen in the given direction.

This apparatus would provide basically the same functions and effects according to the basically the same principle, as the method according to the above mode (12).

(28) The method according to mode (27), further comprising a third presentation step of visually presenting two-dimensionally on the screen, one spherical surface shape defined in the three-dimensional space with its center located coincident with the joint-pivot-center, and with its radius equal in length to the plurality of first straight-lines, in superposition with the first projected-image, the one spherical surface shape being displayed in the form of a projected image obtained by projecting the spherical surface shape onto the screen in the given direction.

This apparatus would provide basically the same functions and effects according to the basically the same principle, as the method according to the above mode (13).

(29) The method according to mode (28), wherein the spherical surface shape is defined in the three-dimensional space in the form of a three-dimensional mesh, and

the third presentation step includes a step of displaying the three-dimensional mesh two-dimensionally on the screen, in the form of a projected image of the three-dimensional mesh obtained by projecting the three-dimensional mesh onto the screen in the given direction.

This apparatus would provide basically the same functions and effects according to the basically the same principle, as the method according to the above mode (14).

(30) The method according to any one of modes (25)-(29), further comprising

a third defining step of determining, on a per-selected-muscle-model basis, the same direction as the defined first pivot-axis-direction as a reference pivot-axis-direction, and defining, on a per-selected-muscle-model basis, an allowable angular range over which the first pivot-axis-direction is allowed to be deviated from the reference pivot-axis-direction, wherein

each one of the first pictorial-shapes is defined in the three-dimensional space in the form of a conical surface shape geometrically specified by a centerline extending in the reference pivot-axis-direction, and a base varying in size with the defined allowable-angular-range, and

the first presentation step includes a conical-surface-shape presentation step of displaying the defined conical-surface-shape two-dimensionally on the screen, on a per-selected-muscle-model basis, in the form of a projected image of the conical surface shape obtained by projecting the conical surface shape onto the screen in a given direction.

This apparatus would provide basically the same functions and effects according to the basically the same principle, as the method according to the above mode (15).

(31) The method according to any one of modes (25)-(30), wherein the first presentation step includes a step of displaying, on a per-selected-muscle-model basis, each one of the first pictorial-shapes in a manner that a visual property of each first pictorial-shape is varied depending on a magnitude of a moment arm with which a corresponding one of the muscles to each selected muscle model exerts its action on the selected joint.

This apparatus would provide basically the same functions and effects according to the basically the same principle, as the method according to the above mode (16).

(32) The method according to any one of modes (24)-(31), further comprising an evaluation step of evaluating maneuverability with which a human manipulates a designated manually-operated device, based on the presentation of the at least one first pictorial-shape.

The “manually-operated device” set forth in the present mode and the following modes may be in the form of a user-operated steering system, a user-operated accelerator system, a user-operated brake system, switches on interior parts, switches of air-conditioner, switches of electrical parts, all for an automobile, for example.

(33) A computer-aided designing method of computer-assisting a designer in designing on a computer a designated manually-operated device manipulated by an operator, the method comprising:

a model presentation step of visually presenting on a screen of a display device at least a skeletal model of a computer-based musculoskeletal model which physically represents on the computer a plurality of bones and a plurality of muscles together making up a human body, wherein

the musculoskeletal model is constructed so as to approximately represent the plurality of bones in the form of a plurality of bone models each of which is defined as a rigid-body segment and which are pivotable relative to one another about pivot axes of a plurality of joints, and

the musculoskeletal model is constructed so as to approximately represent the plurality of muscles in the form of a plurality of muscle models each of which is defined using at least one finite element,

the method further comprising:

a defining step of defining as a muscle-based pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the muscle-based pivot-axis-direction defined on a per-selected-muscle-model basis;

a direction presentation step of visually presenting on the screen, at least one of a plurality of pictorial shapes representative of a plurality of the muscle-based pivot-axis-directions defined for the selected muscle models, respectively, in positional association with the selected joint;

an evaluation step of evaluating maneuverability with which the operator manipulates the manually-operated device, based on the presentation of the at least one pictorial shape; and

a designing step of designing the manually-operated device, based on the evaluation results of the maneuverability.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a block diagram conceptually illustrating the hardware configuration of a system 10 suitable for implementing a human- motion analysis method according to a first embodiment of the present invention;

FIG. 2 is a perspective view illustrating the lower extremity of a finite-element-based human body model indicated in FIG. 1;

FIG. 3 is a perspective view illustrating the lower extremity of a skeleton model indicated in FIG. 1;

FIG. 4 is a perspective view illustrating the lower extremity of a musculoskeletal model indicated in FIG. 1;

FIG. 5 is a view conceptually illustrating a plurality of coordinate spaces existing between a human and an object in mechanical contact with each other;

FIG. 6 is a view illustrating a muscle model of the musculoskeletal model depicted in FIG. 4, with equations (101) and (102);

FIG. 7 is a view illustrating a dynamical relationship established between a joint torque, a muscle moment arm and a muscle force in the musculoskeletal model depicted in FIG. 4, with a plurality of equations;

FIG. 8 is a front view illustrating a muscle coupling two human-bones with each other;

FIG. 9 is a perspective view for explaining the principle under which there a pivot-axis-direction of a joint is calculated from via-pints A and B depicted in FIG. 8 and a joint-pivot-center;

FIG. 10 is a view illustrating the muscle moment arm depicted in FIG. 7, in a matrix format;

FIG. 11 is a flow chart conceptually illustrating a human- motion analysis program indicated in FIG. 1;

FIG. 12 is a flow chart conceptually illustrating a skeleton model construction routine indicated in FIG. 1;

FIG. 13 is a conceptual diagram illustrating the couplings between a plurality of rigid-body segments, for explanation of the skeleton model construction program of FIG. 12;

FIG. 14 is a flow chart conceptually illustrating a motion analysis routine indicated in FIG. 1;

FIG. 15 is a flow chart conceptually illustrating a musculoskeletal model construction routine indicated in FIG. 1;

FIG. 16 is a flow chart conceptually illustrating a direction presentation routine indicated in FIG. 1;

FIGS. 17(a), 17(b) and 17(c) are a front view, a side view and a top plan view illustrating in part a common skeleton model, for explanation of the direction presentation routine depicted in FIG. 16;

FIG. 18 is a perspective view illustrating in part a skeleton model, for explanation of the direction presentation routine depicted in FIG. 16;

FIGS. 19(a), 19(b) and 19(c) are a front view, a side view and a top plan view illustrating in part a common skeleton model, for explanation of the direction presentation routine depicted in FIG. 16;

FIG. 20 is a perspective view illustrating in part a skeleton model, for explanation of the direction presentation routine depicted in FIG. 16;

FIG. 21 is an enlarged perspective-view illustrating in part the skeleton model depicted in FIG. 20, for explanation of the direction presentation routine depicted in FIG. 16;

FIG. 22 is a flow chart conceptually illustrating a musculoskeletal model correction routine indicated in FIG. 1;

FIG. 23 is a flow chart conceptually illustrating a muscle-activation-level estimation routine indicated in FIG. 1;

FIG. 24 illustrates a plurality of equations for explanation of the muscle-activation-level estimation routine depicted in FIG. 23;

FIG. 25 illustrates one equation for explanation of the muscle-activation-level estimation routine depicted in FIG. 23;

FIG. 26 is a flow chart conceptually illustrating a direction presentation routine of a human-motion analysis program executed by a computer 20 for implementing a human-motion analysis method according to a second embodiment of the present invention;

FIGS. 27(a), 27(b) and 27(c) are a front view, a side view and a top plan view illustrating in part a common skeleton model, for explanation of the direction presentation routine depicted in FIG. 26;

FIG. 28 is a flow chart conceptually illustrating a musculoskeletal model correction routine of a human-motion analysis program executed by a computer 20 for implementing a human-motion analysis method according to a third embodiment of the present invention;

FIG. 29 is a flow chart conceptually illustrating the detail of step S525 in FIG. 28, with a name of relative angle calculation routine;

FIG. 30 is a flow chart conceptually illustrating the detail of step S526 in FIG. 28, with a name of muscle-moment-arm direction correction routine;

FIG. 31 illustrates a plurality of equations for explanation of the relative angle calculation routine depicted in FIG. 29 and the muscle-moment-arm direction correction routine depicted in FIG. 30;

FIG. 32 is a view for explanation of the relative angle calculation routine depicted in FIG. 29 and the muscle-moment-arm direction correction routine depicted in FIG. 30;

FIG. 33 is a graph for explanation of the muscle-moment-arm direction correction routine depicted in FIG. 30;

FIG. 34 is a flow chart conceptually illustrating a computer-aided design program executed by a computer 20 for implementing a maneuverability evaluation method according to a fourth embodiment of the present invention;

FIG. 35 is a perspective view illustrating two bone models A and B, one muscle model D coupling the bone models A and B together, a plurality of muscle fiber models a1, . . . , au together making up the muscle model D, and a plurality of muscle-moment-arm vectors dl, . . . , du corresponding to the respective muscle fiber models al, . . . , au, all of which are used in a human-motion analysis method according to a fifth embodiment of the present invention;

FIG. 36 is a view for explanation of an equation expressing a relationship between a joint moment vector, a muscle-moment-arm matrix describing muscle moment arms per muscle fiber and a muscle force vector, and the definitions of elements or entities in the joint moment vector, the muscle-moment-arm matrix and the muscle force vector;

FIG. 37 is a flow chart conceptually illustrating a musculoskeletal model correction routine of a human-motion analysis program executed by a computer 20 for implementing a human-motion analysis method according to the fifth embodiment;

FIG. 38 is a block diagram conceptually illustrating the hardware configuration of a system 210 suitable for implementing a human-motion analysis method according to a sixth embodiment of the present invention;

FIG. 39 is a flow chart conceptually illustrating a human-motion analysis program executed by a computer 20 for implementing the human-motion analysis method according to the sixth embodiment; and

FIG. 40 is a block diagram illustrating a relationship between a plurality of models different in kind and a plurality of numerical analysis techniques different in kind, wherein the human-motion analysis method according to the sixth embodiment uses the models and performs the numerical analysis techniques.

### DETAILED DESCRIPTION OF THE INVENTION

Several presently preferred embodiments of the invention will be described in more detail by reference to the drawings in which like numerals are used to indicate like elements throughout.

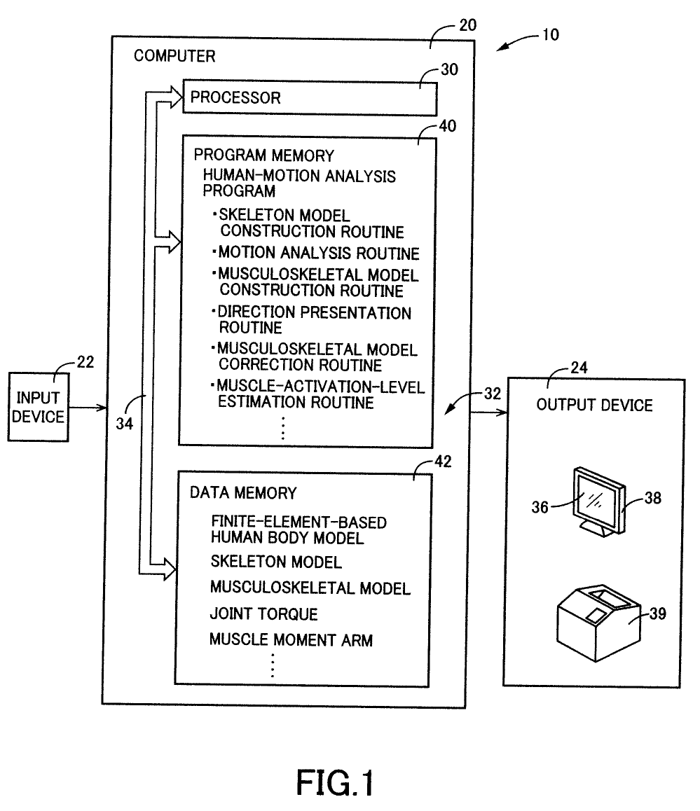

Referring now to FIG. 1, there is conceptually illustrated in block diagram the hardware configuration of a system 10 which is suitable for use in implementing a human-motion analysis method including a musculoskeletal-model construction method according to a first embodiment of the present invention.

The system 10 is adapted to perform analysis of behaviors, loads (e.g., stresses) and deformations occurring at each segment of an occupant present in a car upon contact of the car with an obstacle (i.e., upon external impact on the car), by computer simulation using a human body model. The human body model can represent or simulate a human motion on a computer 20.

As illustrated in FIG. 1, the system 10 is constructed such that an input device 22 and an output device 24 are electrically coupled to the computer 20. The computer 20, as is well known, is constructed such that a processor 30 and a storage device 32 are electrically interconnected via a bus 34.

In the computer 20, a desired program is read out from the storage device 32 and then executed by the processor 30. During execution, data required for the execution is retrieved from the storage device 32, and data representative of the execution results is stored in the storage device 32, if necessary.

The input device 22, although not shown, is so constructed as to include, for example, a mouse as an exemplary pointing device, and a keyboard. The output device 24, although not shown, is so constructed as to include a display device 38 (e.g., a Liquid Crystal Display (LCD) or a Cathode Ray Tube (CRT)) for displaying on a screen 36 images in various formats such as a text format or a graphics format, and a printer 39.

As illustrated in FIG. 1, the storage device 32 is provided with a program memory 40 and a data memory 42. In the program memory 40, various programs beginning with a human-motion analysis program have been previously stored. This human-motion analysis program,, which will be described below in more detail though, is so configured as to include a skeleton model construction routine; a motion analysis routine; a musculoskeletal-model construction routine; a direction presentation routine; a musculoskeletal-model correction routine; and a muscle-activation-level estimation routine.

In the data memory 42, there has been previously stored model data which is for defining various types of physically-based human-body models each representing or simulating the whole human body three-dimensionally by the computer 20. These various types of physically-based human-body models include a finite-element-based human body model; a skeleton model in the form of a multi-joint rigid-body segment-based model; and a musculoskeletal model in the form of a multi-joint rigid-body segment-based model, similarly.

The finite-element-based human body model is a model for approximately representing a human body by partitioning the human body into a plurality of finite elements (hereinafter, referred to simply as “elements”). This finite-element-based human body model, which has its original use in analyzing a human motion by simulation using the finite element method, is also utilized for construction of a skeleton model in the present embodiment, which allows the skeleton model to be constructed not from zero, but from the finite-element-based human body model, resulting in improved efficiency and shortened time incurred for constructing the skeleton model.

In contrast to the finite-element-based human body model, the multi-joint rigid-body-segment-based model, which is used for constructing the skeleton model and as the musculoskeletal model, is referred in the art to also as a mechanical model. This mechanical model is constructed such that a plurality of rigid-body segments are pivotably coupled to one another around a plurality of joints, with greater advantage to representation of a human motion than to representation of the shape of a human body.

For both the skeleton model and the musculoskeletal model, a plurality of rigid-body segments forming each model constitute a plurality of bone models representing a plurality of bones of a human body by the computer 20.

The finite-element-based human body model has a plurality of elements which represent a plurality of tissues or structures of a human body, wherein each element is defined in terms of attributes such as a shape, a density, material properties, etc. The physical quantities such as the positions (i.e., exemplary geometrical quantities) of a plurality of nodes constituting each element, and the material properties are all defined in a single global-coordinate-system.

This finite-element-based human body model, owing to having been constructed by modeling the whole human body, including not only its skeleton structure but also its joining structure such as ligaments, tendons, muscles, etc., represents the whole human body in terms of its anatomical shape, structure, and characteristics, with high fidelity. As a result, physical responses of each segment to an external force are accurately represented.

Further, this finite-element-based human body model is configured to have a variable parameter which defines at least one of the shape, the position, the mechanical properties and the dynamical properties of at least one segment of the finite-element-based human body model. The variable parameter is specified by a user who is a designer or an analyzer, prior to a human-motion analysis.

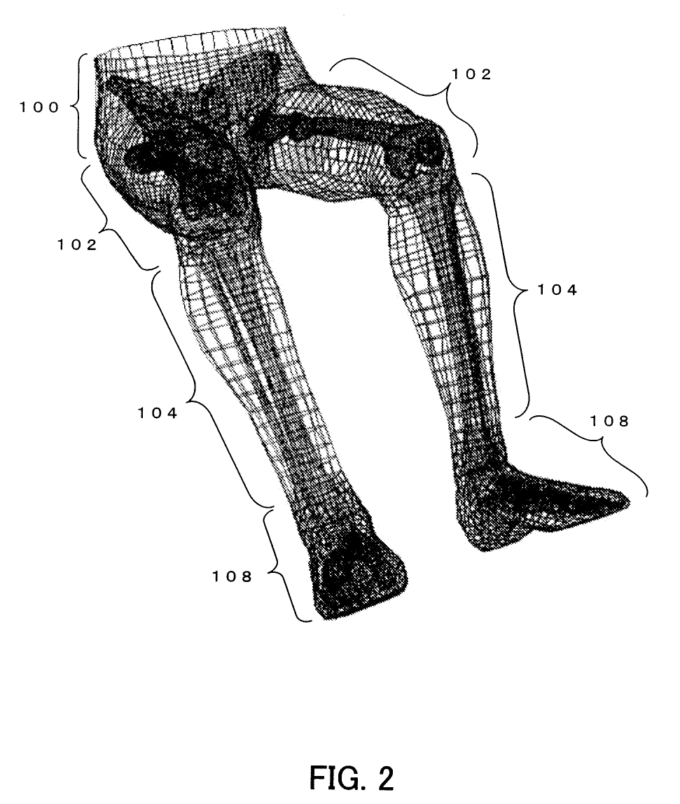

FIG. 2 illustrates a finite-element-based human body model in perspective view only with respect to its lower extremity. As illustrated in FIG. 2, this finite-element-based human body model represents not only the skeleton of a human body but also soft tissues such as muscles, skins, etc., of the human body. The lower extremity of this finite-element-based human body model is segmented into a lumbar region 100, right and left femur regions 102 and 102, right and left crus regions 104 and 104, and right and left foot regions 106 and 106.

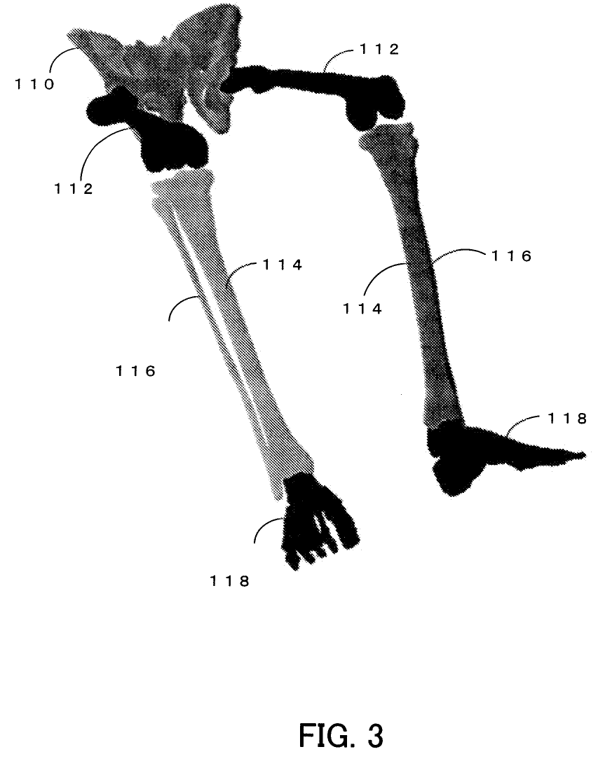

FIG. 3 illustrates a skeleton model in perspective view only with respect to its portions which correspond to portions of the finite-element-based human body model which are illustrated in FIG. 2. As illustrated in FIG. 3, this skeleton model represents only the skeleton of a human body. The lower extremity of this skeleton model is segmented into a pelvis 110, right and left femurs 112 and 112, right and left tibias 114 and 114, right and left fibulas 116 and 116, and right and left foot bones 118 and 118. Each foot bone 118 is in the form of a complex of fine bones.

In this skeleton model, each structure or tissue of a human body is expressed with a plurality of rigid-body segments which are pivotably coupled to one another at joints. The rigid-body segments include the pelvis 110, the right and left femurs 112 and 112, the right and left tibias 114 and 114, the right and left fibulas 116 and 116, and the right and left foot bones 118 and 118.

The surface of the shape of each rigid-body segment is in the form of polygons. A plurality of vertices of the polygons are equal to a plurality of nodes of a plurality of elements together forming a base shape of the polygons. Therefore, the shape of each rigid-body segment is represented by corresponding polygon data. To each rigid-body segment, a local coordinate system is assigned in which there are defined the mass, the moment of inertia, and the position of each polygon, of the corresponding rigid-body segment.

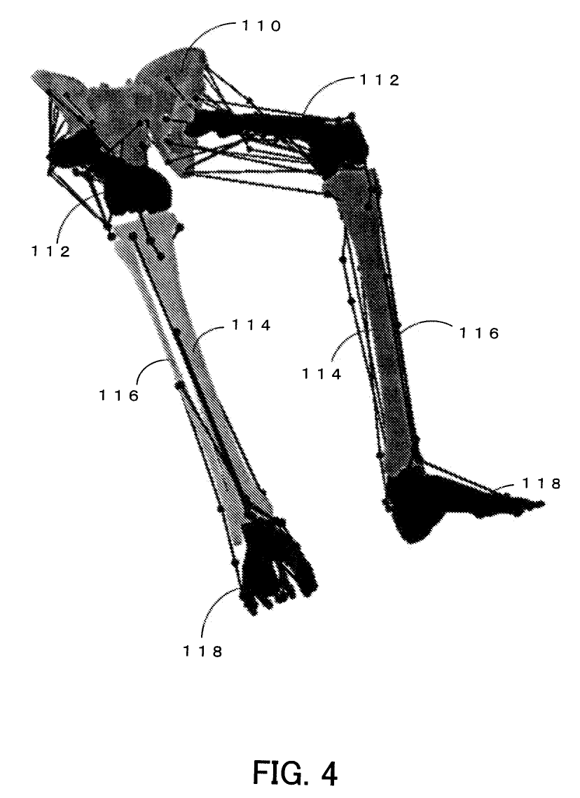

FIG. 4 illustrates a musculoskeletal model in perspective view with respect to its portions which correspond to portions of the skeleton model which are illustrated in FIG. 3. As illustrated in FIG. 4, this musculoskeletal model is constructed by adding muscles in the form of wire elements (illustrated in bold lines in FIG. 4) to the skeleton model illustrated in FIG. 3, to thereby represent only the skeleton and muscles of a human body. That is to say, this musculoskeletal model is constructed by combining the aforementioned skeleton model with a plurality of muscle models (i.e. muscle-element models) each of which is in the form of a wire element.

The plurality of muscle models constituting the musculoskeletal model represent by the computer 20 a plurality of muscles of a human body as wire elements each of which transmits a force one-dimensionally.

In this musculoskeletal model, each muscle is defined in terms of its attachment (origin/insertion) points at which each muscle is attached to the corresponding bones, and its via-points via which each muscle travels between the corresponding attachment points when each muscle is attached to the corresponding bones.

At the attachment points, as denoted by black-colored circles in FIG. 4, each muscle is inhibited from moving relative to the corresponding bones. At the via-points, as denoted by black-colored circles in FIG. 4, each muscle is allowed to move relative to the corresponding bones along each muscle, but is inhibited from moving relative to the corresponding bones across each muscle.

In light of the anatomical configuration that a muscle is attached to the surfaces of the corresponding bones, each muscle model is attached to the surface of each rigid-body segment (i.e., each bone model or each bone-element model) in a similar fashion.

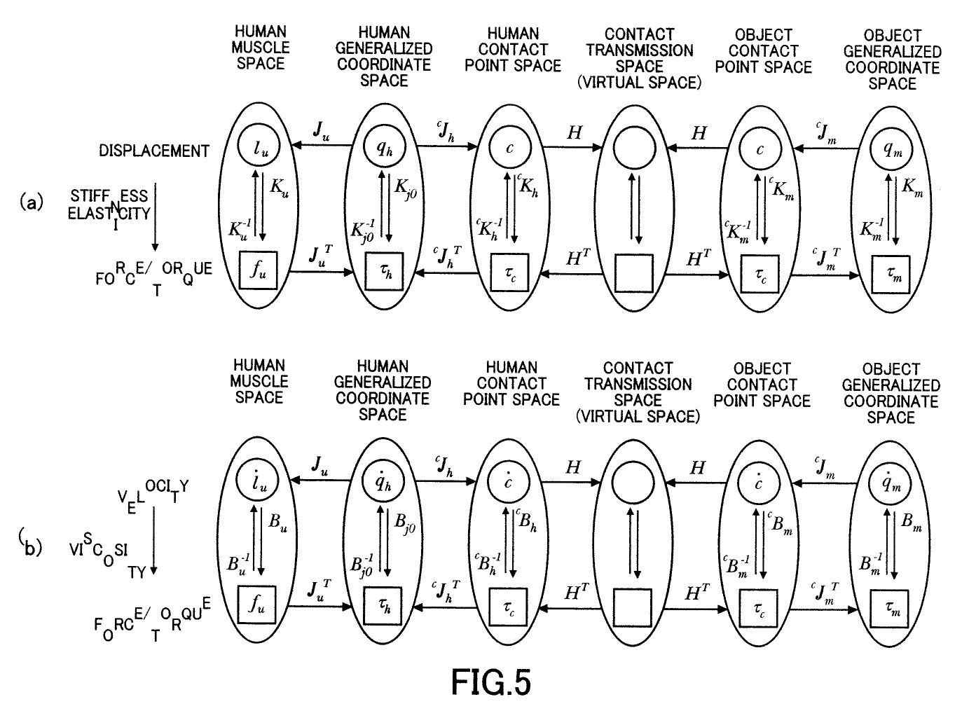

FIG. 5 illustrates conceptually a plurality of coordinate spaces which exist between a human and an object (e.g., a vehicle or a machine) in mechanical contact with each other.

These coordinate spaces include, when viewed from the human side to the object side:

a muscle space in which a human muscle exists;

a human generalized coordinate space in which a generalized coordinate exists to represent a human motion (e.g., a displacement qₕ, a velocity, an acceleration, etc., of the human);

a human contact point space in which a contact point of the human with the object exists;

a contact transmission space as a virtual space;

an object contact point space in which a contact point of the object with the human exists; and

an object generalized coordinate space in which a generalized coordinate exists to represent object motion (e.g., a displacement qₘ, a velocity, an acceleration, etc., of the object).

FIG. 5 further illustrates matrices Jᵤ, ^{c}Jᵤ, H and ^{c}Jₘ, each of which is for use in performing coordinate transformation between adjacent one of the coordinate spaces. The definitions of these symbols will be described below in more detail.

For example, as illustrated in FIG. 5(a), the matrix Jᵤ, as located between the muscle space and the human generalized coordinate space, physically correlates a muscle length (i.e., a muscle displacement) lᵤ with a human displacement qₕ which is an exemplary one of attributes of a human motion (i.e., lᵤ=Jᵤqₕ).

As illustrated in FIG. 5(b), the matrix Jᵤ, as located between the muscle space and the human generalized coordinate space, physically correlates a muscle-length changing velocity (i.e., the rate of change of muscle displacement) dlᵤ/dt with a human velocity dqₕ/dt which is an exemplary one of attributes of a human motion (i.e., dlᵤ/dt=Jᵤdqₕ/dt).

FIG. 5(a) further illustrates how a displacement and a power/torque are physically correlated with each other via a stiffness (elasticity) as a physical property, per coordinate space.

More specifically, in the muscle space, the muscle displacement 1ᵤ and a muscle force fᵤ are physically correlated with each other via a muscle stiffness (human stiffness) Kᵤ. In the human generalized coordinate space, the human displacement qₕ and a human generalized-force τₕ are physically correlated with each other via a stiffness Kⱼₒ responsive to the joint passive characteristics.

In the human contact point space, a displacement c and a contact force τ_{c} both of the contact point are physically correlated with each other through a stiffness ^{c}Kₕ. In the object contact point space, the displacement c and the contact force τ_{c} both of the contact point are physically correlated with each other via a stiffness ^{c}Kₘ. In the object generalized coordinate space, an object displacement qₘ and an object generalized-force τₘ are physically correlated with each other via an object stiffness Kₘ.

Of the various terms and symbols described above, the “displacement” is a collective term used to mean both a position of a particular moving body identified when viewed from the perspective of its translational movement, and a position of the same body identified when viewed from the perspective of its rotational movement, as a result of the generalization of these positions.

More specifically, the human displacement qᵤ, in the human generalized coordinate space, collectively means a position of a particular point of the human identified with respect to its translational movement, and a position of the same point identified with respect its rotational movement.

The object displacement qₘ, in the object generalized coordinate space, collectively means a position of a particular point of the object identified with respect to its translational movement, and a position of the particular point identified with respect to its rotational movement.

The description of the definition of the “displacement,” which has been made above, applies the “velocity” and “acceleration” both described below, with necessary modifications.

In addition, the “generalized force τ” is a corrective term used to mean both a force and a torque or a moment each acting on a particular moving body, as a result of the generalization of these force and torque or moment.

More specifically, the generalized force τₕ means a force and a torque acting on a human joint, in the human generalized coordinate space (also serving as a joint space of defining a human joint). The muscle force fᵤ, which is a physical quantity classified, similarly with the generalized force τ, as a force acting on a human, means a force (a compressive force) acting on a muscle in the muscle space. On the other hand, the generalized force τₘ means a force and a torque each acting on the object in the object generalized coordinate space.

The contact force τ_{c}, which means a generalized force acting on a contact point of the human with the object, is a collective term used to mean both a force and a moment each acting on the contact point, as a result of the generalization of these force and moment.

As illustrated in FIG. 5, the contact force τ_{c} is found in each of the human contact point space and the object contact point space, and the two contact forces τ_{c} are related to have identical magnitudes and opposite directions.

While some of the terms and symbols shown in FIG. 5 have been described above, the remaining terms and symbols will be described below in more detail.

FIG. 5(b) illustrates how a speed and a force/torque are physically correlated with each other via a viscosity as a physical property, per coordinate space.

More specifically, in the muscle space, the muscle-length changing velocity dlᵤ/dt and the muscle force fᵤ are physically correlated with each other via a muscle viscosity (a human viscosity) Bᵤ. In the human generalized coordinate space, the human velocity dqₕ/dt and the generalized force τₕ are physically correlated with each other via a viscosity Bⱼₒ responsive to the joint passive characteristics.

In the human contact point space, a velocity dc/dt and the contact force τ_{c} both of the contact point are physically correlated with each other via a viscosity ^{c}Bₕ. In the object contact point space, the velocity dc/dt and the contact force τ_{c} both of the contact point are physically correlated with each other via a viscosity ^{c}Bₘ. In the object generalized coordinate space, a velocity dqₘ/dt and the generalized force τₘ both of the object are physically correlated with each other via an object viscosity Bₘ.

In the present embodiment, a physically-based human body model bearing human-body physical properties is constructed to take the form of a rigid-body-segment-based human body model (e.g., a skeleton model, a musculoskeletal model, etc.) or a finite-element-based model (e.g., a finite-element-based human body model).

More specifically, the physically-based human body model employed in the present embodiment represents each segment of a human body using rigid or elastic elements (n_{b}=total number). In this physically-based human body model, these elements are constrained or coupled to one another via joints (nⱼ=total number) to thereby form a skeleton structure or a musculoskeletal structure.

In addition, in this physically-based human body model, muscles and tendons (nₐ=total number) of a human body are represented using the positions of attachment points and via-points of these muscles and tendons relative to individual segments of the human body.

This physically-based human body model bears its physical properties per each segment of a human body, which consist of a dimension, the position of a gravity center (i.e., center-of-mass), a principal moment of inertia, joint positions, a skin-surface viscoelasticity, etc.

This physically-based human body model further bears its physical properties per each joint of the human body, which consist of a type, a viscoelasticity, etc.

This physically-based human body model still further bears its physical properties per muscle of the human body, which consist of the positions of muscle attachment points on bones, the positions of muscle via-points, a maximum muscle force fₘₐₓ and a pennation angle described below, a free muscle length, a stiffness (or elasticity) Kᵤ, a viscosity Bᵤ, etc.

In the present embodiment, as described above, a skeleton model in the form of a first rigid-body-segment-based model is constructed from a finite-element-based human body model in the form of a finite-element-based model, and then a musculoskeletal model in the form of a second rigid-body-segment-based model is constructed by attaching to the constructed skeleton model, a muscle model (a muscle-element model), which is geometrically defined with the muscle attachment points and the muscle via-points.

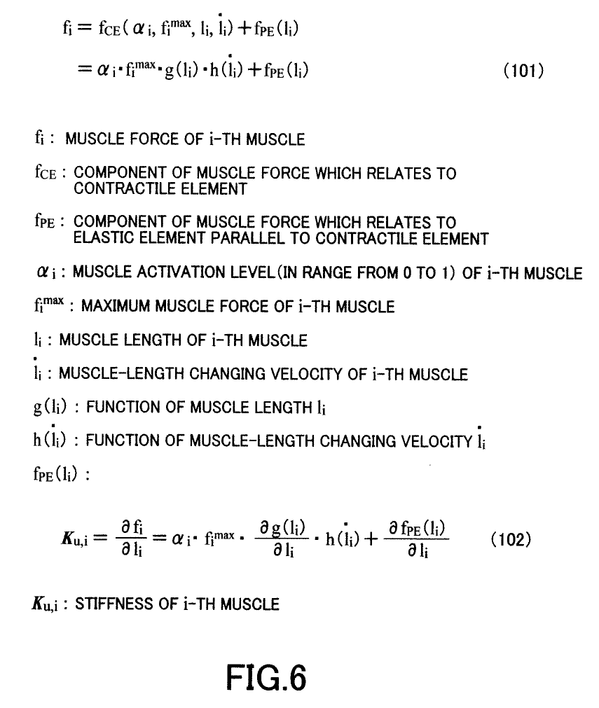

As expressed by equation (101) in FIG. 6, once the maximum muscle force fₘₐₓ, a function gᵤ of the muscle length l, and a function hᵤ, of the muscle-length changing velocity have been defined, a muscle force fᵢ is derived per muscle, That is to say, in the present embodiment, equation (101) constitutes an exemplary equation for describing each muscle model.

In the present embodiment, as described above, a human body is represented as a multi-rigid-body-linked model in which a plurality of rigid-body segments each acting as a link are pivotably coupled to one another. By the use of the multi-rigid-body-linked model, the posture of a human body is uniquely determined by the joint angle of each joint.

In the present embodiment, the joint angle of each joint is derived, according to the above-described kinematical relation, by inverse kinematics analysis, based on information indicative of the positions of finger tips and a toe of a human body.

Further, in the present embodiment, once the joint angle of each joint has been derived by inverse kinematics analysis, a joint torque acting on each joint is, in turn, derived by inverse dynamics analysis.

More specifically, a joint torque (included in the generalized force τₕ (see FIG. 5) as its constituent) acting on each joint is derived, in view of a balance between forces acting on each joint, based on information indicative of weights of the finger tips and of the toe and external forces applied to the finger tips and the toe (i.e., the contact force τ_{c} applied to the human from the object); the inertia of each rigid-body segment; and a centrifugal/Coriolis force acting on each rigid-body segment.

In addition, in the present embodiment, a muscle activation level α is estimated per muscle by an optimization method which will be described below, based on human muscle characteristics (e.g., the maximum muscle force fₘₐₓ, the function gᵤ of the muscle length l, which function serves as a muscle stiffness parameter, the function hᵤ of the muscle-length changing velocity, which function serves as a muscle viscosity parameter, a free muscle length, etc.) and a human motion, and the thus-derived joint torque (included in the generalized force τₕ as its constituent).

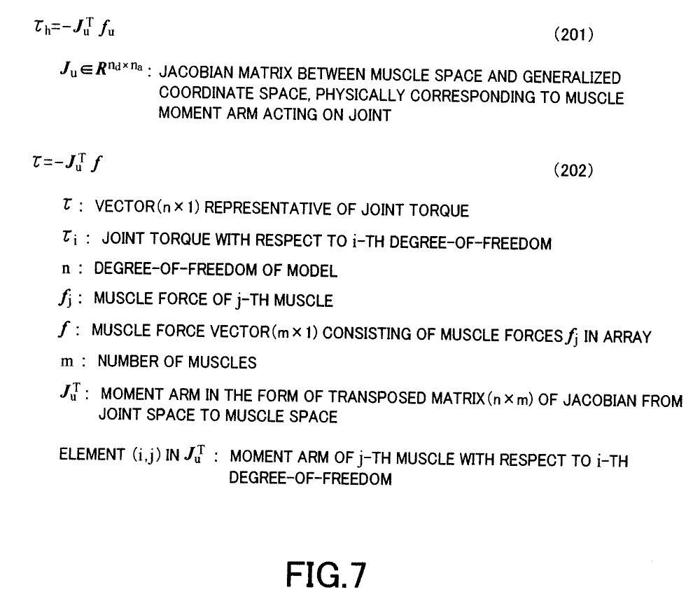

In FIG. 7, equation (201) is shown as the equation of relation between the generalized force τₕ and the muscle force fᵤ. This equation (201) indicates that the generalized force τₕ is derived as the product of the transposed matrix Jᵤ^{T} of the Jacobian matrix Jᵤ and the muscle force fᵤ.

The Jacobian matrix Jᵤ, which is a matrix used for coordinate transformation from the muscle space to the human generalized coordinate space (i.e., the joint space), is shown in FIG. 5 along with the transposed matrix Jᵤ^{T} The Jacobian matrix Jᵤ depends on the posture, that is to say a joint angle of a musculoskeletal model. The muscle force f is a function of the muscle activation level α.

In FIG. 7, equation (202) is shown as the equation of relation between the joint torque τ of the generalized force τₕ and a muscle force f of the muscle forces fᵤ which generates the joint torque τ. This equation (202) indicates that the joint torque τ is derived as the product of the transposed matrix Jᵤ^{T} and the muscle force f.

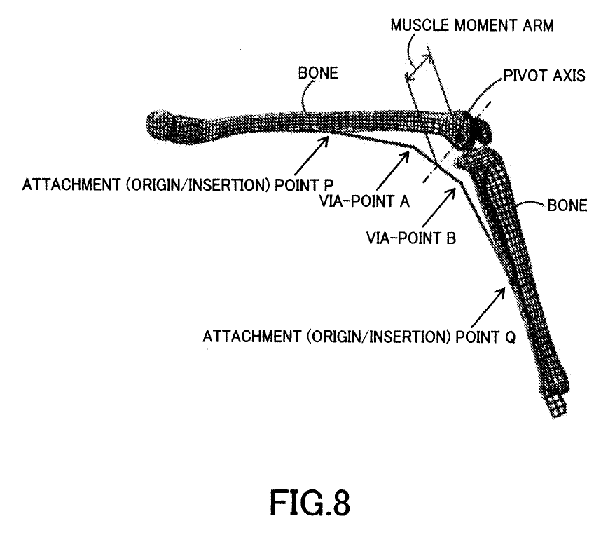

As illustrated in FIG. 8, the transposed matrix Jᵤ^{T} physically corresponds to a muscle moment arm contributing to a joint. In the present embodiment, by the system design, necessary adjustment of the muscle moment arm would cause corresponding elements in the Jacobian matrix Jᵤ to change accordingly.

In the present embodiment, for constructing a musculoskeletal model, data indicative of the aforementioned finite-element-based human body model is retrieved from the data memory 42 at the beginning. As described above, the finite-element-based human body model is a finite-element-based model which represents a human body using a plurality of finite elements, and which has been previously assigned the attribution or correspondence between a plurality of segments making up a human body and the plurality of finite elements.

By the use of the retrieved finite-element-based human body model, the aforementioned skeleton model is constructed.

More specifically, the plurality of finite elements making up the finite-element-based human body model are grouped according to the aforementioned attribution and combined together per each group, with the result that a plurality of segments making up a human body are represented in the form of a plurality of rigid-body segments which are pivotable about joints. This is how the skeleton model is constructed.

According to ones of the plurality of finite elements of the aforementioned finite-element-based human body model, which ones represent a plurality of muscles of a human body, there are defined on the constructed skeleton model, a plurality of wire elements each of which represents a respective muscle in the form of a wire, along with the positions of attachment points and via-points of each muscle relative to a respective rigid-body segment.

FIG. 8 illustrates how one muscle is attached to two bones which are pivotably coupled to each other about a pivot axis of a common joint, with the muscle spanning these bones. The muscle is attached at its one end to one bone at a muscle attachment (origin/insertion) point P, while the muscle is attached at its other end to the other bone at a muscle attachment (origin/insertion) point Q.

As illustrated in FIG. 8, an intermediate region of the muscle, which has no attachment to the two bones, is defined by two muscle via-points A and B through which the muscle passes when traveling between the two muscle attachment points P and Q. The muscle via-point A is dynamically supported by one of the two bones to which the muscle attachment point P belongs, while the muscle via-point B is dynamically supported by one of the two bones to which the muscle attachment point Q belongs.

Because of that geometry allowing two bones to be mutually coupled by one muscle, the occurrence of a tensile force at the muscle would cause a joint torque about the pivot axis of a common joint to be generated at the two bones. The magnitude of the joint torque does not only depend on the magnitude of a muscle force generated by the muscle, but also depends on a distance between a line along which the muscle force applies and the pivot axis, that is to say the direction and the magnitude of a muscle moment arm.

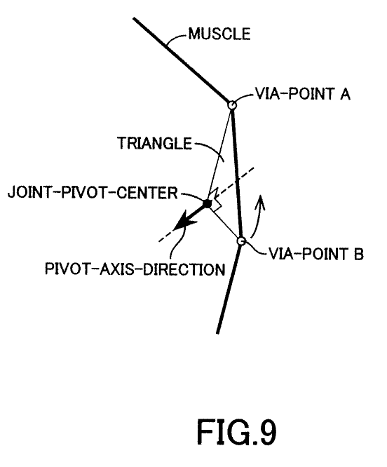

On the other hand, in the present embodiment, as illustrated in FIG. 9 in perspective view, the direction of the pivot axis of each joint is provisionally calculated in the global coordinate system per joint, based on position coordinates indicative of the center point of a joint (i.e., position coordinates indicative of the origin of a joint coordinate system described below, as viewed in the global coordinate system), and position coordinates indicative of the two muscle via-points A and B (i.e., position coordinates in the global coordinate system). The center point of a joint is denoted as “pivot axis” in FIG. 8, and “joint-pivot-center” in FIG. 9.

More specifically, a triangle is virtualized with its three vertices being located at the joint-pivot-center, and the two muscle via-points A and B, respectively, in a three-dimensional space, and then one straight line is determined as a provisional pivot-axis, which extends perpendicular to a plane that the triangle is located on and through the joint-pivot-center.

In the present embodiment, the direction of the pivot axis is defined as the direction of a muscle moment arm, while a distance between the pivot axis and one straight line passing through the two muscle via-points A and B is defined as the magnitude of the muscle moment arm.

The thus-calculated pivot-axis has two opposite directions. In the present embodiment, one of these two directions is selected as the pivot-axis-direction, which is given by the right-hand screw rule when the muscle via-point B moves toward the muscle via-point A in response to muscle contraction in a direction indicated by the thin arrow in FIG. 9.

In the present embodiment, as expressed by equation (202) in FIG. 7, force equilibrium is considered in which a vector indicative of the joint torque τ is equal to the product of a matrix indicative of the muscle moment arm Jᵤ^{T} and a vector indicative of the muscle force f. The muscle force vector f is a vector indicative of only the magnitude of muscle force, per muscle.

In the present embodiment, for the convenience of calculation, the muscle force vector f is not defined to indicate the direction of muscle force, and instead, the resultant of a direction of muscle force and a direction of muscle moment arm is provided for calculation of a moment. The resultant is expressed by the muscle moment arm matrix Jᵤ^{T}.

As a result, in the present embodiment, coincidence is reached between the direction of a joint torque derived by inverse kinematics analysis and inverse dynamics analysis, and the direction of a muscle moment arm indicated by the muscle moment arm matrix Jᵤ^{T}, provided that a musculoskeletal model has been ideally constructed.

The joint torque vector τ indicates both the direction and the magnitude of joint torque, per joint. The direction of joint torque T means the direction of a pivot axis about which two bones are pivoted relative to each other, wherein the two bones are pivotably coupled to each other. The pivot axis (hereinafter, referred to as “reference pivot-axis”) corresponds to the aforementioned “second pivot-axis (i.e., the aforementioned motion-based pivot-axis).”

The muscle moment arm matrix Jᵤ^{T} indicates both the direction and the magnitude of muscle moment arm, per muscle.

The direction of muscle moment arm means the direction of a pivot axis about which two bones are pivoted to relative to each other in response to expansion/contraction of each muscle contributing to a motion of each joint, wherein the two bones are pivotably coupled to each other about each joint. The pivot axis (hereinafter, referred to as “individual pivot-axis”) corresponds to the aforementioned “first pivot-axis (i.e., the aforementioned muscle-based pivot-axis).”

The magnitude of muscle moment arm means a distance between the individual pivot-axis and a muscle travel (i.e., a muscle path represented by a straight line interconnecting the two muscle via-points A and B in FIG. 9), in a three-dimensional space.

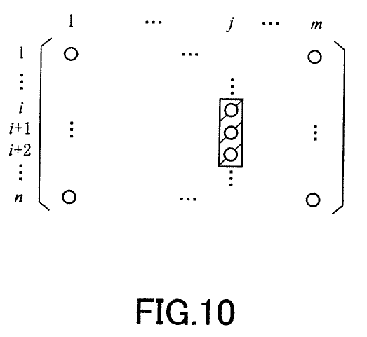

FIG. 10 shows a muscle moment arm matrix Jᵤ^{T}. This is an n×m matrix where the total number of degree-of-freedoms of a musculoskeletal model is denoted as “n”, and the total number of muscles is denoted as “m.” Now, assuming that the j-th muscle of muscles (total number: m) contributes to a motion of a selected one of the joint which is in the form of a spherical joint, the corresponding muscle moment arm will be discussed,

In a case where the selected joint is assigned the degree-of-freedoms (total number: n) including the i-th, (i+1)-th and (i+2) -th degree-of-freedoms, a muscle moment arm vector of the selected joint with respect to the j-th muscle is expressed by a vector consisting of elements (i, j), (i+1, j) and (i+2, j) of a muscle moment arm matrix Jᵤ^{T}. This vector is depicted within the square block in FIG. 10.

The direction of this muscle moment arm vector indicates the direction of the aforementioned individual pivot-axis, while the magnitude of this muscle moment arm indicates a distance between the individual pivot-axis and the aforementioned muscle travel.

For example, in a case where a muscle moment arm vector v at a particular joint is expressed by “(vₓ, v_{y}, v_{z},),” the magnitude |v| of this muscle moment arm vector v is expressed by a scalar which is the square root of (vₓ²+v_{y}²v_{z}²), while the direction of this muscle moment arm vector v is expressed by a unit direction-vector which is (vₓ/|v|, v_{y}/|v|, v_{z}/|v|).

As illustrated in FIG. 10, the muscle moment arm matrix Jᵤ^{T} consists of a plurality of elements in a two-dimensionally array both in a row direction indicating a serial number i of degree-of-freedom, and a column direction indicating a serial number j of muscle. Therefore, the muscle moment arm matrix J^{T} defines muscle moment arms for all pairs of human muscles and degree-of-freedoms of human joints.

It is noted that each muscle does not always contribute to rotational movements about all motion axes, and at least one of degree-of-freedoms which relates to a motion axis not used for rotational movement is selected and assigned zero. Which one of degree-of-freedoms is selected and assigned zero is determined on a joint-by-joint basis, depending upon the physical configuration of each joint in some cases, and depending upon the relative positional-relation between the direction of muscle travel of each muscle and each joint in other cases.

For example, in a case where a muscle moment arm vector v of a particular muscle with respect to a particular joint is expressed by “(vₓ, v_{y}, v_{z}),” and where the particular joint, because of its structural constraint, can flex only about an x-axis, the muscle moment arm vector v of the particular muscle, upon replacement with “(vₓ, 0, 0),” is incorporated into the muscle moment arm matrix Jᵤ^{T}.

As a result, the muscle moment arm matrix Jᵤ^{T} is formulated so as to reflect the degree-of-freedoms of all joints in terms of pivotal movements, the directions of muscle travels of all muscles, and distances between all muscle travels and associated joint-pivot-centers.

On the other hand, the joint torque vector τ, which is calculated by performing inverse kinematics analysis and inverse dynamics analysis, as described above, the calculated value is basically independent of construction errors occurring in a model for use in the those analyses, that is to say a muscle model.

In contrast, a muscle moment arm matrix Jᵤ^{T} is dependent on positional errors in the muscle via-points which are defined manually per bone, that is to say construction errors in a muscle model.

For these reasons, the calculation accuracy of the magnitude of the muscle force vector f, that is to say a muscle force of each muscle, both of which are derived from the joint torque vector τ and the muscle moment arm matrix Jᵤ^{T}, depends on errors in the muscle moment arm matrix Jᵤ^{T}.

On the other hand, in a case where a plurality of muscles can contribute to a motion of a common joint, the direction of the reference pivot-axis of the common joint varies depending on which one of the muscles is selectively activated and contracted.

For the above reason, for enabling a musculoskeletal model to faithfully simulate muscular movement of a real human, it is preferable to perform (a) selection from a plurality of muscles contributable to a motion of a common joint, of a muscle to be activated for achieving a particular flexing motion of the common joint, which muscle has its individual pivot-axis close in direction to a pivot axis about which the common joint is flexed for achieving the particular flexing motion; and (b) analysis of a human body using the musculoskeletal model such that the selected muscle acts more predominantly than other non-selected muscles.

Every muscle, not merely in the form of a straight line, has its thickness, and every muscle attachment point on a bone, not merely in the form of a point in a narrow sense, has its area.

For these reasons, the direction of a force generated in each muscle in action does not remain unchanged, but changes so as to move toward the direction in which an associated joint flexes in response to muscle action.

That is to say, each muscle, when attempting to cause an associated joint to flex, spontaneous changes in the direction of a force generated in each muscle, such that the muscle force direction moves toward the direction in which the associated joint is flexed, with the result that the muscle force acts on the associated joint more efficiently.

Therefore, for enabling a musculoskeletal model to faithfully simulate muscular movement of a real human, it is also preferable to apply correction to the musculoskeletal model so that each muscle, which has been selected as a result of the above preferable selection, may be altered such that its individual pivot-axis moves toward the reference pivot-axis. More specifically, the above correction of a musculoskeletal model is achieved by correcting its muscle moment arm matrix Jᵤ^{T}m, with an enhanced accuracy in calculating its muscle force vector f.

In light of the findings described above, in the present embodiment, a muscle moment arm matrix Jᵤ^{T} is corrected per each muscle having its individual pivot-axis which is close to the reference pivot-axis, such that the individual pivot-axis moves toward the reference pivot-axis, to thereby correct the musculoskeletal model. In this regard, prior to correction, the individual pivot-axis has its relative angle with respect to the reference pivot-axis, which angle is equal to or less than an allowable limit.

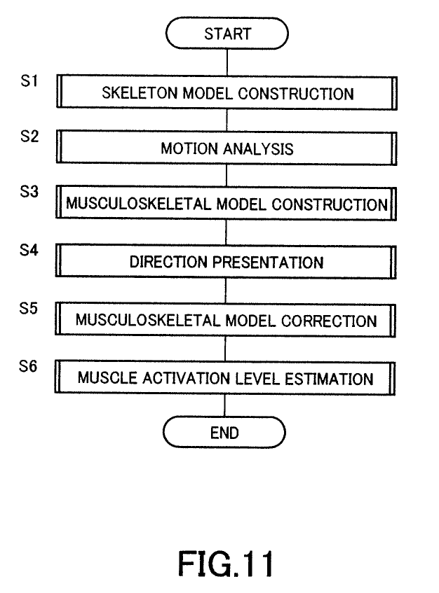

FIG. 11 conceptually illustrates in flow chart the human-motion analysis program indicated in FIG. 1, which is executed by the computer 20. As described above, the computer 20 cooperates with the input device 22 and the output device 24 to constitute the system 10.

During each cycle of execution of the human-motion analysis program, a step Si is first implemented to construct or create a skeleton model using a finite-element-based human body model.

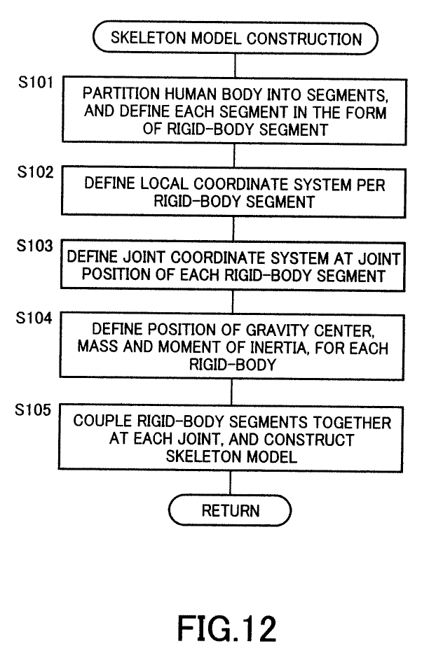

FIG. 12 conceptually illustrates in flow chart the details of the step S1 as the skeleton model construction routine (see FIG. 1).

Upon execution of the skeleton model construction routine, a step S101 is first implemented to retrieve the finite-element-based human body model from the data memory 42 into a working area (not shown) which is an additional memory area separately assigned to the storage device 32, on an element-by-element basis. More precisely, sets of model data representative of the finite-element-based human body model are sequentially retrieved, per element data representative of each element.

This step S101 is further implemented to allocate ones of a plurality of elements (i.e., finite elements) together constituting the finite-element-based human body model, which ones represent human bones, to a plurality of segments together constituting a human body. Ones of the elements together constituting the finite-element-based human body model, which ones represent human tissues or structures excluding bones, that is to say tissues or structures such as skin, flesh, etc., are not allocated to the human body.

For the finite-element-based human body model, there has been previously determined attribution or correspondence between the elements of the model and human segments to which these elements belong, on an element-by-element basis.

That is to say, data for defining the relationship between the elements of the model and the human segments has been previously embedded in the model data representative of the finite-element-based human body model. Using this data, the individual elements of the model are allocated to the corresponding individual segments of a human body.

Ones of the plurality of elements of the model which have been allocated to each human segment are joined together, on per-human-segment basis, to thereby form one rigid-body segment (i.e., a bone model) in the skeleton model.

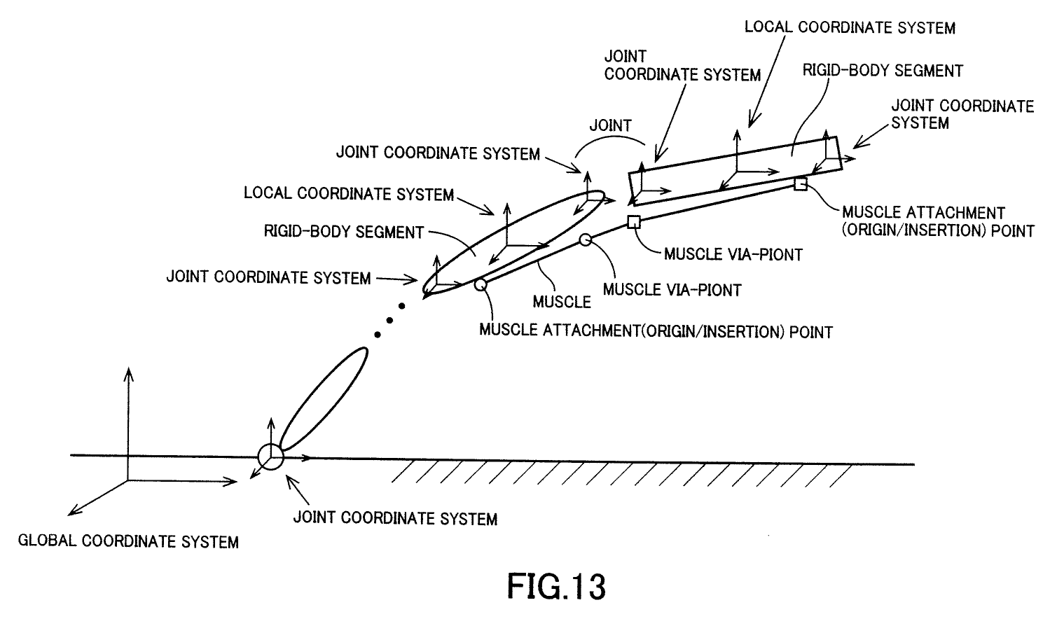

Next, at a step S102, a local coordinate system is defined per rigid-body segment, such as illustrated in FIG. 13. Each local coordinate system has its origin coincident in position with the gravity center of each rigid-body segment. The local coordinate systems are defined or specified by the user of the system 10.

Each local coordinate system contains x, y and z coordinate axes which coincide in direction with a plurality of principal axes of inertia of each rigid-body segment, respectively. However, the x, y and z coordinate axes are assigned to the plurality of principal axes of inertia in the order in which a corresponding moment of inertia decreases. For each local coordinate system to become a right-handed coordinate system, the individual coordinate axes are adjusted in orientation and handedness.

Subsequently, at a step S103, a point is defined which turns out to specify a joint position located between two adjacent human-segments. The point is defined to be coincident with any one of points in the finite-element-based human body model. The point represents a joint position located between two adjacent rigid-body segments, The joint position is defined or specified by the user.

This step S103 is further implemented, as illustrated in, for example, FIG. 13, to assign a joint coordinate system to the defined joint position. The origin of the joint coordinate system coincides with the position of a corresponding joint-pivot-center. The joint coordinate system is defined or specified by the user.

A step S104 is subsequently implemented, on per-rigid-body-segment basis, to calculate the position of gravity-center (i.e., the center-of-mass), the mass, and the moment of inertia, of each rigid-body segment, from attribute information (e.g., the shape, the density, the material properties, etc.) of a plurality of elements belonging to each rigid-body segment.

For calculation of those quantities including the position of gravity-center, the mass and the moment of inertia, consideration is taken of not only ones of a plurality of elements together constituting the finite-element-based human body model, which ones represent human bones, but also ones which represent human tissues excluding bones, that is to say tissues such as skin, flesh, etc.

As a result, in the skeleton model, each rigid-body segment has its shape so as to reflect the surface of each bone, and has the position of its gravity center, its mass and its moment of inertia so as to reflect all tissue regions together forming a human segment corresponding to each rigid-body segment.

Subsequently, at a step S105, coordinate transformation is performed for a plurality of rigid-body segments such that ones of their joint coordinate systems which are assigned to each pair of adjacent rigid-body-segments become coincident with each other, to thereby allow the plurality of rigid-body segments to be pivotably coupled to one another about corresponding joints.

The coordinate transformation is performed according to a direction issued from the user. As a result, the construction of skeleton model is completed. The thus-constructed skeleton model (precisely, data representative of the skeleton model) is stored in the data memory 42.

Then, one cycle of execution of this skeleton model construction routine is terminated.

Upon termination of one cycle of execution of this skeleton model construction routine, motion analysis is performed at a step 32 illustrated in FIG. 11.

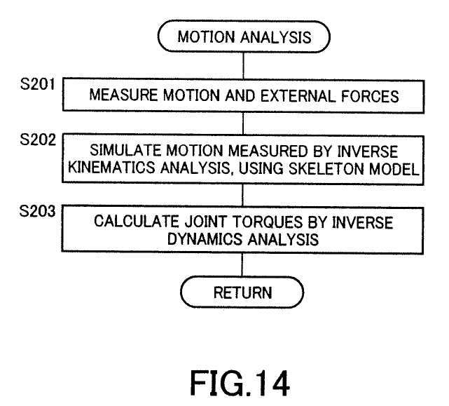

FIG. 14 conceptually illustrates in flow chart the details of the step S2 as the motion analysis routine (see FIG. 1).

Upon execution of this motion analysis routine, a step S201 is first implemented to measure a motion which a human body exhibits, and external forces which act on the human body, both in response to a particular movement imparted to the human body.

The desired human-motion is measured using, for example, a motion capture system (i.e., a device for photographing three-dimensionally markers which have been attached to a human-body surface at its several positions). The desired external-forces are measured using, for example, force sensors or detectors.

The measuring of the desired human-motion provides information indicating a time series of positions of human finger tips, and a time series of positions of human toes. The measuring of the desired external-forces provides information indicating a time series of magnitudes of the external forces acting on the human finger tips and toes, and a time series of directions of the these external forces.

Next, at a step S202, the measured human-motion is simulated using the skeleton model, by the aforementioned inverse kinematics analysis. As a result, a joint angle of each joint is derived, based on the information indicative of the measured human-motion.

Subsequently, at a step S203, a joint torque acting on each joint is calculated based on the derived joint angle of each joint, by the aforementioned inverse dynamics analysis, The calculation allows the joint torque to be defined or estimated.

More specifically, the joint torque acting on each joint is calculated, by considering a force balance between forces acting on each joint, and based on information indicative of the weights of the finger tips and the toes, the external forces acting thereon, the inertia of each rigid-body segment, centrifugal/Coriolis forces acting on each rigid-body segment, etc., as described above. The calculated joint torque is stored in the data memory 42.

Then, one cycle of execution of this motion analysis routine is terminated.

Upon termination of one cycle of execution of this motion analysis routine, musculoskeletal-model construction is performed at a step S3 illustrated in FIG. 11.

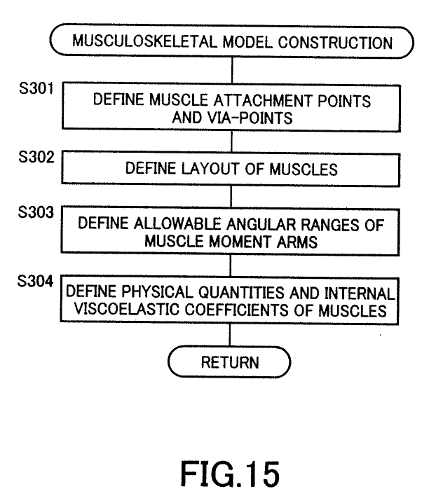

FIG. 15 conceptually illustrates in flow chart the details of the step S3 as the musculoskeletal model construction routine (see FIG. 1).

Upon execution of this musculoskeletal model construction routine, a step S301 is first implemented, per each muscle model which is to be attached to each rigid-body segment of the skeleton model previously constructed, to define the positions of attachments points at which each muscle model is to be attached to the surface of each rigid-body segment, and to define the positions of via-points which are located between aligned attachment points and via which each muscle model passes when extending along each rigid-body segment.

The positions of attachment points and via-points are defined in the local coordinate system assigned to each rigid-body segment, by the user

Next, a step S302 is implemented, per each muscle model which has been defined with respect to the positions of its attachment-points and via-points positions, to define the sequence in which each muscle model travels along a muscle path which is formed by each muscle model extending along corresponding rigid-body segments, that is to say the sequence in which each muscle model passes through its two muscle attachment (origin/insertion) points and at least one muscle via-points. The sequence of each muscle model passing is defined by the user. As a result, each muscle model is disposed at the skeleton model.

A muscle moment arm, which, in the present embodiment, is defined per muscle, can be geometrically calculated from the positions of a plurality of muscle attachment points and via-points both corresponding to each muscle. Therefore, the muscle moment arm is defined as a result of the user defining those muscle attachment points and via-points.

Subsequently, at a step S303, an allowable angular range of the direction of a muscle moment arm per muscle is defined per muscle. As described above, a muscle force direction per muscle, which depends on the direction in which an associated joint is flexed due to each muscle, is allowable to change in a given angular range. For this reason, an individual pivot-axis of each muscle has its allowable angular range, eventually with another allowable angular range of the direction of a corresponding muscle moment arm.

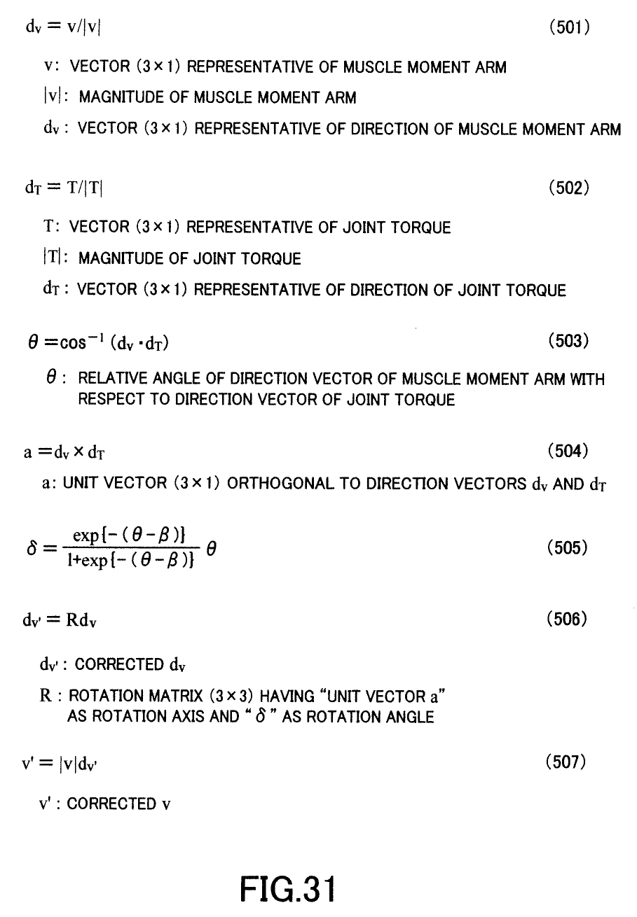

The allowable angular range is specified by the user, and, in a case where the term “allowable angular range” is defined to mean a constant β to be included in a sigmoid function (see equation (505) shown in FIG. 31) described below, it follows that the constant β is entered by the user for eventually specifying the allowable angular range, per muscle.

Thereafter, at a step S304, physical quantities of the already-disposed each muscle model are defined. The physical quantities include the physiological cross section area of each muscle, the pennation angle formed between muscle fibers and a tendon within each muscle, etc. These physiological cross section area and pennation angle, which will be described below, are employed for calculation of a maximum muscle force per muscle. The physical quantities are defined or specified by the user per muscle.

The maximum muscle force can be calculated using the following equation including a constant k (ranging from about 5 to about 10):
MAXIMUM MUSCLE FORCE=k×PHYSIOLOGICAL CROSS SECTION AREA [cm²]×cos (PENNATION ANGLE [rad]).

This step S304 is further implemented to define the internal viscoelasticity of each muscle using a muscle calculation model in the form of, for example, a Hill-type muscle model. The Hill-type muscle model would allow a muscle of each muscle to be calculated using equation (101) in FIG. 6. This equation indicates that a muscle force per muscle is estimated as the product of the muscle activation level αᵢ, the maximum muscle force f^{max}ᵢ, the function g of the muscle length lᵢ, and the function h of the muscle-length changing velocity d(lᵢ)/dt.

Then, one cycle of execution of this musculoskeletal model construction routine is terminated=

Upon termination of one cycle of execution of this musculoskeletal model construction routine, a step S4 depicted in FIG. 11 is implemented to graphically display the direction of the reference pivot-axes and the individual pivot-axes, on the screen 36 of the display device 38.

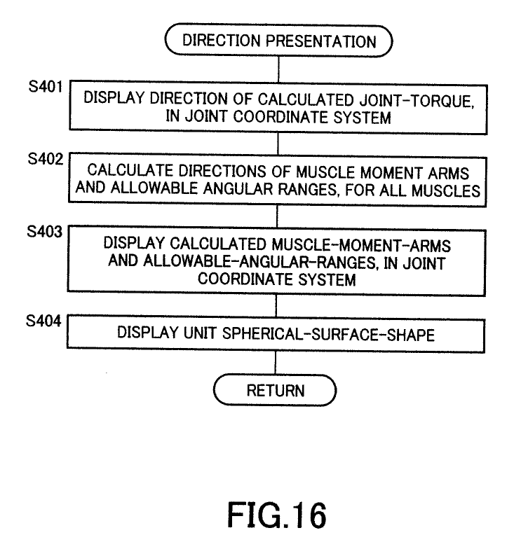

FIG. 16 conceptually illustrates in flow chart the details of the step S4 as the direction presentation routine (see FIG. 1).

Upon execution of this direction presentation routine, a step S401 is first implemented to retrieve from the data memory 42 the joint torques calculated as a result of the execution of the motion analysis routine illustrated in FIG. 14, and to display the directions of the retrieved joint torques, in the corresponding joint coordinate systems.

More specifically, this step S401 is implemented to display the directions of joint torques (i.e., an example of the aforementioned “second pivot-axis-direction”) on the screen 36 in positional association with the corresponding joints, using arrows representative of these directions of joint torques. Each of the arrows is an example of the aforementioned second pictorial-shape.

Each arrow is two-dimensionally displayed on the screen 36, in the form of one projected-image obtained by projecting the original arrow onto the screen 36 in a given projection direction (e.g., in a front view, a side view, or a plan view).

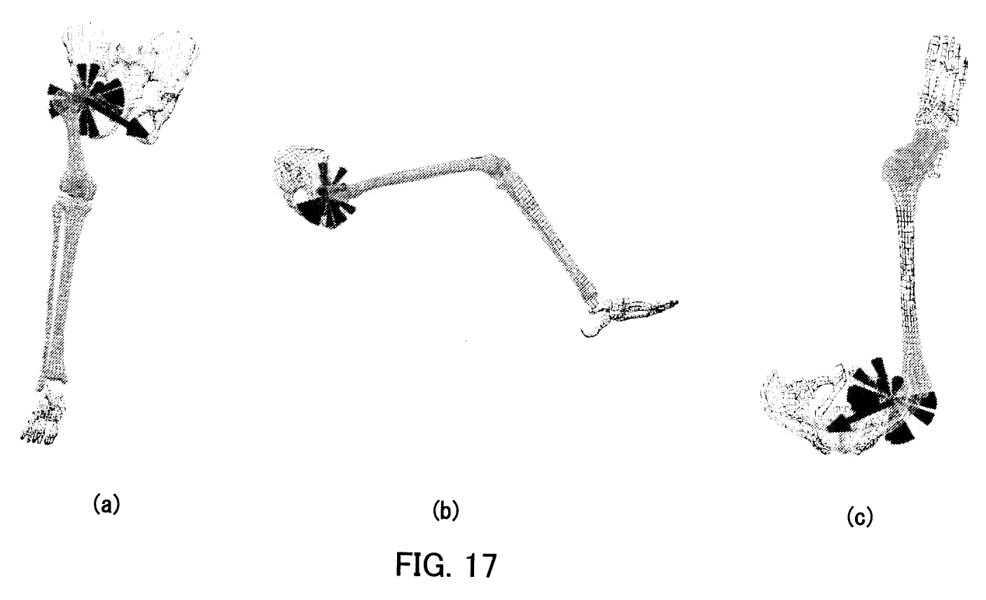

FIGS. 17(a), 17(b) and 17(c) illustrate selected portions of a skeleton model (replaceable with a musculoskeletal model) which correspond to a lumbar region and a right-handed leg region of a human body, respectively, for a better understanding of how to display the selected portions on the screen 36 in a front view, a side view, and a plan view, respectively.

Additionally, FIG. 17(a) further illustrates by the arrow oriented rightward and downward, the direction of a joint torque which, when a human is imparted a particular motion about a hip joint located between the lumbar region and the right-handed leg region, acts on the hip joint, Likewise, FIG. 17(c) further illustrates by the arrow oriented leftward and downward, the direction of the same joint torque. Each of those arrows extends away from the origin of the joint coordinate system.

Next, a step S402 is implemented to calculate the directions of muscle moment arms and their allowable angular ranges, for (a) target ones of all or less muscles contributable to a motion of each of all joints of a human body, which target muscles contributable to a motion of a sequentially selected one of all joints (hereinafter, referred to as “selected joint”), or for (b) target ones of all or less muscles contributable to a motion of each of designated ones (hereinafter, referred to as “designated joints”) of all joints of the human body, which target muscles contributable to a motion of a sequentially selected one of all joints (hereinafter, referred to as “selected joint”).

More specifically, to achieve the ultimate goal of calculating the direction of each muscle moment arm, (a) the direction of a provisional or original version of the individual pivot-axis, and (b) a distance between the pivot-axis and the muscle travel (represented by a straight line interconnecting two via-points A and B, are calculated from x-y-z coordinates (e.g., in the joint coordinate system) of two via-points A and B corresponding to the selected o and x-y-z coordinates (e.g., in the joint coordinate system) of the joint-pivot-center (the origin of the corresponding joint coordinate system), in a manner described above with reference to FIG. 9.

Further, degree-of-freedoms of the selected joint with respect to rotational movements about x-, y- and z-axes, respectively, are defined by the user. These degree-of-freedoms may be alternatively specified using measurement data obtained from a motion capture system or the like.

To achieve the ultimate goal of calculating the direction of each muscle moment arm, there is performed additional calculation of a muscle moment arm vector v (vₓ, v_{y}, v_{z}), from the thus-calculated individual pivot-axis-direction and distance, and the defined degree of-freedoms with respect to rotational movements, in a manner described above. The thus-calculated muscle moment arm vector v (vₓ, v_{y}, v_{z}) is incorporated in a muscle moment arm matrix Jᵤ^{T}.

The direction of the muscle moment arm vector v means the direction of a to-be-calculated muscle moment arm. The direction of muscle moment arm basically reflects a relative positional-relationship between the joint-pivot-center and the muscle travel (represented by a straight line interconnecting two via-points A and B), resulting in the occurrence of coincidence with the pivot-axis-direction (the original version of pivot-axis-direction) depicted in FIG. 9.

However, when the rotation of the selected joint has been constrained with respect to at least one coordinate axis under a particular constraint condition, the pivot-axis-direction depicted in FIG. 9 is corrected so as to reflect the constraint condition. The corrected pivot-axis-direction is expressed as the direction of the ultimate version of a muscle moment arm vector v.

Data indicative of the direction of the thus-calculated muscle-moment-arm is stored in the data memory 42.

Thereafter, at a step S403 of FIG. 16, the direction of the thus-calculated muscle-moment-arm and its allowable angular range are visualized or displayed, with respect to the same joint coordinate system as that used to display the joint torque, in parallel to the displaying of the joint torque.

More specifically, at this step S403, the directions of a plurality of muscle moment arms calculated for a plurality of muscle models representative of a plurality of muscles contributable to a motion of the selected joint are displayed on the screen 36 in positional association with the selected joint, using pictorial shapes indicative of these directions each in the form of a conical surface shape. The directions of muscle moment arms are each an example of the aforementioned “first pivot-axis-direction,” and the conical surface shape is an example of the aforementioned “second pictorial-shape.”

In other words, at this step S403, the directions of a plurality of muscle moment arms associated with a plurality of muscles are displayed with respect to the same selected-joint, using a plurality of conical surface shapes, respectively. These conical surface shapes are displayed two-dimensionally on the screen 36, in the form of a plurality of projected images obtained by projecting the original versions of conical surface shapes onto the screen 36 in a given direction (e.g., in a front view, a side view, or a plan view).

More specifically, these conical surface shapes are defined in a three-dimensional space, as respective exemplary pictorial-shapes extending along respective straight-lines which extend away from one joint-center-point (i.e., joint-pivot-center) indicative of the center point of the selected joint, in the directions of respective muscle moment arms, up to equidistant positions.

Still more specifically, each conical surface shape is defined in the three-dimensional space, by both its centerline extending away from the joint-pivot-center of the selected joint, in the direction of a corresponding muscle moment arm, and its base varying in size with the defined allowable-angular-range

In the present embodiment, under the presupposition that directions of muscle moment arms tend to deviate from the original pivot-axis-direction with isotropic ease, the base of each conical surface shape is geometrically defined by a complete round,

Alternatively, when there is the need to express that directions of muscle moment arms tend to deviate from the original pivot-axis-direction with non-isotropic ease, the base of each conical surface shape may be geometrically defined by a non-complete round such as an ellipse which reflects the non-isotropic deviation.

FIGS. 17(a), 17(b) and 17(c) illustrate by the conical surface shapes each divergently extending away from a common joint-pivot-center, the directions of a plurality of muscle moment arms and their allowable angular ranges. The muscle moment arms are for a plurality of muscles which contribute to a motion of the hip joint located between the lumbar region and the right-handed leg region, in response to impartation of a particular motion about the hip joint to the human body. Every conical surface shape extends away from the origin of the joint coordinate system

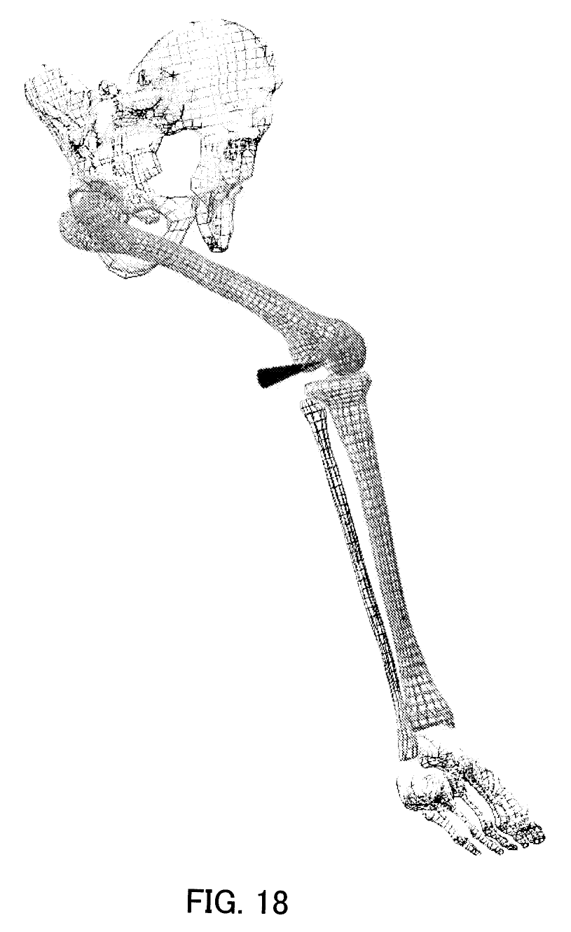

FIG. 18 illustrates an exemplary displayed-image of a complex of selected portions of the skeleton model which correspond to the lumbar region and the right-handed leg region of a human body, respectively, with respect to how to display the selected portions on the screen 36 in enlargement and perspective view, for better illustration.

FIG. 18 further illustrates both the direction of a muscle moment arm associated with a representative muscle and its allowable angular range, with respect to how to display both of the direction of muscle moment arm associated and the allowable angular range, in the form of one common conical surface shape divergently extending away from the joint-pivot-center. The representative muscle is one of a plurality of muscles which contributes to a motion of a knee joint in the right-handed leg region of a human body, in response to impartation of a particular motion about the knee joint, to the human body.

Thereafter, at a step S404 of FIG. 16, one unit spherical-surface-shape is displayed on the screen 36 in superposition with the plurality of conical surface shapes which are being displayed two-dimensionally on the screen 36, for assisting the user in visually perceive the differences in direction between those conical surface shapes, with an enhanced accuracy.

The unit spherical-surface-shape acts as an exemplary depth cue for promoting the user to accurately perceive the depths of those conical surface shapes.

More specifically, this unit spherical-surface-shape is a unitary spherical-surface-shape defined in a three-dimensional space so as to have its center point located at a joint-pivot-center and so as to have its radius with a length equal to the heights of the plurality of conical surface shapes. As a result, these conical surface shapes are altogether within the unit spherical-surface-shape, such that the outer circumferences of the bases of these conical surface shapes are inscribed in the sphere of the unit spherical-surface-shape.

Still more specifically, this unit spherical-surface-shape is two-dimensionally displayed on the screen 36, in the form of an exemplary version of a unitary projected-image obtained by projecting the original version of the unit spherical-surface-shape onto the screen 36 in a given direction (e.g., in a front view, a side view, or a plan view).

Yet sill more specifically, this spherical surface shape is defined in a three-dimensional spa in the form of a mesh (i.e., an array of a plurality of divisions of a spherical surface). The mesh is displayed two-dimensionally on the screen 36, as a projected image obtained by projecting the original version of the mesh onto the screen 36 in the aforementioned given direction.

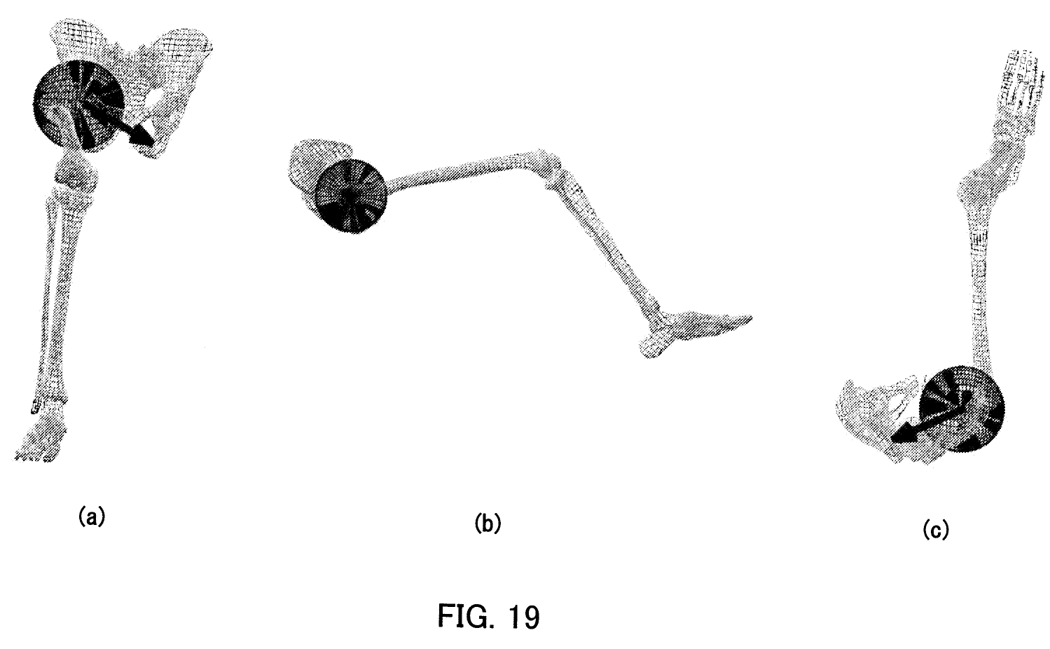

FIGS. 19(a), 19(b) and 19(c), in respective manners similar with FIGS. 17(a), 17(b) and 17(c), each illustrate the direction of a common joint torque (depicted in FIGS. 19(a), 19(b) and 19(c) as the respective arrows each partially protruded from the surface of the unit spherical-surface-shape), which acts on the hip joint located between the lumbar region and the right-handed leg region, in response to impartation of a particular motion about the hip joint to the human body, with respect to how to display the direction of common joint torque on the screen 36 in a front view, a side view, and a plan view, respectively.

FIGS. 19(a), 19(b) and 19(c), in respective manners similar with FIGS. 17(a), 17(b) and 17(c), further illustrate a plurality of conical surface shapes indicative of the directions of muscle moment arms contribute to a motion of the hip join and their allowable angular ranges, with respect to how to display the plurality of conical surface shapes on the screen 36 in a front view, a side view, and a plan view, respectively.

FIGS. 19(a), 19(b) and 19(c), in respective manners similar with FIGS. 17(a), 17(b) and 17(c), still further illustrate one unit spherical-surface-shape in common to the plurality of conical surface shapes, with respect to how to display unit spherical-surface-shape on the screen 36 in a front view, a side view, and a plan view, respectively.

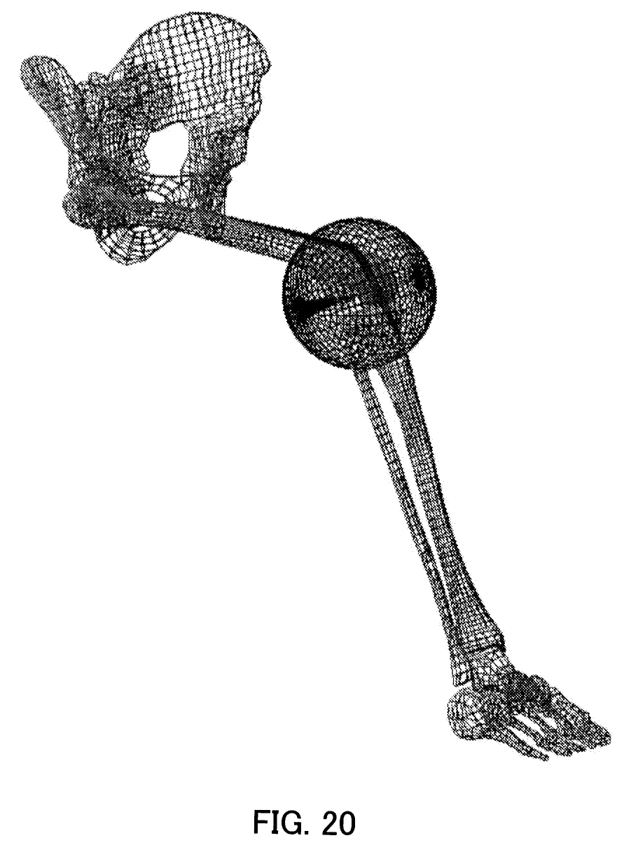

FIG. 20 illustrates an exemplary displayed-image of a complex of selected portions of the skeleton model which correspond to the lumbar region and the right-handed leg region of a human body, respectively, with respect to how to display the selected portions on the screen 36 in enlargement and perspective view, for better illustration.

FIG. 20 further illustrates both one conical surface shape indicative of both the direction of a muscle moment arm associated with a representative muscle and its allowable angular range, and a unit spherical-surface-shape concentric with the conical surface shape. The representative muscle is one of a plurality of muscles which contributes to a motion of a knee joint in a human body, in response to impartation of a particular motion about the knee joint, to the human body.

FIG. 20 still further illustrates the representative muscle in the form of a curbed and elongated pictorial-shape.

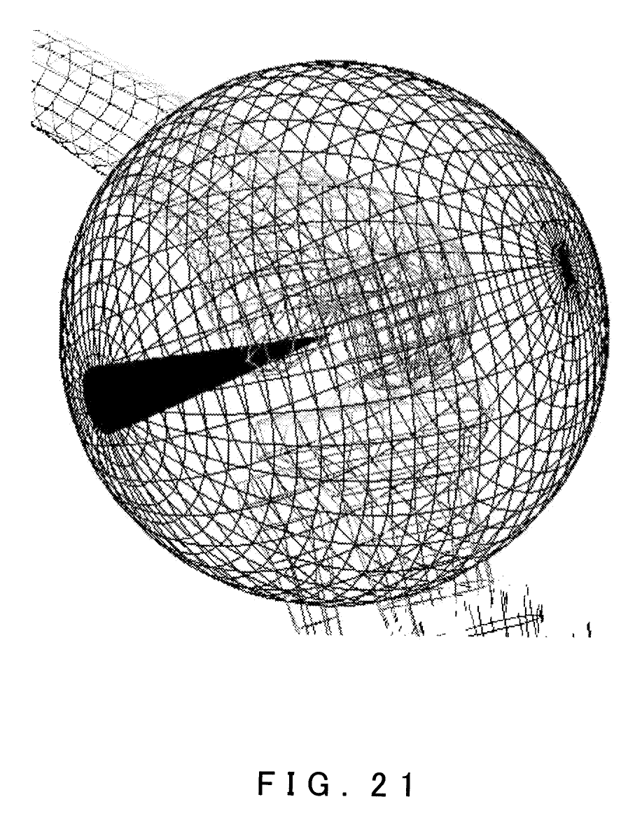

FIG. 21 illustrates in enlargement the knee joint, the conical surface shape and the unit spherical-surface-shape depicted in FIG. 20, for better illustration.

Upon termination of one cycle of execution of the direction presentation routine illustrated in FIG. 16, a step S5 of FIG. 11 is implemented to apply desired corrections to the previously-constructed musculoskeletal model.

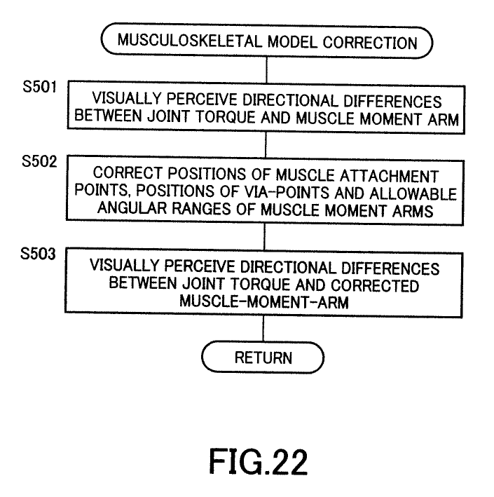

FIG. 22 conceptually illustrates in flow chart the details of this step S5 as the musculoskeletal model correction routine (see FIG. 1).

Upon execution of this musculoskeletal model correction routine, a step S501 is first implemented to prompt the user to visually perceive the differences in direction between the joint torque and the muscle moment arms, on a per-selected-joint basis. To this end, a particular pictorial representation or a particular message may be displayed on the screen 36. The differences in direction between the joint torque and the muscle moment arms correspond to relative angles of the direction of the joint torque with respect to the directions of the muscle moment arms.

Next, a step S502 is implemented to correct one or more desired geometrical quantities including the positions of the muscle attachment points, the positions of the muscle via-points, and the allowable angular ranges of the muscle moment arms, according to the directions from the user, on a per-selected-joint basis. As a result, the musculoskeletal model is corrected. The corrected musculoskeletal-model is stored in the data memory 42.

Subsequently, a step S503 is implemented to prompt the user to visually perceive the differences in direction between the joint torque and the thus-corrected at least one muscle moment arm, on a per-selected-joint basis. To this end, a particular pictorial representation or a particular message may be displayed on the screen 36.

Upon termination of one cycle of execution of this musculoskeletal model correction routine, a step S6 of FIG. 11 is implemented to estimate muscle activation levels using the musculoskeletal model which has been completed.

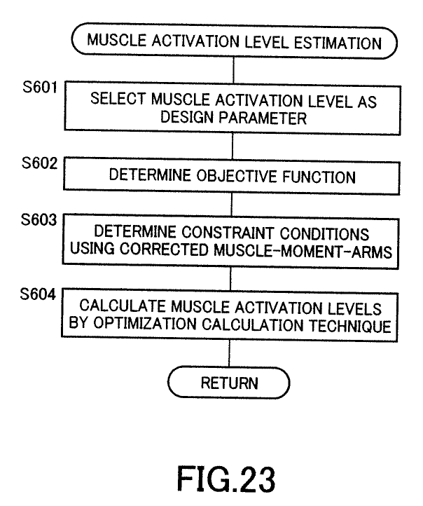

FIG. 23 conceptually illustrates in flow chart the details of this step S6 as the muscle activation level estimation routine (see FIG. 1).

Describing first the scheme of this muscle activation level estimation routine, a joint torque, which is actively outputted from a human, is a quantity resulting from muscle motion, and therefore, from a calculation of the joint torque, a muscle force commensurate with the joint torque is calculated.

However, combinations of feasible muscle-forces which together achieve a given joint torque are infinite in number, typically. This is because there exist more muscles than degree-of-freedoms of a joint.

Then, this muscle activation level estimation routine is executed, for uniquely seeking optimal muscle forces, to make a search for optimal solutions by optimization technique with a particular objective function being specified.

Upon execution of this muscle activation level estimation routine, a step S601 is first implemented to select a muscle activation level as a design parameter or variable. In an alternative example where, instead of the muscle activation level, a muscle force can be selected as the design parameter, difficulties are encountered in formulating the constraint conditions in an analysis described below

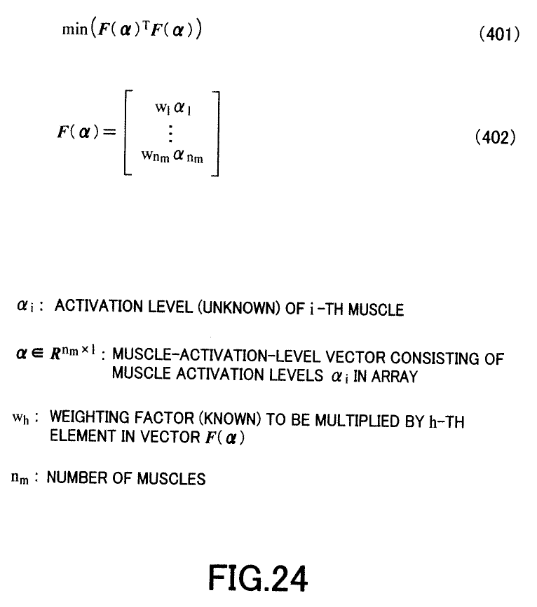

Next, a step S602 is implemented to formulate an object function expressed by equation (401) in FIG. 24. A variable vector F(α) in the objective function is expressed by equation (401) in the same figures

The variable vector includes an element provided as the product a weighting factor wᵢ and a muscle activation level αᵢ, per muscle. The object function has been formulated to finally calculate by optimization an optimal value of the muscle activation level αᵢ, which can minimize the total sum of the products of weighting factor wᵢ and muscle activation level αᵢ, ranging over all muscles to be considered

In the present embodiment, the objective function has been formulated to finally calculate by optimization an optimal value of the muscle activation level αᵢ, which can minimize the sum of squares of weighting factor wᵢ and muscle activation level αᵢ, ranging over all muscles to be considered, to thereby adjust its characteristics into those of a human body.

Subsequently, a step S603 of FIG. 23 is implemented to set the constraint conditions to be considered in the optimization procedure. The constraint conditions include both the equation of relation between generalized forces τ (including joint torques) acting on joints, and muscle forces f, both in a human body; and a range (0-1) of the muscle activation level αᵢ. Provided that the optimization calculation described below is performed so as to satisfy the constraint conditions, it is ensured to estimate an optical value of the muscle activation level αᵢ so that force equilibrium may be substantially reached between the generalized forces τ and the muscle forces f.

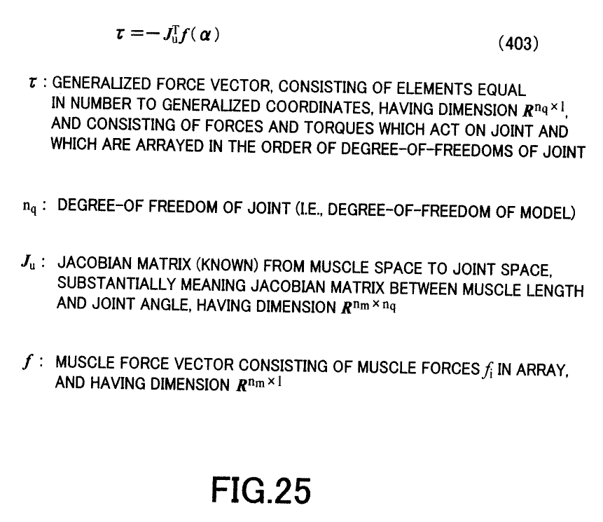

FIG. 25 illustrated the equation of relation between the generalized forces τ and the muscle forces f as equation (403). This equation (403) indicates that each of the generalized forces τ is derived as the product of the muscle moment arm matrix Jᵤ^{T}, which is the transpose of the Jacobian matrix Jᵤ, and the muscle forces f. The Jacobian matrix Jᵤdepends on the posture of the musculoskeletal model, which is equivalent to the joint angle. Each of the muscle forces f is a function of the muscle activation level αᵢ.

At this step S603, the constraint conditions are defined using the muscle moment arm matrix Jᵤ^{T} which has been corrected as a result of the execution of the musculoskeletal model correction routine. As illustrated in FIG. 1, the muscle moment arm matrix Jᵤ^{T} and the muscle moment arm vector v are stored in the data memory 42. The muscle moment arm vector v is stored in the data memory 42 in association with each muscle.

Subsequently, at a step S604, the optimization calculation is performed using the formulated objective function, under the constraint conditions, to thereby calculate the muscle activation level αᵢ per muscle. Parameters referenced for the calculation include: the weighting factors w, the maximum muscle forces fₘₐₓ, the muscle lengths and its changing velocities, the function g of muscle length, the function h of muscle-length changing velocity, the joint angles on which the Jacobian matrix ^{c}Jₕ depends, and the generalized forces τ.

The optimization calculation is referred to generally in the art as “constrained optimization,” more specific versions of which include “sequential quadratic programming,” “modifiable direction technique,” etc.

Then, one cycle of execution of this muscle activation level estimation routine is terminated.

The thus-estimated muscle-activation-level α has various practical applications. For example, when the muscle-activation-level α is used, together with the aforementioned human muscle characteristics, and according to the relation expressed by equation (102) in FIG. 6, stiffness Kᵤ can be calculated per muscle. The stiffness Kᵤ is defined in the muscle space, as illustrated in FIG. 5.

Termination of one cycle of execution of this muscle activation level estimation routine results in termination of one cycle of execution of the human-motion analysis program depicted in FIG. 11.

As will be readily understood from the above, in the present embodiment, the steps S301 and S302 depicted in FIG. 15 and the step S402 depicted in FIG. 16 together constitute an example of the “first defining step” set forth in the above mode (1), and the steps S201-S203 depicted in FIG. 14 together constitute an example of the “second defining step” set forth in the same mode, all for the illustrative purposes.

Further, in the present embodiment, the step S403 depicted in FIG. 16 constitutes an example of the “first presentation step” set forth in the above mode (10), the step S401 depicted in FIG. 16 constitutes an example of the “second presentation step” set forth in the same mode, and the steps S501-S503 depicted in FIG. 22 together constitute an example of the “redefining step” set forth in the above mode (1) or (10), all for the illustrative purposes.

Still further, in the present embodiment, the steps S301-S304 depicted in FIG. 15 together constitute an example of the “provisional construction step” set forth in the above mode (9), the step S402 depicted in FIG. 16 constitutes an example of the “first calculation step” set forth in the same mode, and the steps S201-S203 depicted in FIG. 14 together constitute an example of the “second calculation step” set forth in the same mode, all for the illustrative purposes.

Additionally, in the present embodiment, the steps S501-S503 depicted in FIG. 22 together constitute an example of the “musculoskeletal model correction step” set forth in the above mode (9), for the illustrative purposes.

Still additionally, in the present embodiment, the step S404 depicted in FIG. 16 constitutes an example of the “third presentation step” set forth in the above mode (13), the step S402 depicted in FIG. 16 constitutes an example of the “third defining step” set forth in the above mode (15), and the step S403 depicted in FIG. 16 constitutes an example of the “conical-surface-shape presentation step” set forth in the same mode, all for the illustrative purposes.

Yet still additionally, in the present embodiment, the relevant portion of the human-motion analysis program constitutes an example of the “program” according to the above mode (20), and the program memory 40 depicted in FIG. 1 constitutes an example of the “medium” according to the above mode (21).

Next, a second embodiment of the present invention will be described in comparison with the first embodiment for the convenience of description.

The present embodiment is different from the first embodiment only with respect to a direction presentation routine, and is common to the first embodiment with respect to other elements.

The present embodiment, therefore, will be described below only with respect to its unique direction presentation routine, while the common elements to those of the first embodiment will be referenced the same reference numerals or names as those in the description and illustration of the first embodiment, without redundant description or illustration.

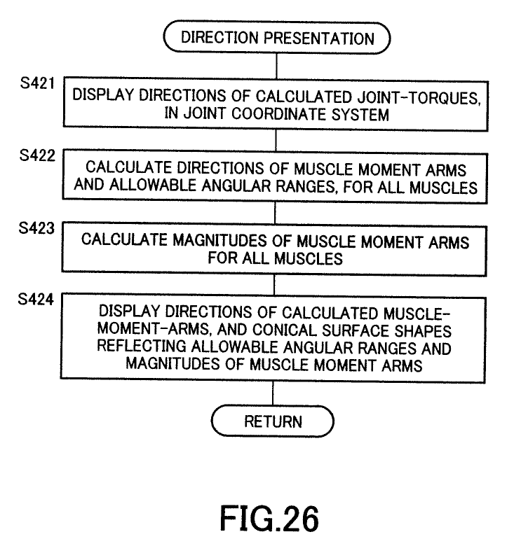

FIG. 26 conceptually illustrates in flow chart a direction presentation routine included in a human-motion analysis program configured according to the present embodiment.

The direction presentation routine of FIG. 26 has common steps to those in the direction presentation routine in the first embodiment described above. Those common steps in this direction presentation routine of FIG. 26 will be briefed by reference to the same numbers as those assigned in the direction presentation routine in the first embodiment.

Upon execution of the direction presentation routine depicted in FIG. 26, a step S421 is first implemented, in the same manner as that in the step S401, to display, in the joint coordinate system, the direction of the joint torque calculated as a result of the execution of the motion analysis routine depicted in FIG. 14

Next, a step S422 is implemented, in the same manner in the step S402, to calculate the directions of muscle moment arms, for all (or part of) target muscles which can contribute to a motion of the selected joint. This step S422 is further implemented to allow the user to define the allowable angular ranges of the calculated directions.

Subsequently, a step 5423 is implemented to calculate the magnitudes of muscle moment arms, for all (or part of) target muscles which can contribute to a motion of the selected joint.

For the calculation of the magnitudes of muscle moment arms, the aforementioned muscle moment arm vector v (vₓ, v_{y}, v_{z}) is used, which reflects both the direction and distance of the original or provisional individual-pivot-axis (represented by the original version of the muscle moment arm vector), and the degree-of-freedoms of the selected joint with respect to its rotational movement. The muscle moment arm vector v (vₓ, v_{y}, v_{z}) has been incorporated in the muscle moment arm matrix Jᵤ^{T}.

Thereafter, a step S424 is implemented to display the directions of the calculated muscle moment arms, their allowable angular ranges, and the magnitudes of the calculated muscle moment arms, in parallel to the displaying of the direction of the joint torque, with respect to the same joint coordinate system as that used to display the direction of the joint torque.

More specifically, at this step S424, the directions and magnitudes of a plurality of muscle moment arms which have been calculated in association with a plurality of muscle models which represent a plurality of muscles contributing to a motion of the selected joint are displayed on the screen 36, in positional association with the selected joint, using respective conical-surface-shapes each of which is an exemplary pictorial-shape indicative of a corresponding one of those directions.

On a muscle-by-muscle basis, the corresponding conical surface shape is defined in a three-dimensional space, as an exemplary pictorial-shape extending along a straight-line which extends away from one joint-center-point (i.e, joint-pivot-center) indicative of the center point of the selected joint, in the direction of a corresponding muscle moment arm, to an extent reflecting the magnitude of the corresponding muscle moment arm.

More specifically, each conical surface shape is defined in the three-dimensional space, by both its centerline extending away from the joint-pivot-center of the selected joint, in the direction of the corresponding muscle moment arm, and its base varying in size with the defined allowable-angular-range.

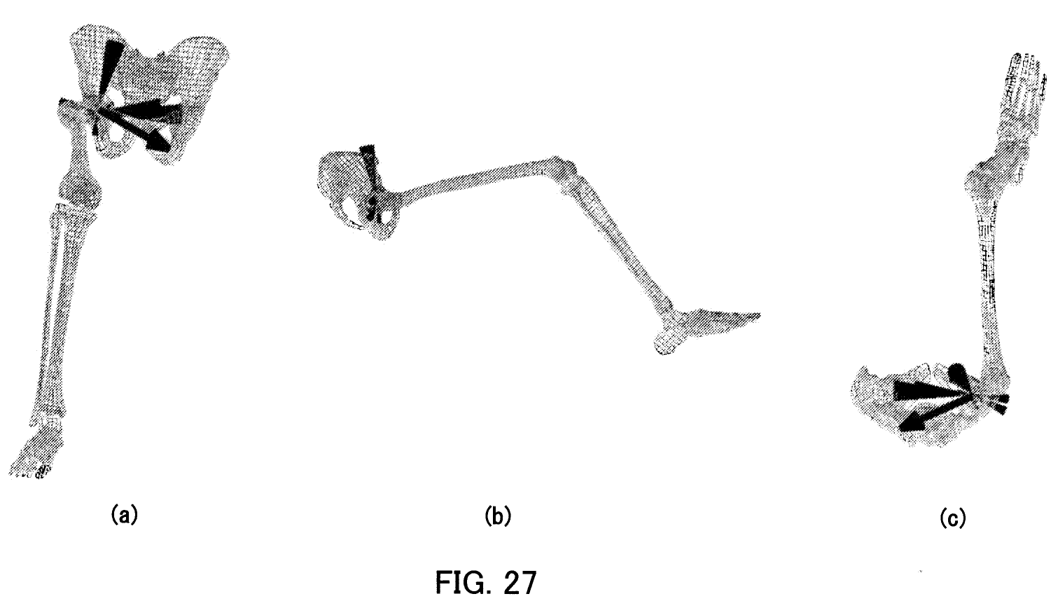

FIGS. 27(a), 27(b) and 27(c) illustrate by the conical surface shapes each divergently extending away from a common joint-pivot-center, the directions of a plurality of muscle moment arms and their allowable angular ranges. The muscle moment arms are for a plurality of muscles which contribute to a motion of a hip joint located between a lumbar region and a right-handed leg region both in a human body, in response to impartation of a particular motion about the hip joint to the hen body.

In FIGS. 27(a), 27(b) and 27(c), every conical surface shape divergently extends away from the origin of the joint coordinate system. FIGS. 27 (a), 27 (b) and 27 (c) also each illustrate by the arrow indicated therein the joint torque acting on the hip joint.

Then, one cycle of execution of the direction presentation routine depicted in FIG. 26 is terminated.

As will be evident from the above, in the present embodiment, the steps S423 and S424 depicted in FIG. 26 together constitute an example of the “first presentation step” set forth in the above mode (7), for illustrative purposes.

Next, a third embodiment of the present invention will be described in comparison with the first embodiment for the convenience of description.

The present embodiment is different from the first embodiment only with respect to a musculoskeletal model correction routine, and is common to the first embodiment with respect to other elements.

The present embodiment, therefore, will be described below only with respect to its unique musculoskeletal-model-correction-routine, while the common elements will be referenced the same reference numerals or names, without redundant description or illustration.

In the first embodiment, a musculoskeletal model is corrected or refined manually according to a user-entered instruction in an attempt to allow the joint torque and the muscle moment arm to become closer in direction to each other to a maximum extent.

In contrast, in the present embodiment, such correction is performed automatically as a result of the execution of a musculoskeletal model correction routine by the computer 20.

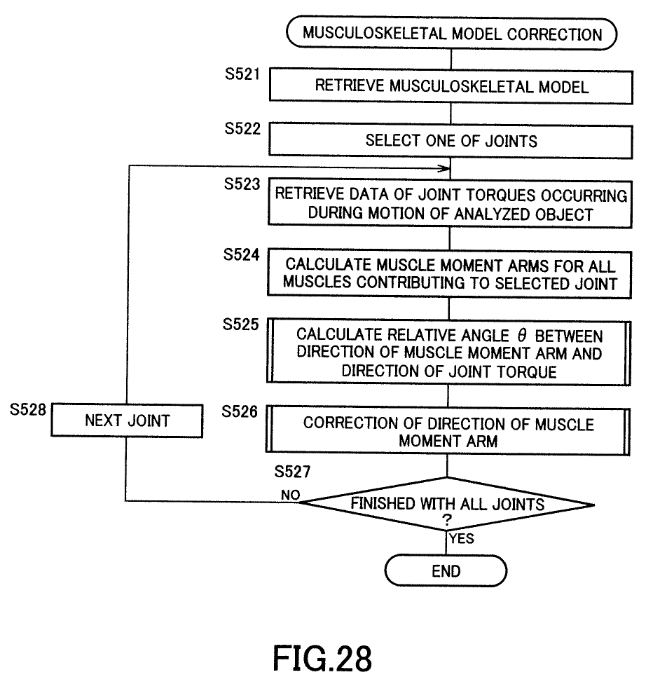

FIG. 28 conceptually illustrates in flow chart a musculoskeletal model correction routine in a human-motion analysis program according to the present embodiment.

Upon execution of this musculoskeletal model correction routine, a step S521 is first implemented to retrieve from the data memory 42 data indicative of a musculoskeletal model which has been constructed or created as a result of the execution of the musculoskeletal model correction routine depicted in FIG. 15.

Next, a step S522 is implemented to select one of all human joint as a joint which is to be currently processed.

Thereafter, a step S523 is implemented to retrieve from the data memory 42 a joint torque vector T indicative of a joint torque acting on a currently-selected joint in response to impartation of a to-be-analyzed motion or behavior to a human body. The joint torque vector T has been previously stored in the data memory 42 as a result of the preceding execution of the motion analysis routine depicted in FIG. 14.

Subsequently, a step S524 is implemented, in a similar manner with the step S402 depicted in FIG. 16, to calculate a muscle moment arm vector v for all muscles contributing to a motion of the currently-selected joint.

Thereafter, a step S525 is implemented to calculate a relative angle θ between the direction of a muscle moment arm and the direction of the joint torque, per muscle.

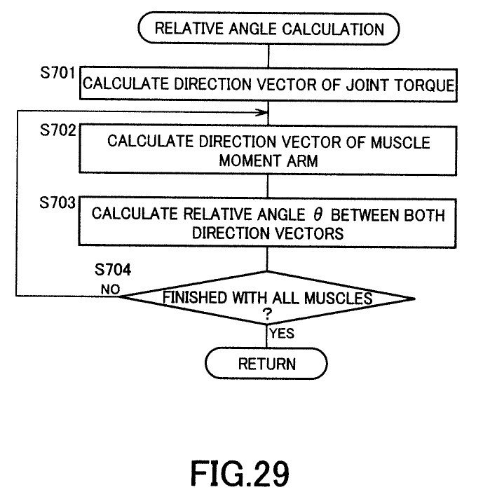

FIG. 29 conceptually illustrates in flow chart the details of this step S525 as a relative angle calculation routine.

Upon execution of this relative angle calculation routine, a step S701 is first implemented to calculate a direction vector dT indicative of the direction of the joint torque, from the retrieved joint torque vector T.

More specifically, the direction vector dT is calculated, as expressed by equation (502) in FIG. 31, by dividing the joint torque vector T by its magnitude |T|, that is to say by normalizing the joint torque vector T.

Subsequently, at a step S702 of FIG. 29, one of all muscles contributing to a motion of the currently-selected joint is selected, and the muscle moment arm vector v is retrieved from the data memory 42, which has been previously stored in the data memory 42 in association with the selected muscle.

This step S702 is further implemented to calculate a direction vector dv indicative of the direction of the muscle moment arm, from the retrieved muscle moment arm vector v.

More specifically, the direction vector dv is calculated, as expressed by equation (501) in FIG. 31, by dividing the muscle moment arm vector v by its magnitude |v|, that is to say by normalizing the muscle moment arm vector v.

Thereafter, a step S703 of FIG. 29 is implemented to calculate the relative angle θ between the calculated two direction vectors dT and dv. This relative angle θ is calculated, as expressed by equation (503) in FIG. 31, using the inner product of those direction vectors dT and dv. The calculated relative angle θ is stored in the data memory 42 in association with each muscle.

Subsequently, a step S704 of FIG. 29 is implemented to make a determination as to whether or not the calculating of the relative angles θ have been finished with all muscles contributing to a motion of the currently-selected joint.

If not, then the determination of the step S704 becomes “NO,” with the subsequent implementation of the steps S702 and S703 for a next-selected joint.

If, however, the calculating of the relative angles θ has been finished with for all muscles contributing to a motion of the currently-selected joint, then the determination of the step S704 becomes “YES,” resulting in the termination of one cycle of execution of the relative angle calculation routine.

Thereafter, at a step S526 of FIG. 28, the directions of the muscle moment arms are corrected per muscle, if necessary.

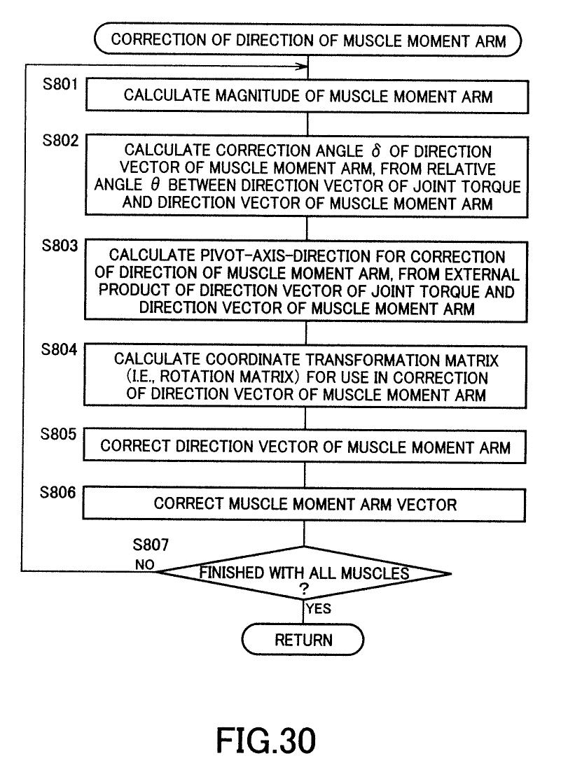

FIG. 30 conceptually illustrates in flow chart the details of this step S526 as a muscle-moment-arm-direction correction routine.

Upon execution of this muscle-moment-arm-direction correction routine, a step S801 is first implemented to select one of all muscles contributing to a motion of a currently-selected joint, as a muscle to be currently processed

This step S801 is further implement to retrieve the muscle moment arm vector v from the data memory 42, which has been previously stored in the data memory 42 in association with the currently-selected muscle.

This step S801 is still further implemented to calculate a direction vector dv indicative of the direction of the muscle moment arm, from the retrieved muscle moment arm vector v.

Next, a step S802 is implemented to calculate a correction angle δ of a direction vector of the muscle moment arm for the currently-selected muscle, from the relative angle θ between the direction vector dT of the joint torque, and the direction vector dv of the current muscle-moment-arm.

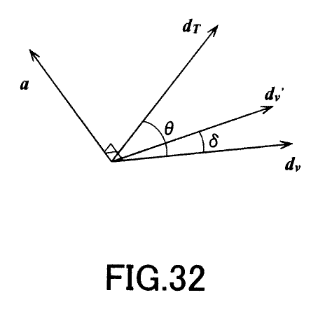

FIG. 32 illustrates a relative geometry between the uncorrected direction-vector dv, the corrected direction-vector dv′, the relative angle θ, and the correction angle δ.

The correction angle δ is basically calculated such that the muscle moment arm per muscle and the joint torque become coincident in direction with each other.

In the present embodiment, however, the correction angle δ is calculated such that the relative angle θ is not altered when the original value of relative angle θ exceeds an allowable limit, while the relative angle θ is altered when the original value of relative angle θ does not exceed the allowable limit, such that the relative angle θ becomes closer to zero

More specifically, in the present embodiment, the correction angle δ is calculated such that, even in a case where the original value of relative angle θ does not exceed the allowable limit, the relative angle θ becomes closer to zero when the original value of relative angle θ does not exceed a reference value not exceeding the allowable limit than when the original value of relative angle θ exceeds the reference value.

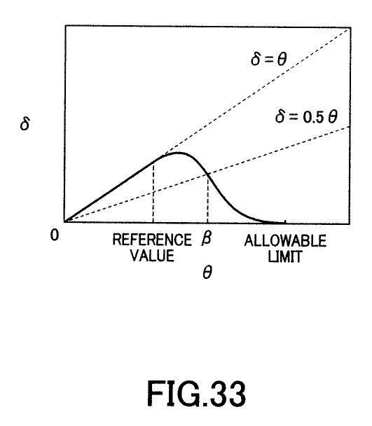

FIG. 33 illustrates in a graph an exemplary version of the above alteration characteristic (i.e., θ-to-δ relation). The graph is defined by a sigmoid function expressed by equation (505) in FIG. 31. This type of sigmoid function would determine a value of the allowable limit and a value of the reference value, depending on a value of the constant β.

As illustrated in FIG. 33, the correction angle δ changes, according to the θ-to-δ relation, such that the correction angle δ decreases as the relative angle θ increases, in a region where the relative angle θ is larger than the reference value, but smaller than the allowable limit. The mutual relation reflects the intrinsic behavior of a real human muscle faithfully.

As illustrated in FIG. 33, by the sigmoid function, the reference value is substantially coincident with an upper limit of a range of the relative angle θ can change, in which the relative angle θ and the correction angle δ change together so as to be completely identical to each other.

In addition, as illustrated in FIG. 33, the reference value is substantially coincident with an upper limit of a range of the relative angle θ can change, in which the relative angle θ and the correction angle δ change together such that the correction angle δ takes a non-zero value.

Now, there will be described the relationship between the allowable limit, reference value and constant β, and the aforementioned allowable angular range of the direction of a muscle moment arm.

With the θ-to-δ relation graphed in FIG. 33 in mind, the allowable angular limit may be defined to mean the constant β. In this instance, the allowable limit and the reference value each are no more than a physical quantity conceptually or internally existing in the θ-to-δ relation.

Alternatively, provide that the allowable angular range of the direction of each muscle moment arm is defined to mean the allowable limit, (a) the constant β may be directly derived from the allowable limit, using a predetermined function, or (b) the reference value may be derived from the allowable limit, using a predetermined function, and the constant β may be derived from those reference value and allowable limit, using a predetermined function.

Still alternatively, provide that the allowable angular range of the direction of each muscle moment arm is defined to mean the reference value, (c) the constant β may be directly derived from the reference value, using a predetermined function, or (d) the reference value may be derived from the reference value, using a predetermined function, and the constant β may be derived from those reference value and allowable limit, using a predetermined function.

The step S802 depicted in FIG. 30, describing more specifically, is implemented to calculate the correction angle δ for the currently-selected muscle, by entering an actual value of the relative angle θ and an actual value of the constant β into equation (505) depicted in FIG. 31.

A step S803 of FIG. 30 is subsequently implemented to calculate as a pivot-axis-direction for correction of direction (hereinafter, referred to as “PCD”), the direction of a pivot axis about which the direction vector dv is to be pivoted relative to the original version of the direction vector dv for causing the direction vector dv of each muscle moment arm to move toward the direction vector dT of the joint torque, for the currently-selected muscle.

The PCD is defined to mean a unit vector “a” orthogonal to both the direction vectors dv and dT. The unit vector “a” is illustrated in FIG. 32, together with the direction vectors dv and dT.

This step S803 is implemented to calculate the unit vector “a” using the outer product of the direction vectors dv and dT, as expressed by equation (504) in FIG. 31.

Thereafter, a step S804 of FIG. 30 is implemented to calculate a coordinate transformation matrix (i.e., rotation matrix) R for correction of the direction vector dv of each muscle moment arm.

The rotation matrix R, as expressed by equation (506) in FIG. 31, is defined as a 3×3 matrix in which its rotation axis is assigned to the unit or orthogonal vector “a,” and its rotation angle is assigned to the correction angle δ.

Subsequently, a step S805 of FIG. 30 is implemented to calculate the corrected direction-vector dv′ using the calculated rotation matrix R, and equation (506) depicted in FIG. 31.

The step S805 is followed by a step S806 of FIG. 30 to calculate the corrected muscle-moment-arm-vector v′ as the product of the calculated corrected-direction vector dv′ and the magnitude |v| of the muscle moment arm, as expressed by equation (507) in FIG. 31.

The step S806 is followed by a step S807 of FIG. 30 to make a determination as to whether or not the calculating of the corrected moment-arm-vectors v′ has been finished with all muscles contributing to a motion of the currently-selected joint.

If not, then the determination of the step S807 becomes “NO,” with the subsequent implementation of the steps S801-S806 for a next-selected muscle.

If the implementation of the steps S801-S806 has been finished with all muscles contributing to a motion of the currently-selected joint, then the determination of the step S807 becomes “YES,” resulting in the termination of one cycle of execution of this muscle moment arm direction correction routine.

Thereafter, a step S527 of FIG. 28 is implemented to make a determination as to whether or not the calculating of the corrected moment-arm-vectors v′ has been finished with all joints in a human body.

If not, then the determination of the step S527 becomes “NO,” with the subsequent implementation of a step S528 to select a next joint, and the further subsequent implementation of the steps S523-S526 for the next-selected joint.

If the implementation of the steps S523-S526 has been finished with all joints, then the determination of the step S527 becomes “YES.” Then, one cycle of execution of this musculoskeletal model correction routine is terminated.

As will be evident from the above, in the present embodiment, the musculoskeletal model correction routine depicted in FIG. 28 constitutes an example of the “redefining step” set forth in the above mode (1), and an example of the “alteration step” set forth in the above mode (2), (3) or (4), all for illustrative purposes.

Further, in the present embodiment/the musculoskeletal model correction routine depicted in FIG. 28 constitutes an example of the “musculoskeletal model correction step” set forth in the above mode (9), for illustrative purposes.

Still further, in the present embodiment, the musculoskeletal model correction routine depicted in FIG. 28 constitutes an example of the “redefining step” set forth in the above mode (10), and an example of the “alteration step” set forth in the above mode (17), (18) or (19), all for illustrative purposes.

Next, a fourth embodiment of the present invention will be described in comparison with the first embodiment for the convenience of description.

The present embodiment is common to the first embodiment with respect to some elements, and therefore, the present embodiment will be described below with the common elements being referenced the same reference numerals or names, without redundant description or illustration.

Some occasions exist where there is the need for designing manually-operated devices, such as user-operated steering systems, user-operated accelerator systems, user-operated brake systems, switches on interior parts, switches of air-conditioners, switches of electrical parts, all for an automobile, for example.

In those occasions, a technique of displaying on the screen 36, while a designer is designing a particular manually-operated device, the direction of muscle moment arms of human muscles used for manipulating the manually-operated device, together with and in superposition with a human skeleton model or a musculoskeletal model, would make it easier for the designer to design the manually-operated device in a time-efficient manner, while accurately evaluating the maneuverability which would be provided by the manually-operated device.

In addition, other occasions exist where a designer is required to design a particular manually-operated device usable by as many people as possible regardless of age, ability or situation (i.e., under a universal design scheme), such as a device which is not always used by ordinary people, and which should be usable without difficulty even by people having disabilities in part of the muscles

Further, still other occasions exit where a designer is required to a particular manually-operated device intended exclusively for use by people having disabilities, with the use condition in mind.

In those occasions described above, it is vital for a designer to finalize the features or configuration of a manually-operated device, that is to say, for example, its relative position to a potential user or an object person, the required direction of manual operation, the required force of manual operation, etc., with the motion characteristics of the user (e.g., information for defining disabled muscles in the user) in mind.

In light of the above circumstances, the present embodiment is directed to a maneuverability evaluation method of assisting a designer in evaluating the maneuverability of a manually-operated device, using the aforementioned technique of displaying on the screen 36, the directions of muscle moment arms together with and in superposition with a human skeleton model or a musculoskeletal model.

For implementing the maneuverability evaluation method, a design assist program is executed by the computer 20 for making it easier to achieve enhanced efficiency with which a designer designs a manually-operated device.

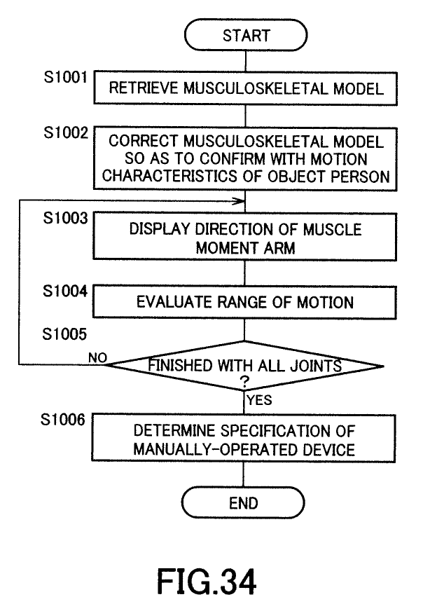

FIG. 34 conceptually illustrates in flow chart the design assist program.

Upon execution of this design assist program, a step S1001 is first implemented to retrieve the musculoskeletal model from the data memory 42.

A step S1002 is next implemented to correct the retrieved musculoskeletal model manually according to a designer-entered instruction, so as to match the motion characteristics of an object person who uses a manually-operated device to be designed.

Subsequently, a step S1003 is implemented, in the similar manner with the steps S402 and S403 of FIG. 16, to select one of all joints in the object person, and to display on the screen 36 the directions of muscle moment arms for all muscles contributing to a motion of the selected joint.

Thereafter, a step S1004 is implemented to allow the designer to view those conical surface shapes, on a muscle-by-muscle basis, for enabling the designer to evaluate the range of motion of human finger tips and toes moved by each human muscle.

Subsequently, a step S1005 is implemented to make a determination as to whether or not the evaluation of the ranges of motion has been finished with all joints.

If not, then the determination of the step S1005 becomes “NO,” with the subsequent implementation of the steps S1003 and S1004 for a next joint.

If the implementation of the steps 51003 and S1004 has been finished with all joints, then the determination of the step S1005 becomes “YES.”

Thereafter, a step S1006 is implemented to allow the designer to finalize the features or configuration of the manually-operated device, in view of the designer's evaluation performed at the step S1004.

Then, one cycle of execution of this design assist program is terminated.

Next, a fifth embodiment of the present invention will be described in comparison with the third embodiment for the convenience of description.

The present embodiment is different from the third embodiment only with respect to a musculoskeletal model correction routine, and is common to the third embodiment with respect to other elements.

The present embodiment, therefore, will be described below only with respect to its unique musculoskeletal-model-correction-routine, while the common elements will be referenced the same reference numerals or names, without redundant description or illustration.

In the third embodiment, muscle forces are estimated using a musculoskeletal model by numerical analysis. The musculoskeletal model is configured to include rigid-body segments or rigid links for use in modeling a skeleton structure of a human body, and wire elements for use in modeling muscles of the human body.

More specifically, for this musculoskeletal model, a real one muscle is approximately represented by one wire element, and a muscle travel or path represented by the wire element is defined to approximate the geometrical center line of a real muscle.

In the third embodiment, the relationship between motion and muscle forces of the skeleton structure is described, using the thus-configured musculoskeletal model, and by the equation of motion, and the muscle forces are found from the motion of the skeleton structure, by inverse analysis.

However, the fact that, in general, the number of muscles is larger than the number of degree-of-freedoms of a joint brings a problem of estimating muscle forces into an indeterminate problem. In the third embodiment, to solve the problem, optimization calculation is employed with an objective function formulated to match a human motion to be analyzed.

A real muscle is organized in the form of a bundle of a plurality of muscle fibers, each of which contacts due to activity of human motor nerves, resulting in the occurrence of a muscle force, with each muscle fiber deforming flexibly in action. Each human motor nerve forms a single motor unit controlling a plurality of muscle fibers which are distributed among different muscles, with a varying total number of muscle fibers controlled by each human motor nerve in a range from tens to hundreds.

For these reasons, a muscle force can act on a muscle also in a direction deviated from the geometrical center line of the muscle. In the third embodiment, its muscle travel or path is defined in accordance with the geometrical center line of the muscle, causing a muscle-force direction to be fixedly located on the muscle geometrical-center-line.

In the third embodiment, however, a technique of allowing a muscle moment arm to be defined independently of a muscle force direction as a variable quantity, makes is easier to estimate a muscle force, based on the force equilibrium between muscle force and joint torque reached with respect to various human-motions, irrespective of the fact that the muscle-force direction is caused to be fixedly located on the muscle geometrical-center-line.

In other words, in the third embodiment, it is easier to enhance the accuracy with which a muscle force can be estimated, irrespective of the fact that the muscle-force direction is caused to be fixedly located on the muscle geometrical-center-line.

On the other hand, in the present embodiment, one muscle is modeled as a bundle of a plurality of muscle-fiber model. As a result, muscle force directions can be defined or specified on a per-muscle-fiber-model basis, allowing a muscle moment arm to be defined on a per-muscle-fiber-model basis.

The above, however, does not always mean that one real muscle is required to be represented as a plurality of muscle-fiber models having the same total number as that of a plurality of real muscle fibers building up the one real muscle, but means that one real muscle can be represented as a plurality of muscle-fiber models having the smaller total number than that of a plurality of real muscle fibers building up the one real muscle, for example, for elimination or reduction in computational load.

Due to the above, in the present embodiment, muscle moment arm vectors are calculated on a per-muscle-fiber-model basis, and the muscle moment arm vectors are corrected in the similar algorithm with the third embodiment.

The present embodiment, therefore, would make it still easier to simulate the dynamics of a real muscle by its muscle model with enhanced accuracy.

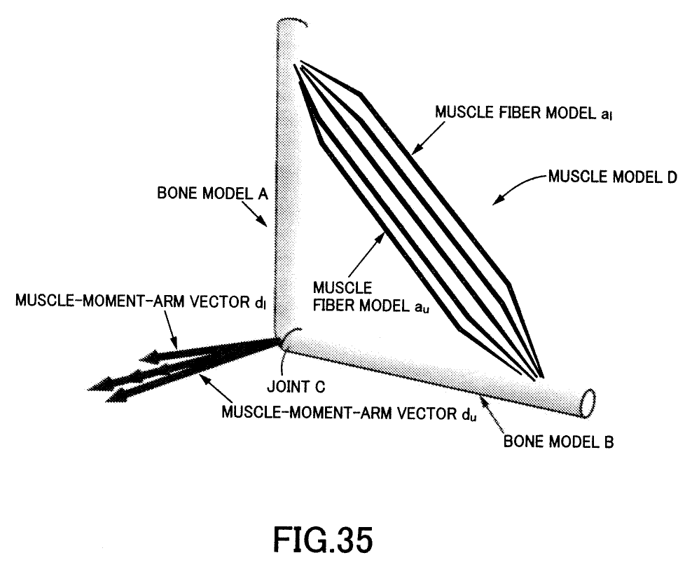

FIG. 35 illustrates in perspective view an example of modeling of one muscle as a bundle of a plurality of muscle-fiber models.

In the example illustrated in FIG. 35, two bone models A and B are disposed relative to a joint C so as to be pivotable relative to each other about the joint C, and these bone models A and 5 are coupled to each other via one muscle model D. The muscle model D constitutes an example of the aforementioned detailed muscle-model.

The example illustrated in FIG. 35, the muscle model D representative of one muscle is in the form of a bundle of a plurality of muscle-fiber models a₁, . . . , aᵤ (u: total number of muscle-fiber models), which, typically, are not coplanar.

In addition, each muscle-fiber model a is attached at its one end to the bone model A at an attachment point, and is attached at its opposite end to the bone model B at another attachment point.

Moreover, each muscle-fiber model a extends along a straight line defined by two via-points, when passing through between these two via-points. The muscle travel or path is uniquely specified by those two attachment points and two via-points.

FIG. 35 further illustrates a plurality of muscle moment arm vectors d₁, . . . , dᵤ (u: total number of muscle-fiber models), in association with the joint C. The muscle moment arm vectors d, because of their assignment per muscle-fiber model a, has the same total number as that of the muscle-fiber models a, as illustrated in FIG. 35.

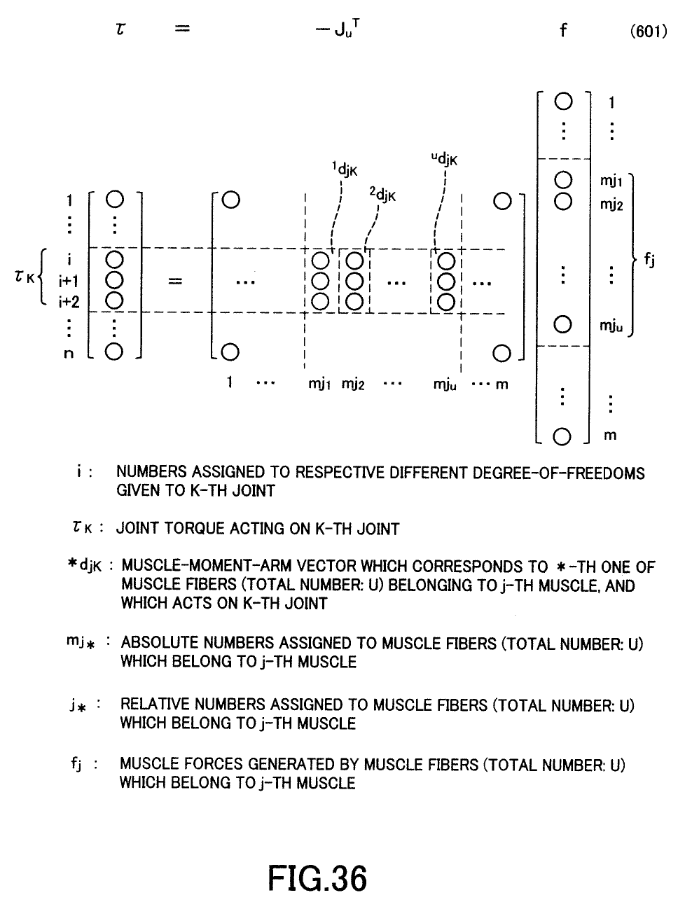

In the present embodiment, similar with the third embodiment, consideration is taken of the force equilibrium in which the joint torque vector τ is equal to the product of the muscle moment arm matrix Jᵤ^{T} and the muscle force vector f, as expressed by equation (601) in FIG. 36.

FIG. 36 further illustrates the joint torque vector τ, the muscle moment arm matrix Jᵤ^{T} and the muscle force vector f.

Where the degree-of-freedom of a musculoskeletal model is denoted as “n,” the total number of muscle-fiber models belonging to all muscle models is denoted as “m,” and the total number of muscle-fibers is denoted as “u,” the joint torque vector X is a column vector having n rows, the muscle moment arm matrix Jᵤ^{T} is an n×m matrix, and the muscle force vector f is a column vector having m rows.

Now, the muscle moment arm will be discussed, assuming that the j-th muscle of a plurality of muscles exerts its action on a selected joint in the form of a spherical joint. A plurality of muscle fibers belonging to the j-th muscle are assigned relative serial-numbers j₁, j₂, . . . , jᵤ, and assigned absolute serial-numbers mⱼ₁, mⱼ₂, . . . , mⱼᵤ.

In a case where the selected joint are assigned i-th, (i+1)-th and (i+2)-th degree-of-freedoms which are part of n degree-of-freedoms, the muscle moment arm vector corresponding to the first muscle fiber (mⱼ₁-th muscle fiber, in absolute serial-number) in the j-th muscle is composed as a column vector having 3 rows consisting of elements (i, mⱼ₁), (i+1, mⱼ₁) and (i+2, mⱼ₁) in the muscle moment arm matrix Jᵤ^{T}.

Likewise, the muscle moment arm vector corresponding to the second muscle fiber (mⱼ₂-th muscle fiber, in absolute serial-number) in the j-th muscle is composed as a column vector having 3 rows consisting of elements (i, mⱼ₂), (i+1, mⱼ₂) and (i+2, mⱼ₂) in the muscle moment arm matrix Jᵤ^{T}.

Still likewise, the muscle moment arm vector corresponding to the u-th muscle fiber (mⱼᵤ-th muscle fiber, in absolute serial-number) in the j-th muscle is composed as a column vector having 3 rows consisting of elements (i, mⱼᵤ), (i+1, mⱼᵤ) and (i+2, mⱼᵤ) in the muscle moment arm matrix Jᵤ^{T}.

As will be evident from the above, in the present embodiment, the muscle moment arm vectors for the j-th muscle are calculated as a set of u muscle-moment-arm-vectors corresponding to u muscle-fiber models.

The direction of a muscle moment arm vector corresponding to each muscle-fiber model is indicative of the direction of an individual pivot-axis per muscle fiber, while the magnitude of the muscle moment arm vector is indicative of the distance between the individual pivot-axis and the muscle travel per muscle fiber.

For example, in a case where a muscle moment arm vector v of a particular muscle fiber with respect to a particular joint is expressed by “(vₓ, v_{y}, v_{z}),” the magnitude |v| of this muscle moment arm vector v is expressed by a scalar which is the square root of (vₓ²+v_{y}²+v_{z}²), while the direction of this muscle moment arm vector v is expressed by a unit direction-vector which is (vₓ/|v|, v_{y}/|v|, v_{z}/|v|).

As illustrated in FIG. 36, the muscle moment arm matrix Jᵤ^{T} consists of a plurality of elements in a two-dimensionally array both in a row direction indicating a serial number i of degree-of-freedom, and a column direction indicating a serial number mⱼ of muscle fiber. Therefore, the muscle moment arm matrix Jᵤ^{T} defines muscle moment arms for all pairs of human muscles and degree-of-freedoms of human joints.

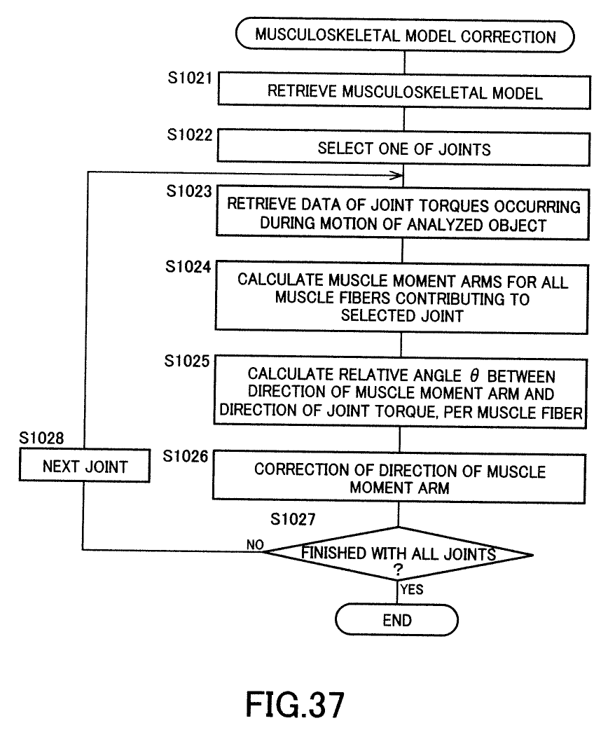

FIG. 37 conceptually illustrates in flow chart a musculoskeletal model correction routine of a human-motion analysis program configured according to the present embodiment.

This musculoskeletal model correction routine has its fundamental algorithm in common to that of the musculoskeletal model correction routine depicted in FIG. 28, while it is different in that muscle moment arm are calculated and the calculations are corrected if necessary, not per muscle, but per muscle fiber.

Then, the musculoskeletal model correction routine depicted in FIG. 37 will be described below, provided, however, that its common steps to those of the musculoskeletal model correction routine depicted in FIG. 28 will be described without redundant description, by explicit reference to the corresponding steps in FIG. 28.

Upon execution of this musculoskeletal model correction routine in FIG. 37, a step S1021 is first implemented, in a similar manner with the step S521 depicted in FIG. 28, to retrieve from the data memory 42 data indicative of the musculoskeletal model.

Next, a step S1022 is implemented, in a similar manner with the step S522 depicted in FIG. 28, to select one of all human joint as a joint which is to be currently processed.

Thereafter, a step S1023 is implemented, in a similar manner with the step S523 depicted in FIG. 28, to retrieve from the data memory 42 the joint torque vector T indicative of a joint torque acting on a currently-selected joint in response to impartation of a to-be-analyzed motion or behavior to a human body.

Subsequently, a step S1024 is implemented, in a similar manner with the step S524 depicted in FIG. 28, to calculate the muscle moment arm vectors v for all muscle fibers belonging to all muscles contributing to a motion of the currently-selected joint, in a similar manner with the step S402 depicted in FIG. 16.

Thereafter, a step S1025 is implemented, in a similar manner with the step S525 depicted in FIG. 28, to calculate the relative angle θ between the direction of each muscle moment arm and the direction of the joint torque, per muscle fiber. The calculating of the relative angle θ is performed by executing the relative angle calculation routine depicted in FIG. 29, for each muscle fiber.

Subsequently, a step S1026 is implemented, in a similar manner with the step S526 depicted in FIG. 28, to correct the directions of the muscle moment arms per muscle fiber, if necessary. The correction is performed by executing the muscle moment arm direction correction routine depicted in FIG. 30

Thereafter, a step S1027 is implemented, in a similar manner with the step S527 depicted in FIG. 28, to make a determination as to whether or not the calculating of the corrected moment-arm-vectors v′ has been finished with all joints in a human body.

If not, then the determination of the step 51027 becomes “NO,” with the subsequent implementation of a step 51028, in a similar manner with the step S528 depicted in FIG. 28, to select a next joint, and the further subsequent implementation of the steps S1023-S1026 for the next-selected joint.

If the implementation of the steps S1023-S1026 has been finished with all joints, then the determination of the step S1027 becomes “YES.” Then, one cycle of execution of this musculoskeletal model correction routine is terminated.

As will be readily understood from the above, in the present embodiment, the steps S301 and S302 depicted in FIG. 15 and the step S402 depicted in FIG. 16 together constitute an example of the “first defining step” set forth in the above mode (1), the steps 3201-3203 depicted in FIG. 14 together constitute an example of the “second defining step” set forth in the same mode, and the musculoskeletal model correction routine depicted in FIG. 37 constitutes an example of the “redefining step” set forth in the same mode, all for the illustrative purposes.

Further, in the present embodiment, the step S1024 constitutes an example of the “first direction calculation step” set forth in the above mode (5), an example of the “second direction calculation step” set forth in the above mode (6), and an example of the “vector calculation step” set forth in the above mode (7), the step S1025 depicted in the same figure constitutes an example of the “relative-angle calculation step” set forth in the same mode, and the step S1026 depicted in the same figure constitutes an example of the “vector correction step” set forth in the above mode.

Next, a sixth embodiment of the present invention will be described in comparison with the third embodiment for the convenience of description.

The present embodiment, which is in common to the third embodiment with respect to many elements, will be described below only with respect to different elements from those in the third embodiment, while the common elements will be referenced the same reference numerals or names, without redundant description or illustration.

In the third embodiment, a finite-element-based human body model and a rigid-body-segment-based musculoskeletal model are employed.

The finite-element-based human body model is a model physically representing or simulating a whole human body using a plurality of finite elements each in the form of a solid element, irrespective of whether a respective segment of the whole human body is a bone or a muscle.

On the other hand, the rigid-body-segment-based musculoskeletal model is a musculoskeletal model physically representing or simulating the whole human body, using a plurality of bone models each in the form of a rigid-body segment for representation of a plurality of bones in the whole human body, and using a plurality of muscle models each in the form of a wire element (or referred to as “bar element”) for representation of a plurality of muscles in the whole human body. This rigid-body-segment-based musculoskeletal model is categorized as the multi-joint-rigid-body-segment-based model, as described above.

In the present embodiment, two types of finite-element-based human body models and a rigid-body-segment-based musculoskeletal model in common to that in the third embodiment.

Those two types of finite-element-based human body models include a finite-element-based musculoskeletal model and a finite-element-based muscle model.

The finite-element-based musculoskeletal model is a musculoskeletal model physically representing only the musculoskeletal structure of a human body using a plurality of finite elements.

On the other hand, the finite-element-based muscle model is a muscle model physically representing only a plurality of muscles in a human body using a plurality of finite elements. In terms of construction, this finite-element-based muscle model is included in the finite-element-based musculoskeletal model.

The finite-element-based musculoskeletal model, because of its category of a finite-element-based model, represents a human musculoskeletal structure as an elastic body, with the capability of simulating deformation of the musculoskeletal structure.

Likewise, the finite-element-based muscle model, because of its categorization as a finite-element-based model, represents a human muscle as elastic bodies, with the capability of simulating deformation of the muscle.

On the other hand, although the rigid-body-segment-based musculoskeletal model, because of its representation of a skeleton as rigid-body segments, is incapable of simulating deformation of the skeleton, the rigid-body-segment-based musculoskeletal model, because of its representation of a muscle as a wire element, is capable of simulating deformation of the muscle, with deformation simulatability limited to only one direction.

In addition, in the third embodiment, the rigid-body-segment-based musculoskeletal model is constructed using the finite-element-based human body model (whole human body model), and muscle activation levels are estimated using the constructed rigid-body-segment-based musculoskeletal model.

In contrast, in the present embodiment, the rigid-body-segment-based musculoskeletal model is constructed using the finite-element-based musculoskeletal model (partial human body model), and muscle forces and muscle activation levels are estimated using the constructed rigid-body-segment-based musculoskeletal model.

Further, in the present embodiment, the estimated muscle activation levels, upon being converted if necessary, are applied to the finite-element-based muscle model (partial human body model), to thereby estimate stresses and strains occurring in each segment of a human body in response to impartation of a particular motion to the human body.

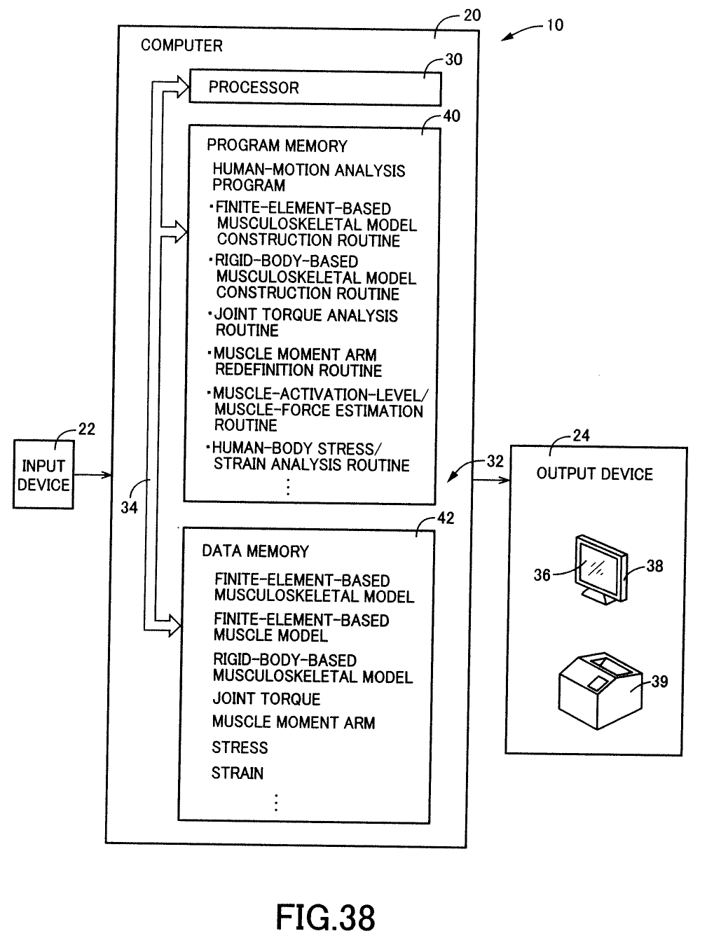

Referring now to FIG. 38, there is conceptually illustrated in block diagram the hardware configuration of a system 210 which is suitable for use in implementing a human-motion analysis method including a human-body stress/strain analysis process according to the present embodiment.

As illustrated in FIG. 38, the system 210, similarly with the system 10 depicted in FIG. 1, is configured to perform analysis of stresses (exemplary loads) and strains (exemplary deformations) occurring at each segment of an occupant present in a car upon contact of the car with an obstacle (i.e., upon external impact on the car), by computer simulation using a human body model which can represent or simulate a human motion by the computer 20.

As illustrated in FIG. 1, the system 210, similarly with the system 10 depicted in FIG. 1, is constructed such that the input device 22 and the output device 24 are electrically coupled to the computer 20. The computer 20, as is well known, is constructed such that the processor 30 and the storage device 32 are electrically interconnected via the bus 34.

As illustrated in FIG. 38, the storage device 32 is provided with the program memory 40 and the data memory 42. In the program memory 40, various programs beginning with the human-motion analysis program have been previously stored.

This human-motion analysis program, which will be described below in more detail though, is so configured as to include a finite-element-based musculoskeletal model construction routine; a rigid-body-segment-based musculoskeletal model construction routine; a joint torque analysis routine; a muscle moment arm redefinition routine; a muscle-activation-level/muscle-force estimation routine; and a human-body stress/strain analysis routine.

To the data memory 42, areas have been assigned for storing the finite-element-based musculoskeletal model; the finite-element-based muscle model; the rigid-body-segment-based musculoskeletal model; joint torques; muscle moment arms; stresses; and strains, respectively.

It is noted that, because the finite-element-based musculoskeletal model is a model internally including the finite-element-based muscle model, that is to say a combined model of a muscle model and a skeleton model, it would be adequate to store in the data memory 42 at least the finite-element-based musculoskeletal model among the finite-element-based musculoskeletal model and the finite-element-based muscle model.

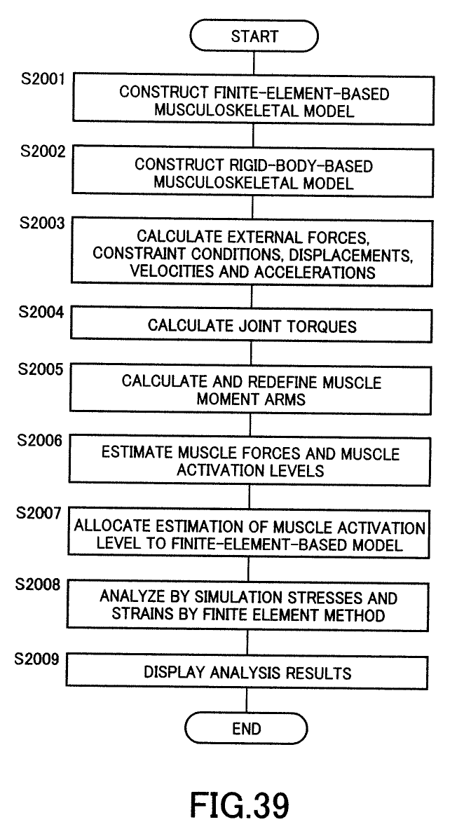

FIG. 39 conceptually illustrates in flow chart the human-motion analysis program according to the present embodiment.

During each cycle of execution of this human-motion analysis program, a step S2001 is first implemented to cause the computer 20 to execute the aforementioned finite-element-based musculoskeletal model construction routine, to thereby construct the finite-element-based musculoskeletal model, as illustrated in FIG. 2.

An exemplary technique of constructing the finite-element-based musculoskeletal model is disclosed in U.S. Patent Application Publication No. US-2002-0042703-A1, which is incorporated hereinto by reference.

Next, a step S2002 is implemented to construct the rigid-body-segment-based musculoskeletal model illustrated in FIG. 4, using the constructed finite-element-based musculoskeletal model.

More specifically, the rigid-body-segment-based musculoskeletal model is constructed by causing the computer 20 to execute the aforementioned rigid-body-segment-based musculoskeletal model construction routine. This rigid-body-segment-based musculoskeletal model construction routine has been configured to include, for example, the skeleton model construction routine depicted in FIG. 12 and the musculoskeletal model construction routine depicted in FIG. 15.

Subsequently, a step S2003 is implemented to calculate external forces acting on segments of a human body which is in contact with an object, using the constructed rigid-body-segment-based musculoskeletal model.

In an exemplary event to be analyzed, an exemplary external force is a reaction force acting on a human foot from a brake pedal in an automotive car, in response to the brake pedal being depressed by the human foot, and an alternative exemplary external force is a reaction force acting on a human back form a seat in an automotive car, in response to the human back being pressed onto the seat.

In this exemplary event to be analyzed, a motion of a human depressing the brake pedal is imparted to the rigid-body-segment-based musculoskeletal model.

This step S2003 is further implemented to calculate constraint conditions, displacements, velocities and accelerations, using the rigid-body-segment-based musculoskeletal model.

In this regard, the constraint conditions refer to, for example, degree-of-freedoms of motion occurring in an area in which a human and an object are in contact with each other. The displacements, velocities and accelerations are found in association with, for example, each joint in the rigid-body-segment-based musculoskeletal model.

At this step S2003, those external forces, constraint conditions, displacements, velocities and accelerations are calculated in a similar manner with the steps S201 and S202 depicted in FIG. 14.

Thereafter, a step S2004 is implemented, in a similar manner with the step S203 depicted in FIG. 14, to calculate joint torques acting on each joint. To this end, the aforementioned joint torque analysis routine is executed by the computer 20,

Subsequently, a step S2005 is implemented, in a similar manner with the step S402 depicted in FIG. 16, to calculate muscle moment arms per muscle or per muscle fiber.

This step S2005 is further implemented, in a similar manner with the steps S521-S528 depicted in FIG. 28, to redefine or refine the muscle moment arms which have been previously calculated, based on the aforementioned relative angles θ, per muscle or per muscle fiber. To this end, the aforementioned muscle moment arm redefinition routine is executed by the computer 20.

Thereafter, a step S2006 is implemented to estimate muscle forces and muscle activation levels. The estimation is performed basically by optimization calculation. In this regard, its design variable has two options, that is to say a muscle force and a muscle activation level. At any rate, it is required to consider the equilibrium between muscle forces and a joint torque, as one of the constraint conditions.

Once a muscle activation level has been selected as a design variable, firstly, muscle activation levels are estimated per muscle or per muscle fiber, in a similar manner with the step S6 depicted in FIG. 11. The estimation requires the optimization calculation, as described above.

Secondly, muscle forces are estimated based on the estimated muscle activation levels, using equation (101) depicted in FIG. 6, per muscle or per muscle fiber.

More specifically, as expressed by equation (101), muscle forces are estimated based on the estimations of muscle activation levels, a maximum muscle-force, a muscle length, and a muscle-length changing velocity, per muscle or per muscle fiber.

In the alternative, once a muscle force has been selected as a design variable, firstly, muscle forces are estimated by the aforementioned optimization calculation, per muscle or per muscle fiber.

Secondly, muscle activation levels are estimated based on the estimated muscle forces, using equation (101) depicted in FIG. 6, per muscle or per muscle fiber.

More specifically, as expressed by equation (101) muscle activation levels are estimated based on the estimations of muscle forces, the maximum muscle-force, the muscle length, and the muscle-length changing velocity, per muscle or per muscle fiber.

Following this step S2006, a step S2007 is implemented to allocate or divide each one of the estimations of muscle activation levels, for conversion into muscle activation levels applicable to the finite-element-based muscle model, per muscle or per muscle fiber.

For example, in general, a muscle model defined in the rigid-body-segment-based musculoskeletal model has a smaller total-number of constituent elements than that of the finite-element-based muscle model, with respect to the same real muscle. That is to say, there is a difference in total number between the muscle model included in the rigid-body-segment-based musculoskeletal model and the finite-element-based muscle model.

For this reason, if finite element analysis is performed such that the muscle activation levels which have been estimated using the rigid-body-segment-based musculoskeletal model are used without any modification, as the muscle activation levels applied to the finite-element-based musculoskeletal model, then the accuracy of analysis results would degrade.

In the above circumstances, this step S2007 is implemented to allocate or divide each muscle-activation-level estimated using the rigid-body-segment-based musculoskeletal model, according to the relation between the configuration of the muscle model defined in the rigid-body-segment-based musculoskeletal model, and the configuration of the finite-element-based muscle model, to thereby convert the original muscle activation levels into those defined in the finite-element-based muscle model.

It is added that this step S2007 is also implemented to convert a physical quantity other than a muscle activation level, in a similar manner with the muscle activation level, if required for simulation analysis described below.

Subsequently, a step S2008 is implemented to perform simulation analysis of stresses and strains occurring in each segment (eg., each segment corresponding to each finite element) of a human body, using the finite-element-based muscle model, by the finite element method.

The finite element method, as well known in the art, is one of numerical calculation approaches performed by computers, in which a continuum is partitioned into a large number of elements (e.g., a mesh) each having a finite size, and physical quantities of individual elements are entered into a given simultaneous characteristic equations of material, to thereby numerically calculate a given system in its entirety.

Further, each characteristic equation of material is formulated to have its characteristic factors for controlling the analysis characteristic of the finite element method to be performed.

An exemplary version of simulation analysis is disclosed in U. S Patent Application Publication No. US-2002-0042703-A1, which is incorporated hereinto by reference.

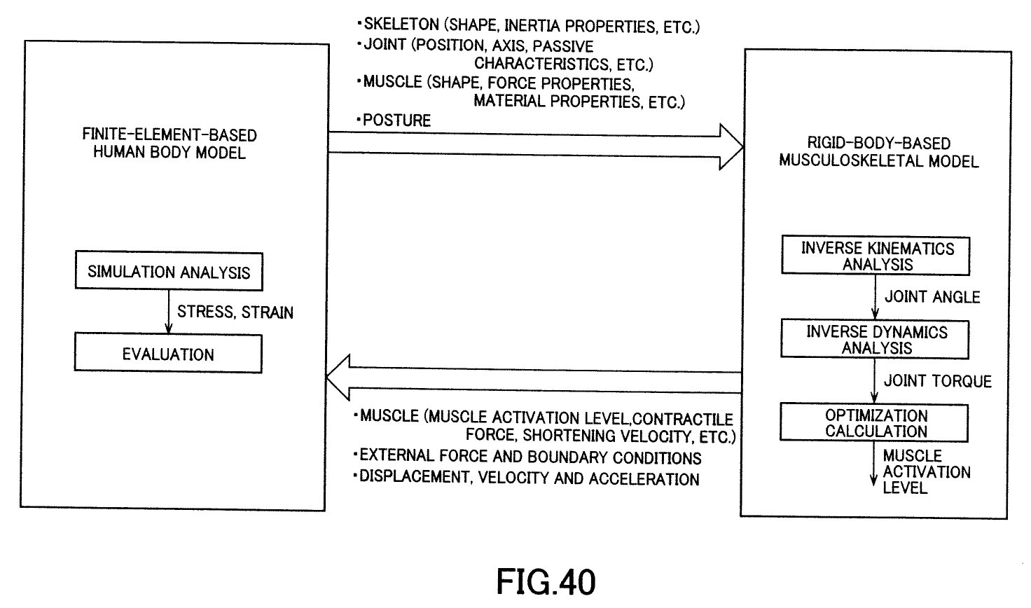

Referring now to FIG. 40, there is conceptually illustrated in block diagram the relationship between a plurality of models different in type for use in the present embodiment, and a plurality of numerical analyses different in type to be performed in the present embodiment.

In the present embodiment, as described above, the inverse kinematics analysis is performed for seeing the calculations of joint angles, using the rigid-body-segment-based musculoskeletal model, and the inverse dynamics analysis is in turn performed for seeking the calculations of joint torques, based on the calculations of joint angles, and using the rigid-body-segment-based musculoskeletal model.

Further, in the present embodiment, the optimization calculation is performed for seeking the estimations of muscle forces and muscle activation levels, based on the calculations of joint torques.

Still further, in the present embodiment, the simulation analysis is performed for seeking the estimations of stresses and strains occurring in each segment of a human body, using the finite-element-based human body model (or the finite-element-based muscle model). Those estimations are for use in various aspects of evaluation or various applications.

Additionally, in the present embodiment, for calculating the rigid-body-segment-based musculoskeletal model from the finite-element-based human body model (or the finite-element-based muscle model), information on a human skeleton, information on human joints, information on human muscles, and information on human postures are presented from the finite-element-based human body model, the rigid-body-segment-based musculoskeletal model is constructed based of those sets of information.

Still additionally, in the present embodiment, for performing simulation analysis using the finite-element-based human body model, information on human muscles, information on external forces and boundary conditions each applied to a human body, and information on displacements, velocities and accelerations in a human body are presented to the finite-element-based human body model from the rigid-body-segment-based musculoskeletal model.

Based on those sets of information, and using the finite-element-based human body model, stresses and strains occurring in each segment of a human body are estimated.

As will be understood from the above, in the present embodiment, the steps S2002, S204 and S2005 depicted in FIG. 39 together constitute an example of the “provisional construction step” set forth in the above mode (9), a portion of the step S2005 depicted in the same figure which is assigned to calculate muscle moment arms constitutes an example of the “first calculation step” set forth in the same mode, the step S2004 depicted in the same figure constitutes an example of the “second calculation step” set forth in the same mode, and a portion of the step S2005 depicted in the same figure which is assigned to redefine the muscle moment arms constitutes an example of the “musculoskeletal model correction step” set forth in the same mode.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A method of constructing a computer-based musculoskeletal model which physically represents on a computer a plurality of bones and a plurality of muscles together making up a human body, wherein
the musculoskeletal model is constructed so as to approximately represent the plurality of bones in the form of a plurality of bone models each of which is defined as a rigid-body segment and which are pivotable relative to one another about pivot axes of a plurality of joints, and
the musculoskeletal model is constructed so as to approximately represent the plurality of muscles in the form of a plurality of muscle models each of which is defined using at least one finite element,
the method comprising:
a first defining step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint;
a second defining step of defining as a second pivot-axis-direction, a direction of an axis about which selected ones of the plurality of bones represented by the selected bone models are pivoted relative to each other in response to a specified motion imparted to the human body; and
a redefining step of redefining by the computer the defined first pivot-axis-direction of the selected joint, as a function of a relative angle of the defined first pivot-axis-direction to the defined second pivot-axis-direction, both of the selected joint.

2. The method according to claim 1, wherein the redefining step includes an alteration step of altering the first pivot-axis-direction such that the relative angle becomes smaller, to thereby redefine the first pivot-axis-direction.

3. The method according to claim 2, wherein the alteration step is implemented not to alter the first pivot-axis-direction when the relative angle exceeds an allowable limit, and to alter the first pivot-axis-direction is altered when the relative angle does not exceed the allowable limit, such that the relative angle becomes smaller.

4. The method according to claim 3, wherein the alteration step is implemented to alter the first pivot-axis-direction such that the relative angle is moved closer to zero when the relative angle does not exceed a reference value not exceeding the allowable limit than when the relative value exceeds the reference values.

5. The method according to claim 1, wherein the redefining step includes a first direction calculation step of calculating the first pivot-axis-direction of the selected muscle model, based on position coordinate information indicative of a position of a joint-pivot-center of the selected joint, and position coordinate information indicative of positions of two via-points via which the selected muscle model passes when traveling between two attachment points at which the selected muscle model is attached to the selected bone models.

6. The method according to claim 1, wherein
each of the muscles is in the form of a bundle of a plurality of muscle fibers,
the plurality of muscle models include at least one detailed muscle model representing a bundle of a plurality of muscle fibers making up a corresponding one of the plurality of muscles, in the form of a bundle of a plurality of muscle-fiber models, and
the redefining step includes a second direction calculation step of calculating the first pivot-axis-direction on a per-muscle-fiber-model basis.

7. The method according to claim 6, wherein the redefining step includes:
a vector calculation step of calculating, on a per-muscle-fiber-model basis, a moment arm vector representative of a moment arm with which a corresponding one of the muscle fibers to each muscle-fiber model exerts its action on the selected joint;
a relative-angle calculation step of calculating the relative angle, based on the calculated moment arm vector and the defined second pivot-axis-direction; and
a vector correction step of correcting the calculated moment arm vector, based on the calculated relative angle, on a per-muscle-fiber-model basis.

8. The method according to claim 7, wherein the vector calculation step includes a step of calculating the moment arm vector, on a per-muscle-fiber-model basis, based on position coordinate information indicative of a position of a joint-pivot-center of the selected joint, and position coordinate information indicative of positions of two via-points via which each muscle-fiber model passes when traveling between two attachment points at which each muscle-fiber model is attached to the selected bone models.

9. A process of estimating by a computer a stress and/or a strain occurring at each segment of a human body, from a given motion imparted to the human body, using a computer-based musculoskeletal model and a finite element model, wherein
the musculoskeletal model physically represents on a computer a plurality of bones and a plurality of muscles together making up the human body, using a plurality of rigid-body segments for representation of the plurality of bones, and using a plurality of finite elements for representation of the plurality of muscles, and
the finite element model physically represents on the computer the same human body using a plurality of finite elements, irrespective of whether each segment of the human body is a bone or a muscle,
the process comprising:
a musculoskeletal model construction step of constructing the musculoskeletal model;
a load estimation step of estimating a plurality of loads different in kind acting with respect to each segment of the human body, based on the motion imparted to the human body, using the constructed musculoskeletal model; and
a stress/strain estimation step of estimating a stress and/or a strain occurring at each segment of the human body, based on the estimated plurality of loads, using the finite element model, wherein
the musculoskeletal model is constructed so as to approximately represent the plurality of bones in the form of a plurality of bone models each of which is defined as a rigid-body segment and which are pivotable relative to one another about pivot axes of a plurality of joints, and
the musculoskeletal model is constructed so as to approximately represent the plurality of muscles in the form of a plurality of muscle models each of which is defined using at least one finite element,
the musculoskeletal model construction step comprising:
(a) a provisional construction step of provisionally constructing the musculoskeletal model based on provided musculoskeletal model information;
(b) a first calculation step of calculating as a first pivot-axis-direction for selected ones of the plurality of bone models of the provisionally-constructed musculoskeletal model, which ones are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exerts its action on the selected joint;
(c) a second calculation step of calculating as a second pivot-axis-direction, a direction of an axis about which selected ones of the plurality of bones represented by the selected bone models are pivoted relative to each other in response to a specified motion imparted to the human body; and
(d) a musculoskeletal model correction step of correcting the calculated first pivot-axis-direction of the selected joint, as a function of a relative angle of the calculated first pivot-axis-direction to the calculated second pivot-axis-direction, both of the selected joint, to thereby correct the provisionally-constructed musculoskeletal model, wherein
the plurality of different loads include at least one of a muscle-related load, an external force acting on each segment of the human body, and a velocity and an acceleration occurring at each segment of the human body, and
the muscle-related load includes at least one of a muscle activation level and a muscle force.

10. A method of constructing a computer-based musculoskeletal model which physically represents on a computer a plurality of bones and a plurality of muscles together making up a human body, wherein
the musculoskeletal model is constructed so as to approximately represent the plurality of bones in the form of a plurality of bone models each of which is defined as a rigid-body segment and which are pivotable relative to one another about pivot axes of a plurality of joints, and
the musculoskeletal model is constructed so as to approximately represent the plurality of muscles in the form of a plurality of muscle models each of which is defined using at least one finite element,
the method comprising:
a first defining step of defining as a first pivot-axis-direction for selected ones of the plurality of bone models which are movably coupled to and pivotable relative to each other about a pivot axis of an arbitrary selected one of the plurality of joints, a direction of an axis about which the selected bone models are pivoted relative to each other in response to expansion/contraction of a selected one of the plurality of muscle models which exert its action on the selected joint, the first pivot-axis-direction defined on a per-selected-muscle-model basis;
a second defining step of defining as a second pivot-axis-direction, a direction of an axis about which selected ones of the plurality of bones represented by the selected bone models are pivoted relative to each other in response to a specified motion imparted to the human body;
a first presentation step of visually presenting on a screen of a display device, at least one of a plurality of first pictorial-shapes representative of a plurality of the first pivot-axis-directions defined for the selected muscle models, respectively, in positional association with the selected joint;
a second presentation step of visually presenting on the screen, a second pictorial-shape representative of the defined second pivot-axis-direction, in positional association with the selected joint; and
a redefining step of redefining at least one of the defined plurality of first pivot-axis-directions of the selected joint, as a function of a relative angle of the at least one first pivot-axis-direction to the defined second pivot-axis-direction, both of the selected joint.

11. The method according to claim 10, wherein the first presentation step is implemented to perform visual presentation of the at least one first pictorial-shape in parallel to visual presentation of the second pictorial-shape by implementation of the second presentation step.

12. The method according to claim 10, wherein the plurality of first pictorial-shapes are defined in a three-dimensional space in the form of a plurality of first straight-lines which extend away from one joint-pivot-center of the selected joint, in the plurality of first pivot-axis-directions, up to equidistant positions, respectively, or in the form of a plurality of figures extending along the plurality of first straight-lines, respectively,
the second pictorial-shape is defined in the three-dimensional space in the form of one second straight-line which extends away from the one joint-pivot-center, in the second pivot-axis-direction, or in the form of one figure extending along the second straight-line,
the first presentation step is implemented to display the at least one first pictorial-shape two-dimensionally on the screen, in the form of at least one first projected-image obtained by projecting the at least one first pictorial-shape onto the screen in a given direction, respectively, and
the second presentation step is implemented to display the second pictorial-shape two-dimensionally on the screen, in the form of a second projected-image obtained by projecting the second pictorial-shape onto the screen in the given direction.

13. The method according to claim 12, further comprising a third presentation step of visually presenting two-dimensionally on the screen, one spherical surface shape defined in the three-dimensional space with its center located coincident with the joint-pivot-center, and with its radius equal in length to the plurality of first straight-lines, in superposition with the first projected-image, the one spherical surface shape being displayed in the form of a projected image obtained by projecting the spherical surface shape onto the screen in the given direction.

14. The method according to claim 13, wherein the spherical surface shape is defined in the three-dimensional space in the form of a three-dimensional mesh, and
the third presentation step includes a step of displaying the three-dimensional mesh two-dimensionally on the screen, in the form of a projected image of the three-dimensional mesh obtained by projecting the three-dimensional mesh onto the screen in the given direction.

15. The method according to claim 10, further comprising
a third defining step of determining, on a per-selected-muscle-model basis, the same direction as the defined first pivot-axis-direction as a reference pivot-axis-direction, and defining, on a per-selected-muscle-model basis, an allowable angular range over which the first pivot-axis-direction is allowed to be deviated from the reference pivot-axis-direction, wherein
each one of the first pictorial-shapes is defined in the three-dimensional space in the form of a conical surface shape geometrically specified by a centerline extending in the reference pivot-axis-direction, and a base varying in size with the defined allowable-angular-range, and
the first presentation step includes a conical-surface-shape presentation step of displaying the defined conical-surface-shape two-dimensionally on the screen, on a per-selected-muscle-model basis, in the form of a projected image of the conical surface shape obtained by projecting the conical surface shape onto the screen in a given direction.

16. The method according to claim 10, wherein the first presentation step includes a step of displaying, on a per-selected-muscle-model basis, each one of the first pictorial-shapes in a manner that a visual property of each first pictorial-shape is varied depending on a magnitude of a moment arm with which a corresponding one of the muscles to each selected muscle model exerts its action on the selected joint.

17. The method according to claim 10, wherein the redefining step includes an alteration step of altering at least one of the plurality of first pivot-axis-directions such that the relative angle becomes smaller, to thereby redefine the at least one first pivot-axis-direction.

18. The method according to claim 17, wherein the alteration step is implemented not to alter each one of the first pivot-axis-directions when the relative angle exceeds an allowable limit, and to alter each first pivot-axis-direction when the relative angle does not exceed the allowable limit, such that each first pivot-axis-direction becomes smaller.

19. The method according to claim 18, wherein the alteration step is implemented to alter each one of ones of the first pivot-axis-directions the relative angles of which do not exceed the allowable limit, such that the relative angle is moved closer to zero when the relative angle does not exceed a reference value not exceeding the allowable limit than when the relative value exceeds the reference value.

20. A computer-executable program which, when executed by a computer, effects the method according to claim 1.

21. A computer-readable medium having stored therein a program which, when executed by a computer, effects the method according to claim 1.
